(19) United States
(12) Patent Application Publication
(10) Pub. No.: US 2021/0187628 A1
(43) Pub. Date: Jun. 24, 2021

(54) DOCKING STATION SYSTEM

(71) Applicant: Kreg Enterprises, Inc., Huxley, IA (US)

(72) Inventors: Neil Holland, Boone, IA (US); Tim Forbes, Ankeny, IA (US); Scott Schaaf, Ankeny, IA (US)

(21) Appl. No.: 17/126,119

(22) Filed: Dec. 18, 2020

Related U.S. Application Data
(60) Provisional application No. 62/950,189, filed on Dec. 19, 2019.

(51) Int. Cl. B23B 47/28

(52) U.S. Cl. CPC B23B 47/287; B23B 2247/12; B23B 2247/10

(57) ABSTRACT

A docking station system is presented for use with pocket hole jigs and other jigs and tools. The docking station system is configured to receive and connect with a pocket hole jig, other jigs, and/or tool to facilitate easy installation and use thereof. In one or more arrangements, the docking system has hinge members that allow for the connection of side supports. Side supports include a base member and a cover member and have a hollow interior for storage. Side supports rotate upon docking station system between an extended position and a retracted position and may be locked in the retracted position for storage and transport. When side supports are in an extended position, the upper surface of the side supports are in flush alignment with the upper surface of the base of the pocket hole jig installed upon the docking station.

### CROSS-REFERENCE TO RELATED APPLICATIONS

The present application claims priority to U.S. Provisional Application No. 62/950,189, titled DOCKING STATION SYSTEM, and filed on Dec. 19, 2019, the entirety of which is hereby incorporated by reference herein in its entirety, including any figures, tables, or drawings or other information.

### FIELD OF THE DISCLOSURE

This disclosure relates generally to jig systems for holding workpieces. More specifically and without limitation, this disclosure relates generally to an improved docking station system for jig systems that provides additional benefits over the prior art.

### OVERVIEW OF THE DISCLOSURE

Pocket hole wood joinery involves joining boards by inserting a fastener at an angle through the edge of one workpiece into an adjoining workpiece, thereby joining the two workpieces together. Such joints are commonly used for face frames, cabinet boxes, leg-to-rail joinery in chairs and tables, and so forth.

To facilitate the formation of pocket hole joinery, Applicant, Kreg Tool Company offers a line of pocket hole jigs. These pocket hole jigs are configured to clamp a workpiece in place and help guide a stepped drill bit at an angle into a workpiece thereby forming a pocket hole in the workpiece. The pocket hole formed by this process is configured to receive a screw that is used to screw two workpieces together.

Existing jigs for use forming pocket hole joinery have a variety of configurations and operate in a variety of manners. All of these configurations and manners of operation leave much to be desired. In addition, all of the existing pocket hole jigs available have deficiencies and therefore are not well suited for various applications.

To cure some of these deficiencies various attachments or accessories have been developed. However, these attachments or accessories themselves leave much to be desired and leave many problems or inefficiencies unresolved. In addition, the use of many of these attachments or accessories complicate the use of the transportation, storage, setup and use of a pocket hole jig system.

For the reasons stated above, and for other reasons stated below which will become apparent to those skilled in the art upon reading and understanding the disclosure, there is a need in the art for docking station system that improves upon the state of the art.

Thus, it is an object of at least one embodiment of the disclosure is to provide a docking station system that improves upon the state of the art.

Another object of at least one embodiment of the disclosure is to provide a docking station system that can receive different jigs.

Yet another object of at least one embodiment of the disclosure is to provide a docking station system that can be easily affixed to a work surface.

Another object of at least one embodiment of the disclosure is to provide a docking station system that includes storage.

Yet another object of at least one embodiment of the disclosure is to provide a docking station system that is easily stored.

Another object of at least one embodiment of the disclosure is to provide a docking station system that is easily transportable.

Yet another object of at least one embodiment of the disclosure is to provide a docking station system that provides additional support for a workpiece.

Another object of at least one embodiment of the disclosure is to provide a docking station system that provides repeatable adjustable stops for a workpiece.

Yet another object of at least one embodiment of the disclosure is to provide a docking station system that retracts into a compact configuration.

Another object of at least one embodiment of the disclosure is to provide a docking station system that expands into an extended configuration.

Yet another object of at least one embodiment of the disclosure is to provide a docking station system that locks into a retracted position.

Another object of at least one embodiment of the disclosure is to provide a docking station system that is easy to use.

Yet another object of at least one embodiment of the disclosure is to provide a docking station system that is efficient.

Another object of at least one embodiment of the disclosure is to provide a docking station system that can be used with any type of workpiece.

Yet another object of at least one embodiment of the disclosure is to provide a docking station system that is cost effective.

Another object of at least one embodiment of the disclosure is to provide a docking station system that forms accurate pocket holes.

Yet another object of at least one embodiment of the disclosure is to provide a docking station system that is safe to use.

Another object of at least one embodiment of the disclosure is to provide a docking station system that has a durable design.

Yet another object of at least one embodiment of the disclosure is to provide a docking station system that has a long useful life.

Another object of at least one embodiment of the disclosure is to provide a docking station system that provides additional functionality for pocket hole jigs and pocket hole joinery.

Yet another object of at least one embodiment of the disclosure is to provide a docking station system that has a wide variety of uses.

Another object of at least one embodiment of the disclosure is to provide a docking station system that has a wide variety of applications.

Yet another object of at least one embodiment of the disclosure is to provide a docking station system that provides cost savings to a user.

Another object of at least one embodiment of the disclosure is to provide a docking station system that is relatively inexpensive.

Yet another object of at least one embodiment of the disclosure is to provide a docking station system that provides value.

Another object of at least one embodiment of the disclosure is to provide a docking station system that prevents or reduces relative movement between the pocket hole jig and the workpiece.

Yet, another object of at least one embodiment of the disclosure is to provide a docking station system that facilitates easier clamping.

Another object of at least one embodiment of the disclosure is to provide a docking station system that that facilitates stable placement of a pocket hole jig system.

Yet, another object of at least one embodiment of the disclosure is to provide a docking station system that is comfortable to use.

Another object of at least one embodiment of the disclosure is to provide a docking station system that is more stable than other pocket hole jigs.

Yet another object of at least one embodiment of the disclosure is to provide a docking station system that improves the ergonomics of use.

Another object of at least one embodiment of the disclosure is to provide a docking station system that facilitates the easy installation of various jigs.

Yet another object of at least one embodiment of the disclosure is to provide a docking station system that facilitates the secure installation of various jigs.

Another object of at least one embodiment of the disclosure is to provide a docking station system that facilitates the formation of aesthetically pleasing finished products.

These and other objects, features, or advantages of at least one embodiment will become apparent from the specification, figures and claims.

### SUMMARY

A docking station system is presented for use with pocket hole jigs and other jigs and tools. The docking station system allows for easy installation of a pocket hole jig and includes hinge members that allow for the connection of side supports. Side supports include a base member and a cover member and have a hollow interior for storage. Side supports rotate upon docking station system between an extended position and a retracted position and may be locked in the retracted position for storage and transport. When side supports are in an extended position, the upper surface of the side supports are in flush alignment with the upper surface of the base of the pocket hole jig installed upon the docking station. Side supports also include a stop member that facilitates the repeatable alignment of multiple workpieces. An adapter bracket is also presented for connection directly to the base of pocket hole jigs.

### BRIEF DESCRIPTION OF THE DRAWINGS

FIG. 1 shows a back side view of a docking station system, in accordance with one or more embodiments.

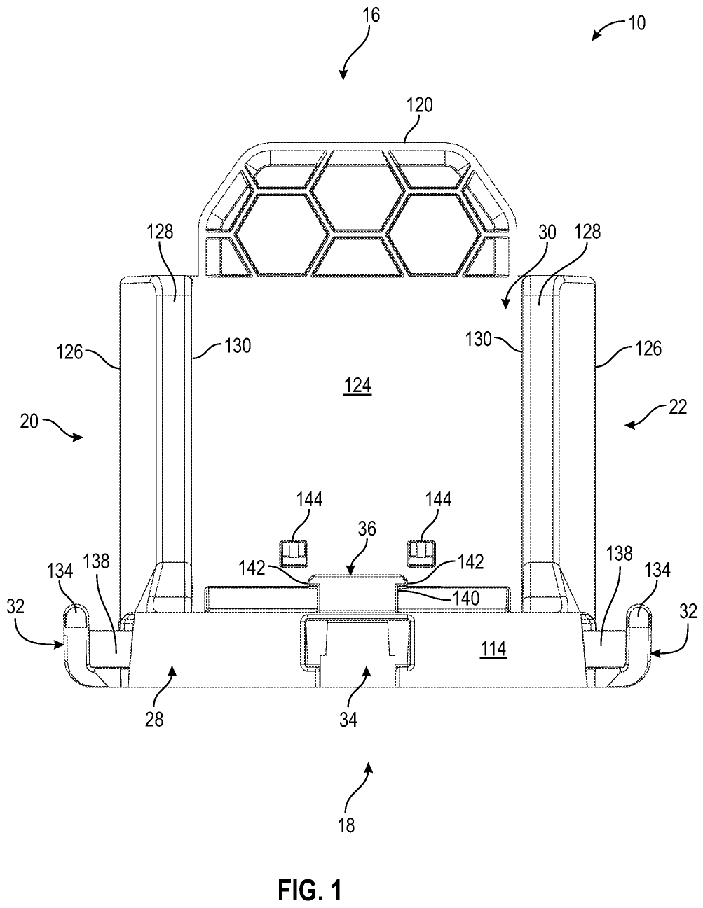

FIG. 2 shows a top side view of a docking station system, in accordance with one or more embodiments.

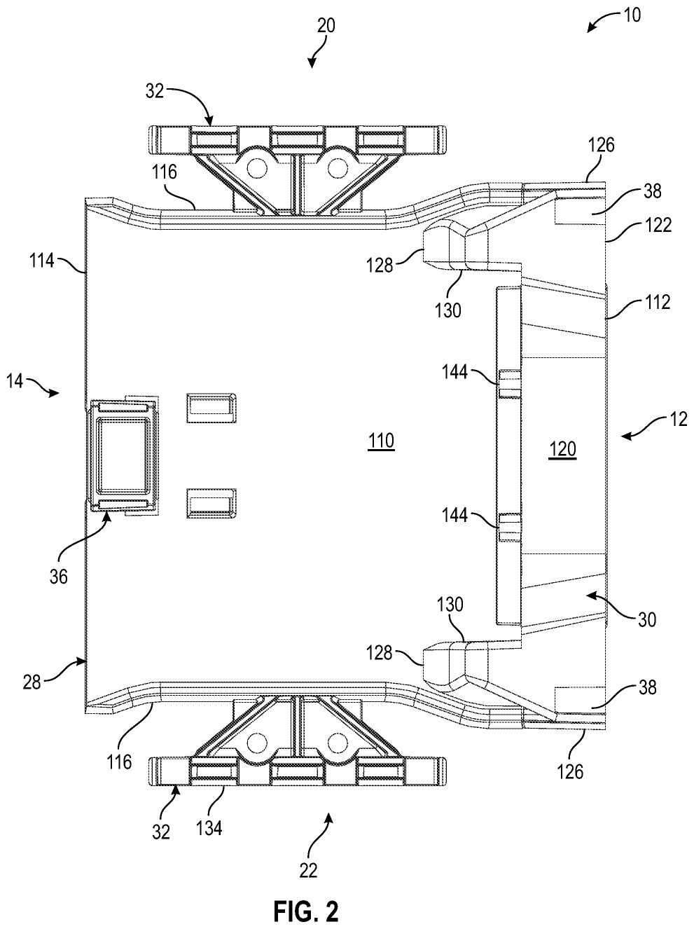

FIG. 3 shows a bottom side view of a docking station system, in accordance with one or more embodiments.

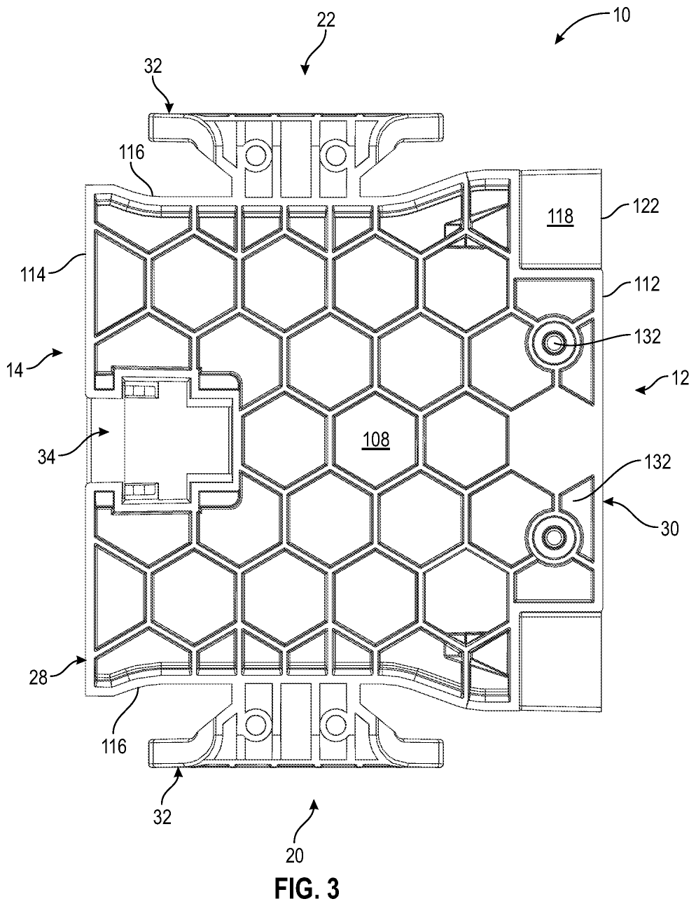

FIG. 4 shows a right side view of a docking station system, in accordance with one or more embodiments.

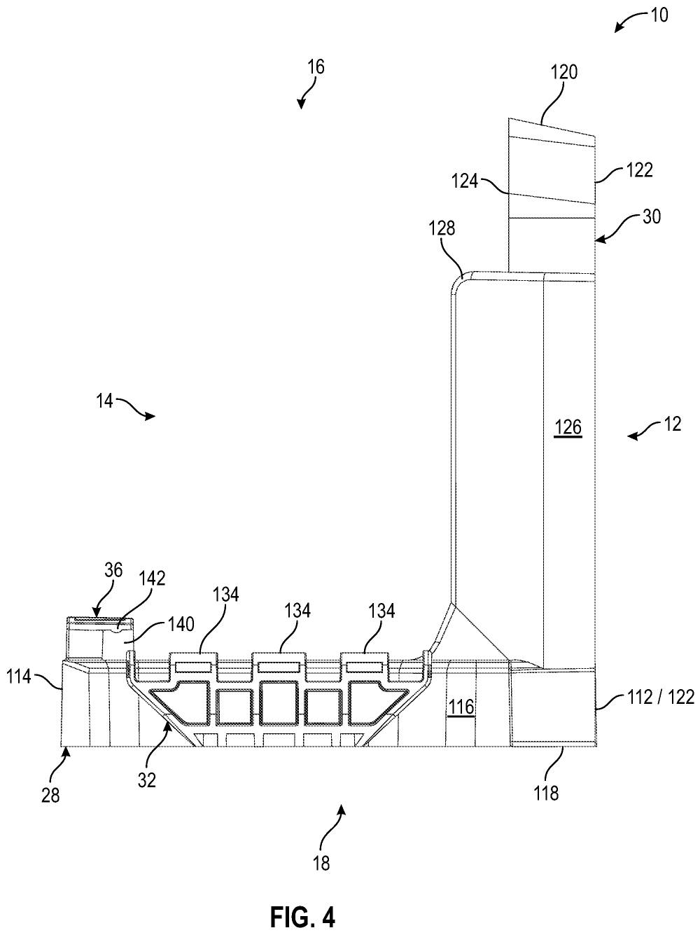

FIG. 5 shows a left side view of a docking station system, in accordance with one or more embodiments.

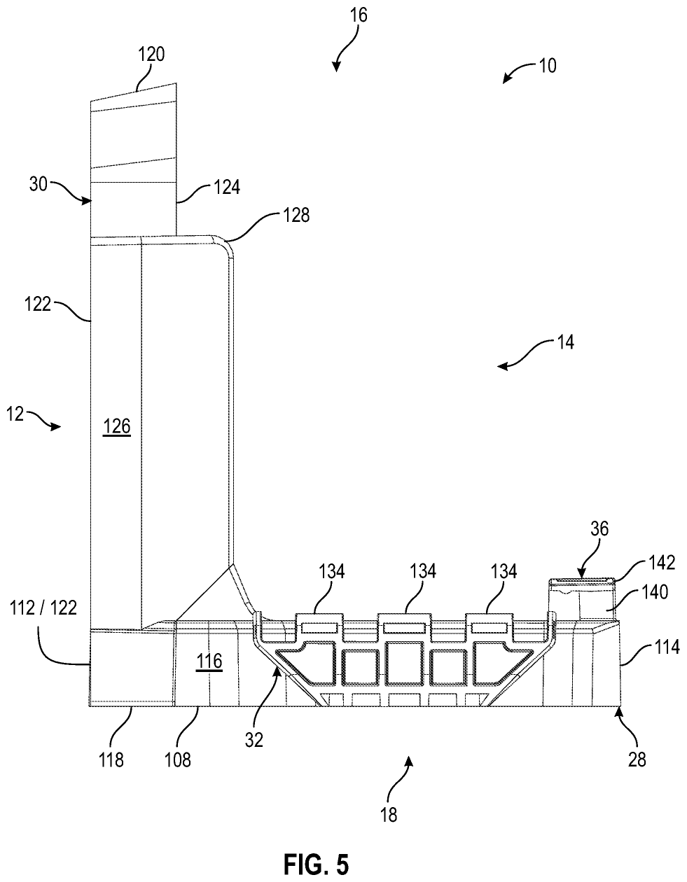

FIG. 6 shows an upper front right perspective view of a docking station system, in accordance with one or more embodiments.

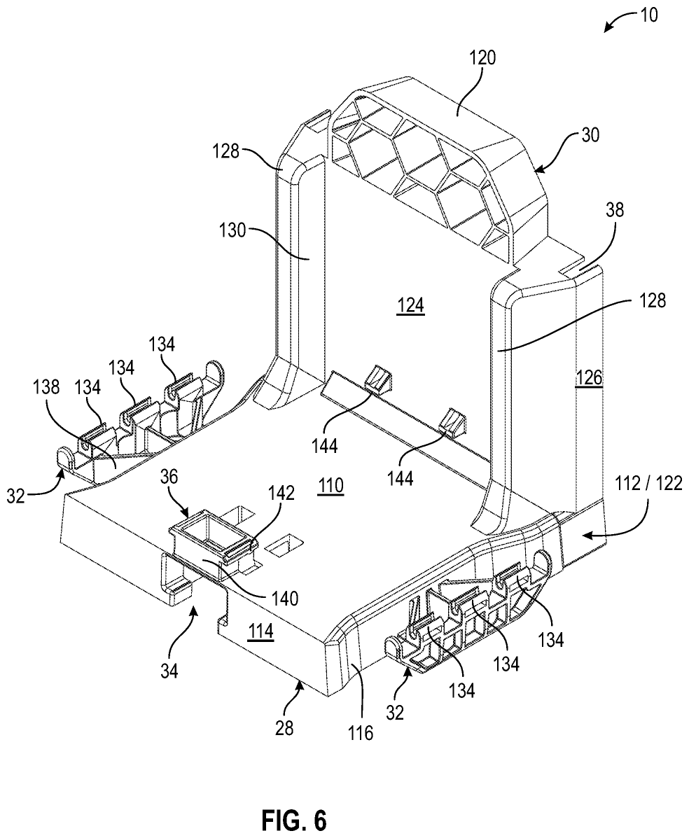

FIG. 7 shows an upper front left perspective view of a docking station system, in accordance with one or more embodiments.

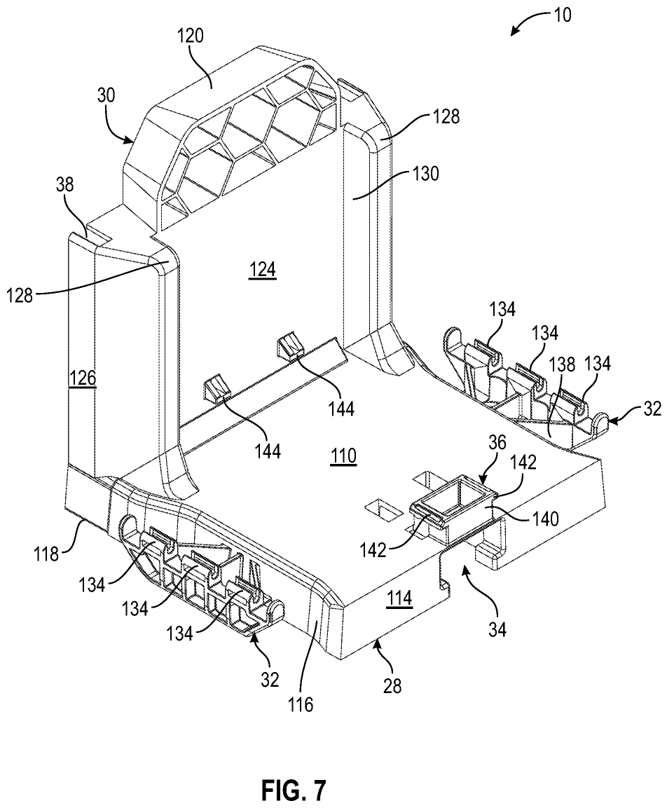

FIG. 8 shows an upper rear left perspective view of a docking station system, in accordance with one or more embodiments.

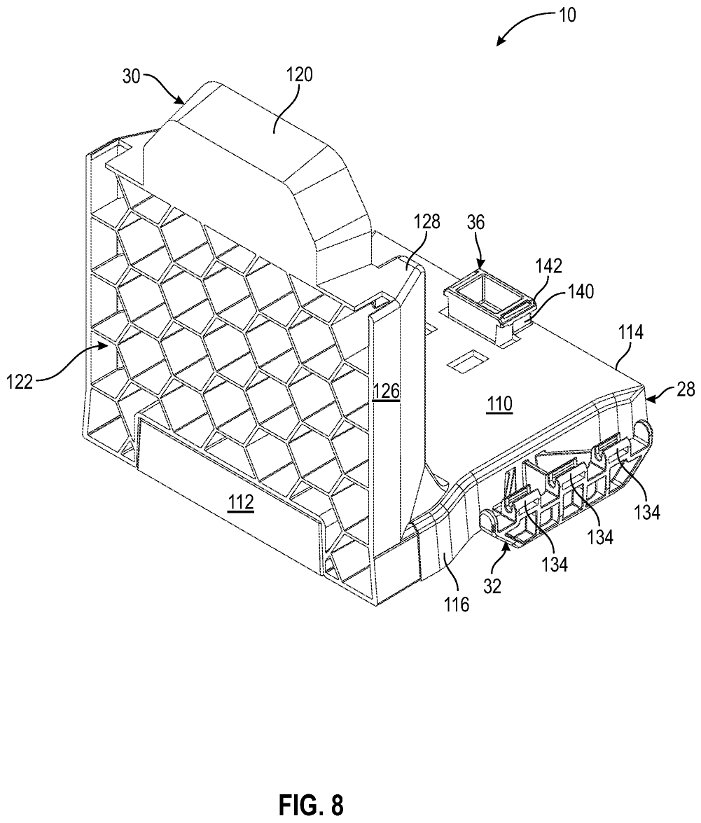

FIG. 9 shows an upper rear right perspective view of a docking station system, in accordance with one or more embodiments.

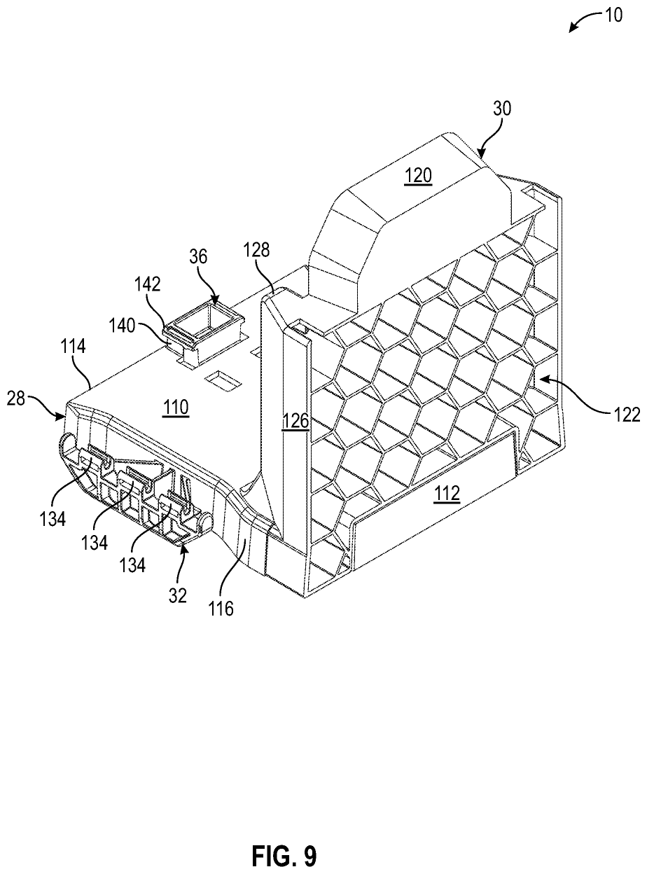

FIG. 10 shows a lower rear right perspective view of a docking station system, in accordance with one or more embodiments.

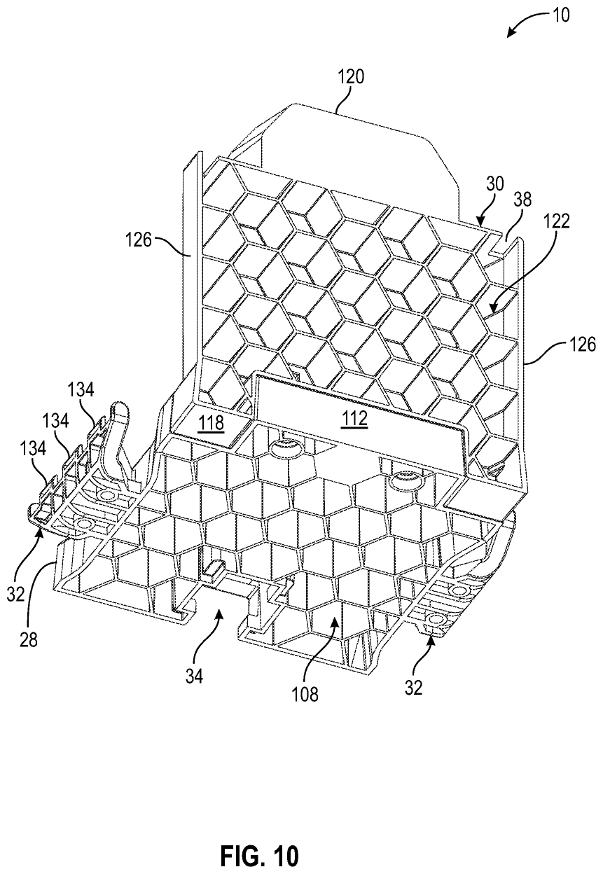

FIG. 11 shows a lower rear left perspective view of a docking station system, in accordance with one or more embodiments.

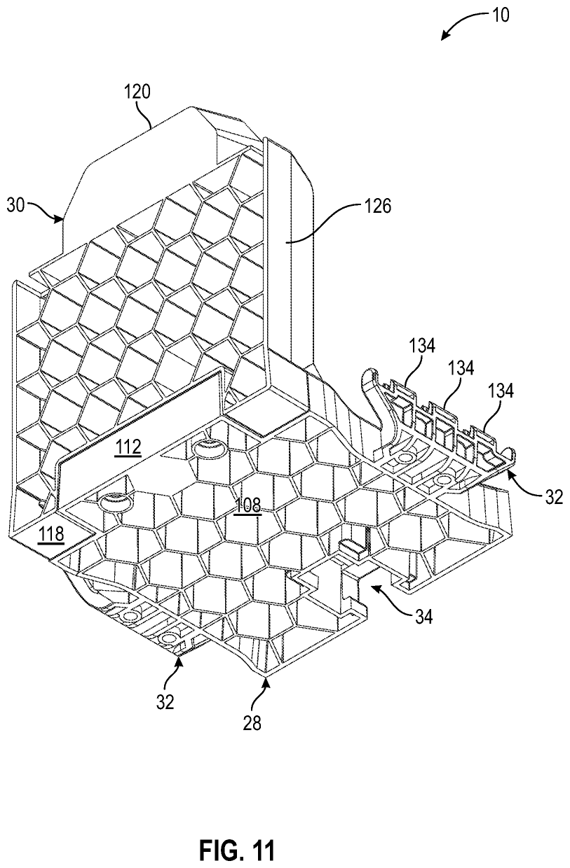

FIG. 12 shows a lower front right perspective view of a docking station system, in accordance with one or more embodiments.

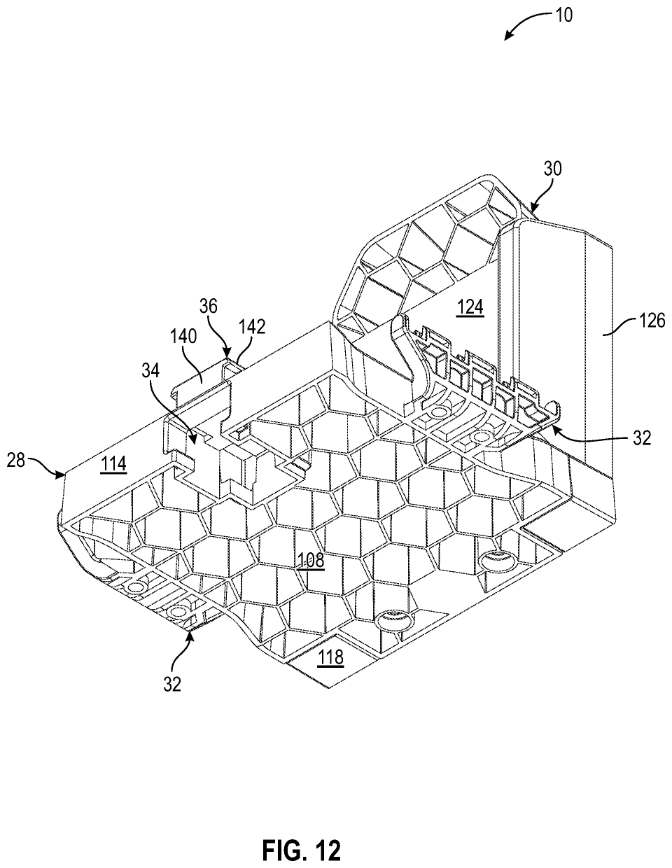

FIG. 13 shows a lower front left perspective view of a docking station system, in accordance with one or more embodiments.

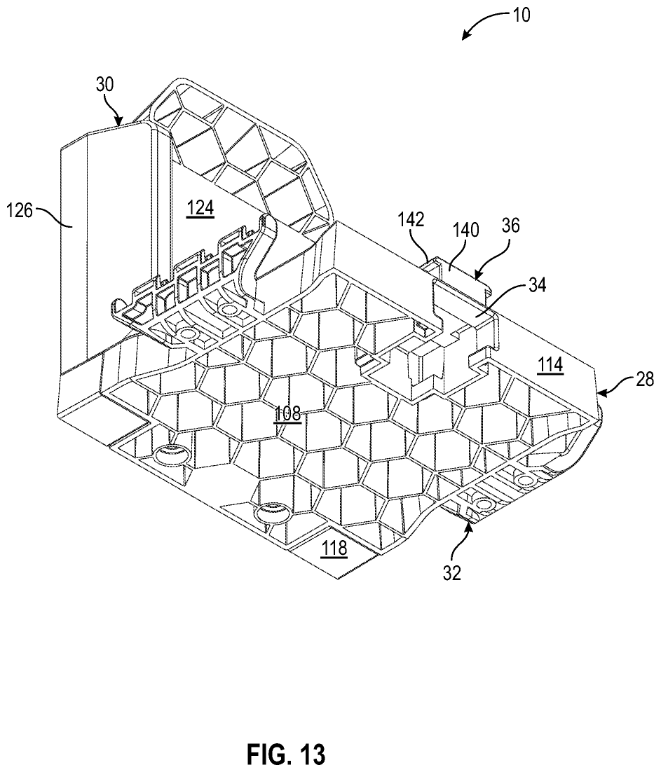

FIG. 14 shows a back side view of a docking station system, in accordance with one or more embodiments; the view showing side support positioned for connection to the docking station system.

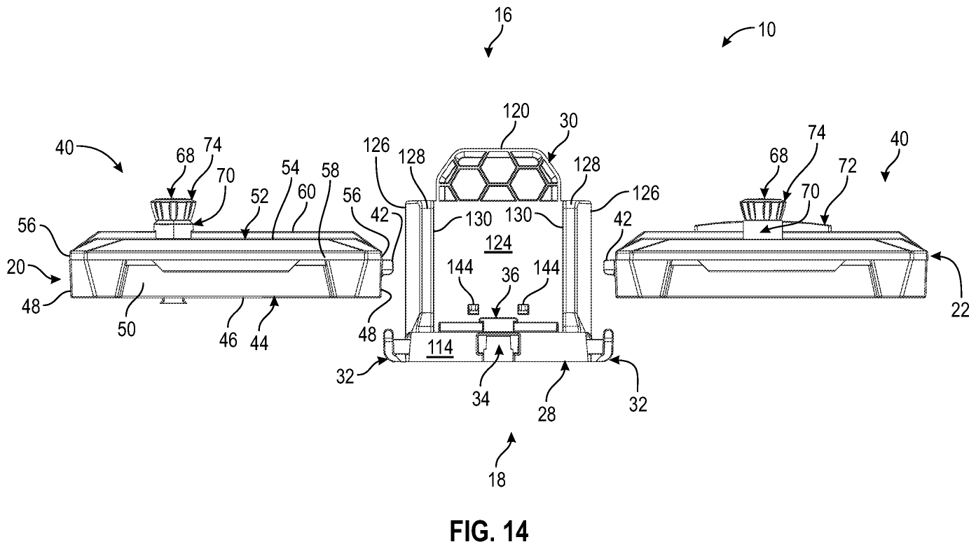

FIG. 15 shows a close up upper rear left perspective view of a docking station system and side supports, in accordance with one or more embodiments.

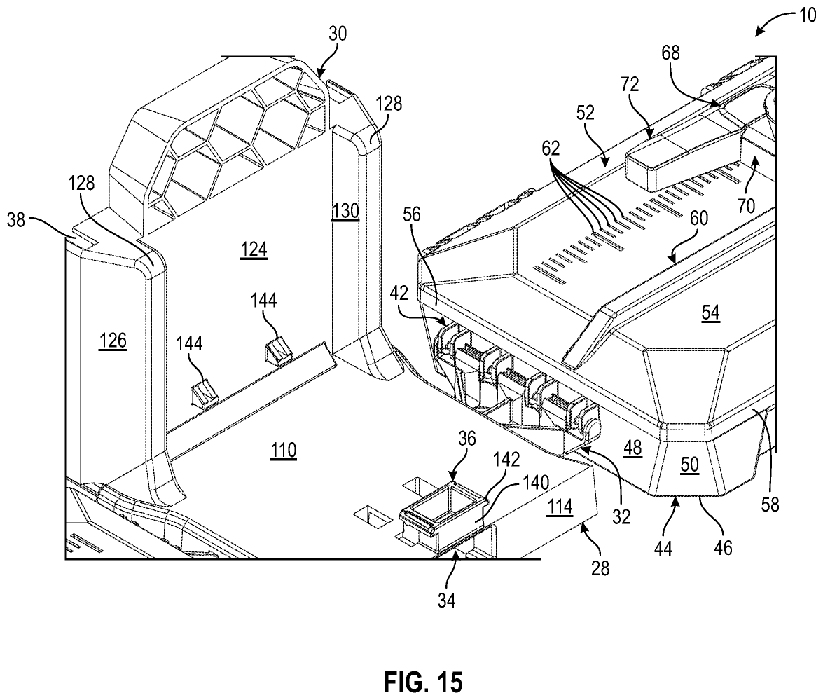

FIG. 16 shows a back side view of a docking station system with side supports, in accordance with one or more embodiments.

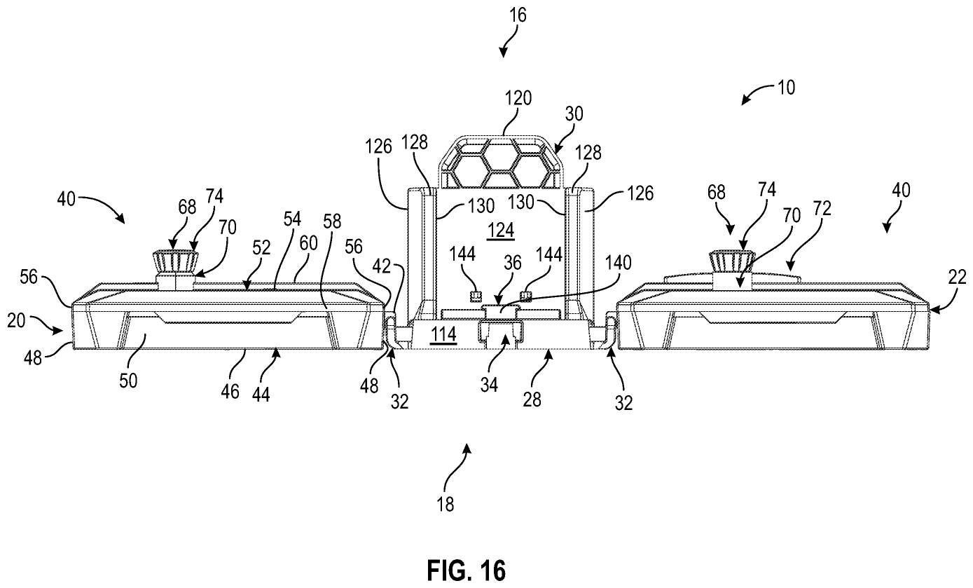

FIG. 17 shows a top side view of a docking station system with side supports, in accordance with one or more embodiments.

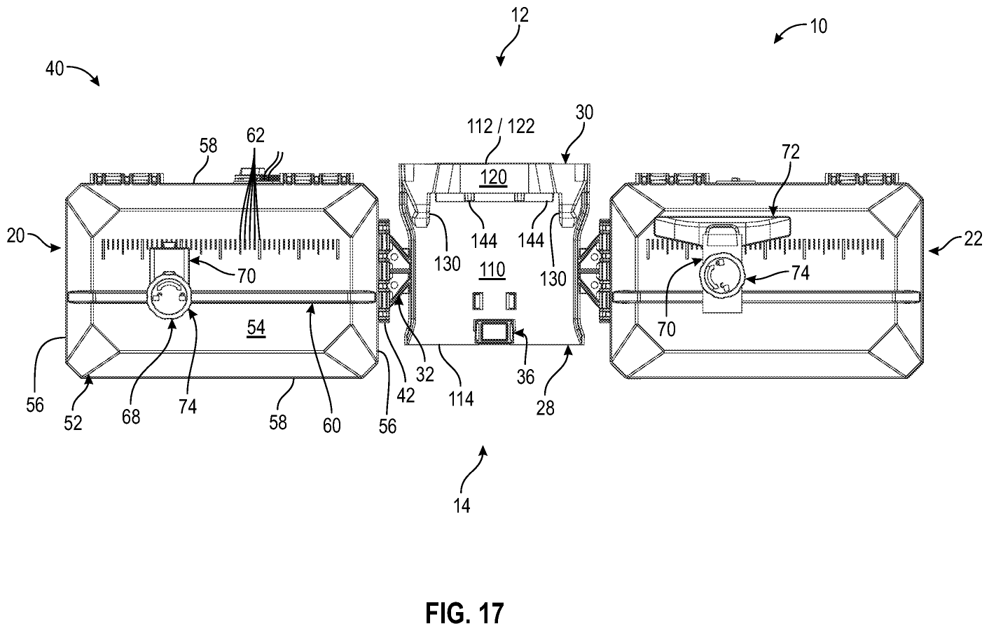

FIG. 18 shows an upper rear left perspective view of a docking station system with side supports, in accordance with one or more embodiments.

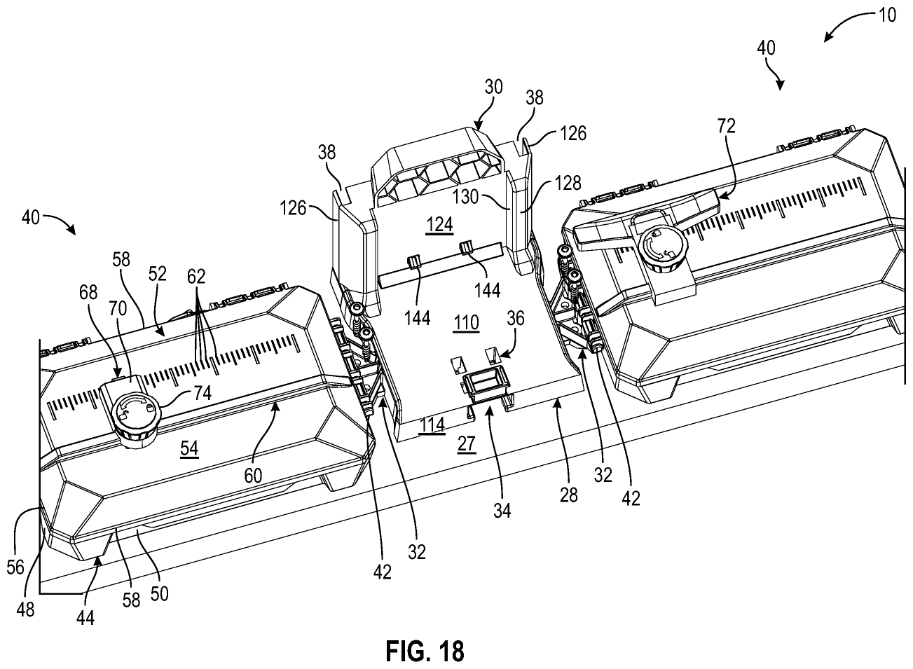

FIG. 19 shows a close up upper rear left perspective view of a docking station system with side supports, in accordance with one or more embodiments.

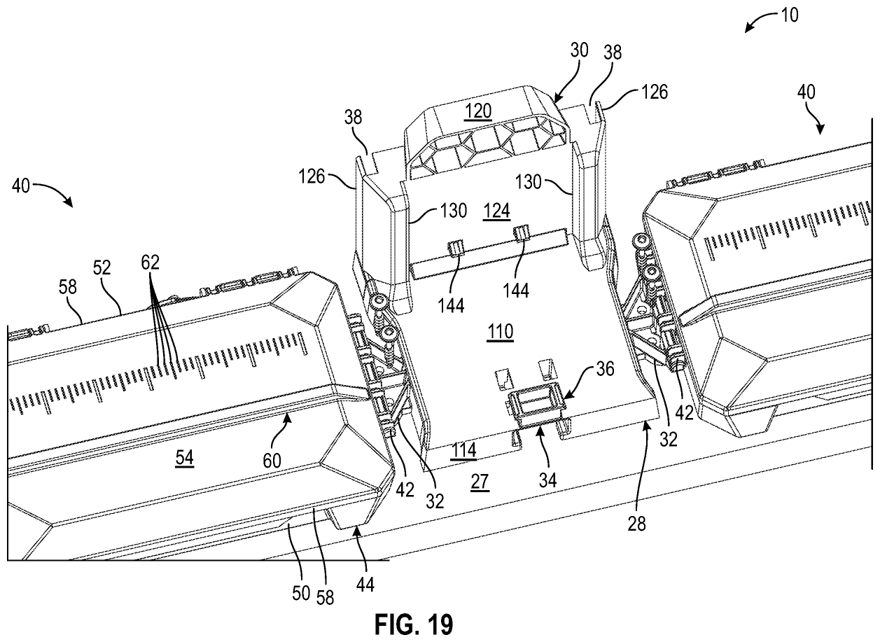

FIG. 20 shows a close up upper rear left perspective view of a docking station system with side supports, in accordance with one or more embodiments.

FIG. 21 shows an upper front right perspective view of a docking station system with side supports and pocket hole jig system, in accordance with one or more embodiments; the view showing the pocket hole jig system detached from the docking stating system.

FIG. 22 shows an upper front left perspective view of a docking station system with side supports and pocket hole jig system, in accordance with one or more embodiments; the view showing the pocket hole jig system detached from the docking stating system.

FIG. 23 shows an upper rear left perspective view of a docking station system with side supports and pocket hole jig system, in accordance with one or more embodiments; the view showing the pocket hole jig system detached from the docking stating system.

FIG. 24 shows an upper rear right perspective view of a docking station system with side supports and pocket hole jig system, in accordance with one or more embodiments; the view showing the pocket hole jig system detached from the docking stating system.

FIG. 25 shows a rear view of a docking station system with side supports and pocket hole jig system, in accordance with one or more embodiments; the view showing the pocket hole jig system detached from the docking stating system.

FIG. 26 shows a rear view of a docking station system with side supports and pocket hole jig system, in accordance with one or more embodiments; the view showing the pocket hole jig system attached to the docking stating system.

FIG. 27 shows an upper rear right perspective view of a docking station system with side supports and pocket hole jig system, in accordance with one or more embodiments; the view showing the pocket hole jig system attached to the docking stating system.

FIG. 28 shows an upper rear left perspective view of a docking station system with side supports and pocket hole jig system, in accordance with one or more embodiments; the view showing the pocket hole jig system attached to the docking stating system.

FIG. 29 shows a close up rear side cross sectional view of docking station system and pocket hole jig system connected together, in accordance with one or more embodiments.

FIG. 30 shows an upper rear right perspective view of a docking station system with side supports and pocket hole jig system, in accordance with one or more embodiments; the view showing the pocket hole jig system attached to the docking stating system; the view showing the docking station system clamped to a work surface.

FIG. 31 shows a top side view of a docking station system with side supports and pocket hole jig system, in accordance with one or more embodiments; the view showing the pocket hole jig system attached to the docking stating system.

FIG. 32 shows a bottom side view of a docking station system with side supports and pocket hole jig system, in accordance with one or more embodiments; the view showing the pocket hole jig system attached to the docking stating system.

FIG. 33 shows a left side view of a docking station system with side supports and pocket hole jig system, in accordance with one or more embodiments; the view showing the pocket hole jig system attached to the docking stating system.

FIG. 34 shows a right side view of a docking station system with side supports and pocket hole jig system, in accordance with one or more embodiments; the view showing the pocket hole jig system attached to the docking stating system.

FIG. 35 shows a front side view of a docking station system with side supports and pocket hole jig system, in accordance with one or more embodiments.

FIG. 36 shows a back side view of a docking station system with side supports and pocket hole jig system, in accordance with one or more embodiments; the view showing the pocket hole jig system attached to the docking stating system.

FIG. 37 shows an upper front right perspective view of a docking station system with side supports and pocket hole jig system, in accordance with one or more embodiments; the view showing the pocket hole jig system attached to the docking stating system.

FIG. 38 shows an upper front left perspective view of a docking station system with side supports and pocket hole jig system, in accordance with one or more embodiments; the view showing the pocket hole jig system attached to the docking stating system.

FIG. 39 shows an upper rear right perspective view of a docking station system with side supports and pocket hole jig system, in accordance with one or more embodiments; the view showing the pocket hole jig system attached to the docking stating system.

FIG. 40 shows an upper rear left perspective view of a docking station system with side supports and pocket hole jig system, in accordance with one or more embodiments; the view showing the pocket hole jig system attached to the docking stating system.

FIG. 41 shows a lower rear left perspective view of a docking station system with side supports and pocket hole jig system, in accordance with one or more embodiments; the view showing the pocket hole jig system attached to the docking stating system.

FIG. 42 shows a lower rear right perspective view of a docking station system with side supports and pocket hole jig system, in accordance with one or more embodiments; the view showing the pocket hole jig system attached to the docking stating system.

FIG. 43 shows an outer side view of an adapter bracket for connecting side supports to a docking station system, in accordance with one or more embodiments.

FIG. 44 shows a top side view of an adapter bracket for connecting side supports to a docking station system, in accordance with one or more embodiments.

FIG. 45 shows a bottom side view of an adapter bracket for connecting side supports to a docking station system, in accordance with one or more embodiments.

FIG. 46 shows a front view of an adapter bracket for connecting side supports to a docking station system, in accordance with one or more embodiments.

FIG. 47 shows a rear view of an adapter bracket for connecting side supports to a docking station system, in accordance with one or more embodiments.

FIG. 48 shows an upper rear right perspective view of an adapter bracket for connecting side supports to a docking station system, in accordance with one or more embodiments.

FIG. 49 shows an upper front right perspective view of an adapter bracket for connecting side supports to a docking station system, in accordance with one or more embodiments.

FIG. 50 shows an upper rear left perspective view of an adapter bracket for connecting side supports to a docking station system, in accordance with one or more embodiments.

FIG. 51 shows an upper front left perspective view of an adapter bracket for connecting side supports to a docking station system, in accordance with one or more embodiments.

FIG. 52 shows a lower rear right perspective view of an adapter bracket for connecting side supports to a docking station system, in accordance with one or more embodiments.

FIG. 53 shows a lower front right perspective view of an adapter bracket for connecting side supports to a docking station system, in accordance with one or more embodiments.

FIG. 54 shows a lower rear left perspective view of an adapter bracket for connecting side supports to a docking station system, in accordance with one or more embodiments.

FIG. 55 shows a lower front left perspective view of an adapter bracket for connecting side supports to a docking station system, in accordance with one or more embodiments.

FIG. 56 shows a close up upper front left perspective view of a docking station system and an adapter bracket, in accordance with one or more embodiments; the view showing the adapter bracket positioned for connection with the docket station system.

FIG. 57 shows a close up upper front left perspective view of a docking station system and an adapter bracket, in accordance with one or more embodiments; the view showing the adapter bracket connected with the docket station system.

FIG. 58 shows a close up left side view of a docking station system, side support, and pocket hole jig system, in accordance with one or more embodiments.

FIG. 59 shows an upper rear left perspective view of a docking station system with side supports and pocket hole jig system, in accordance with one or more embodiments; the view showing the pocket hole jig system attached to the docking stating system; the view showing side supports in a retracted position; the view showing docking station system clamped to a work surface.

FIG. 60 shows an upper rear left perspective view of a docking station system with side supports and pocket hole jig system, in accordance with one or more embodiments; the view showing the pocket hole jig system attached to the docking stating system; the view showing side supports in an extended position; the view showing docking station system clamped to a work surface; the view showing a workpiece held by the pocket hole jig system.

FIG. 61 shows an upper rear left exploded perspective view of a stop member of a side support for used with a docking station system, in accordance with one or more embodiments

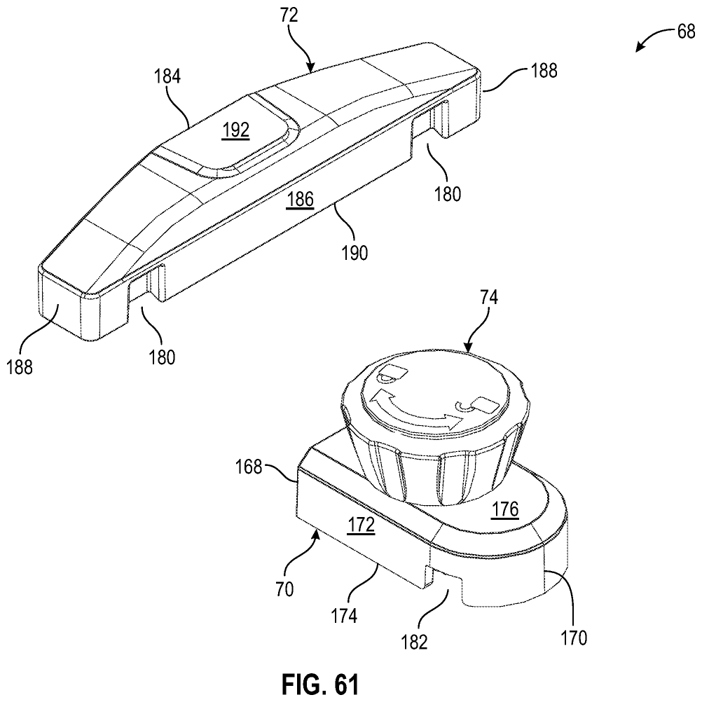

FIG. 62 shows an upper rear left perspective view of a stop member of a side support for used with a docking station system, in accordance with one or more embodiments; the view showing a locking member connected to an extension member of the stop member at a first position.

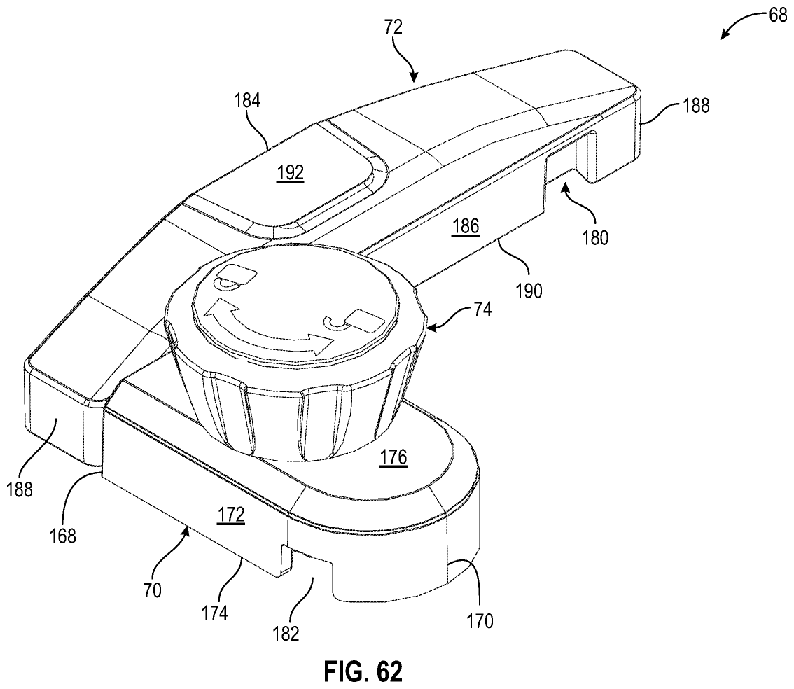

FIG. 63 shows an upper rear left perspective view of a stop member of a side support for used with a docking station system, in accordance with one or more embodiments; the view showing a locking member connected to an extension member of the stop member at a second position.

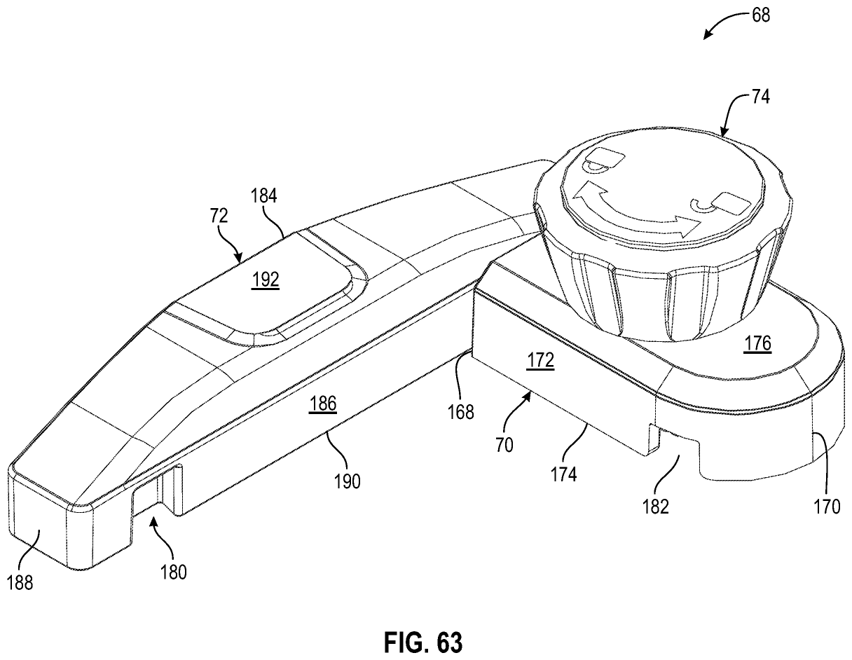

FIG. 64 shows a lower front right perspective view of a stop member of a side support for used with a docking station system, in accordance with one or more embodiments.

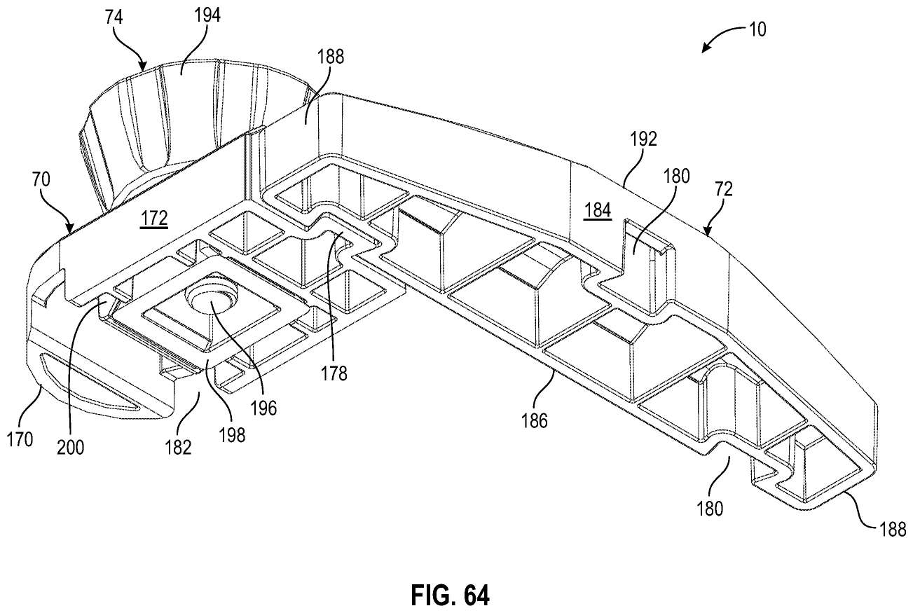

FIG. 65 shows an upper rear left perspective view of a docking station system with side supports and pocket hole jig system, in accordance with one or more embodiments; the view showing the pocket hole jig system attached to the docking stating system; the view showing docking station system clamped to a work surface.

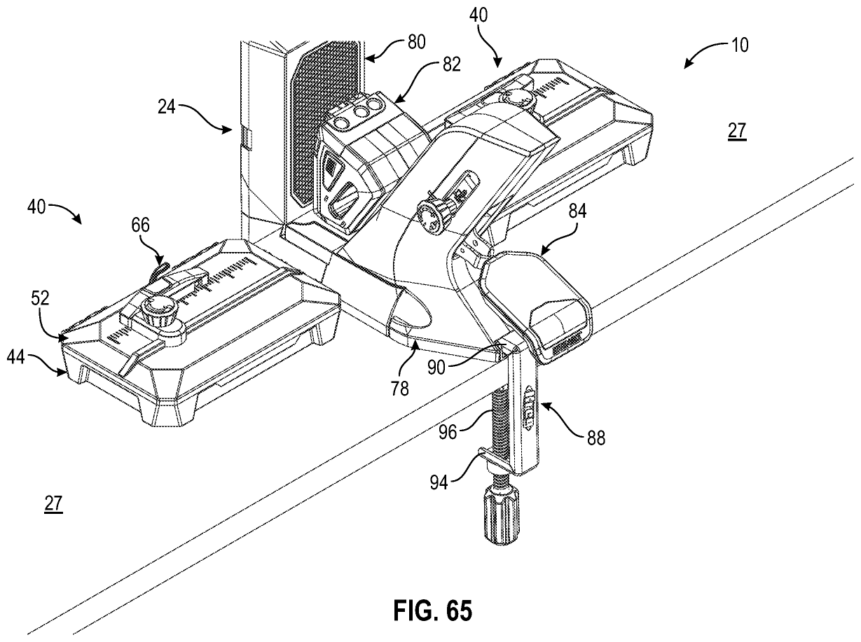

FIG. 66 shows an upper rear left perspective view of a docking station system with side supports and pocket hole jig system, in accordance with one or more embodiments; the view showing the pocket hole jig system attached to the docking stating system; the view showing docking station system clamped to a work surface; the view showing a workpiece held by the pocket hole jig system.

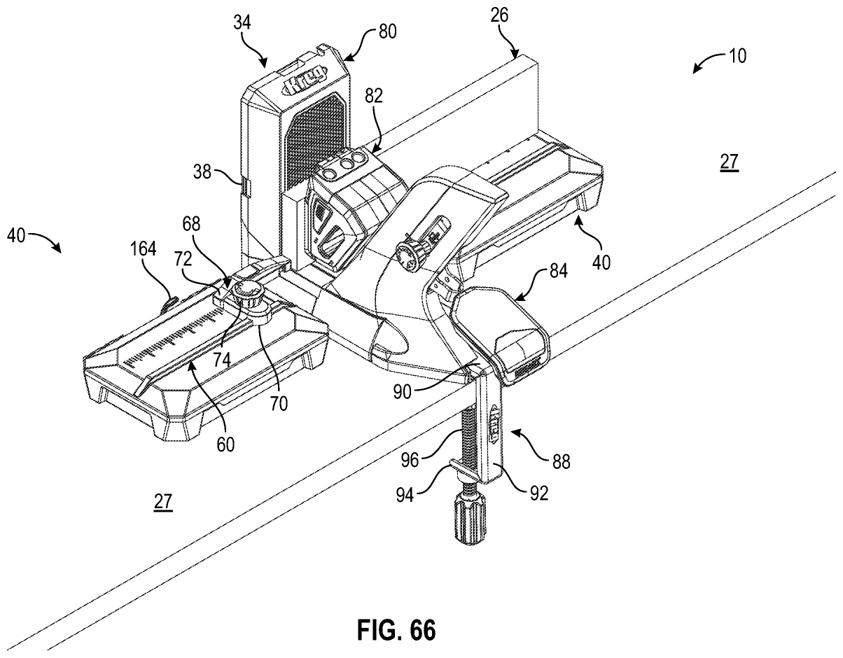

FIG. 67 shows an upper rear right perspective view of an example side support, in accordance with one or more embodiments; the view showing an interior of the side support.

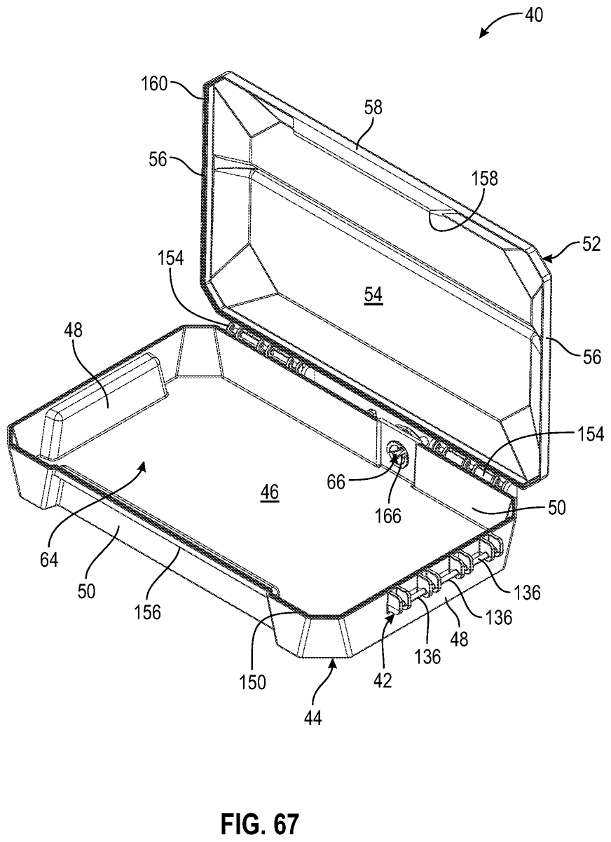

FIG. 68 shows an upper rear left perspective view of an example side support, in accordance with one or more embodiments; the view showing an interior of the side support.

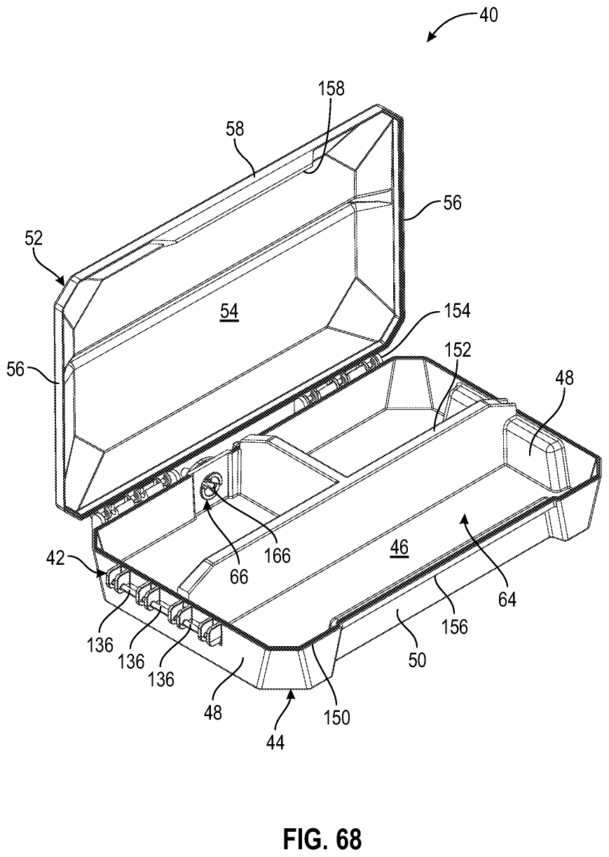

FIG. 69 shows an upper rear right perspective view of a docking station system with side supports and pocket hole jig system, in accordance with one or more embodiments; the view showing an interior of the side supports.

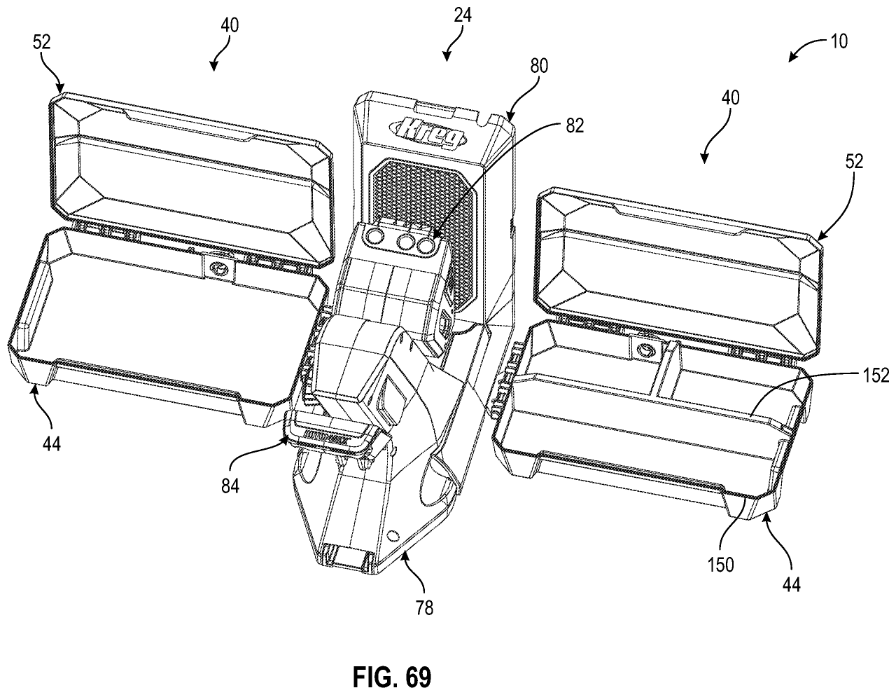

FIG. 70 shows a close up upper front left perspective view of a docking station system with side supports and pocket hole jig system, in accordance with one or more embodiments; the view showing side supports lifted to a retracted position.

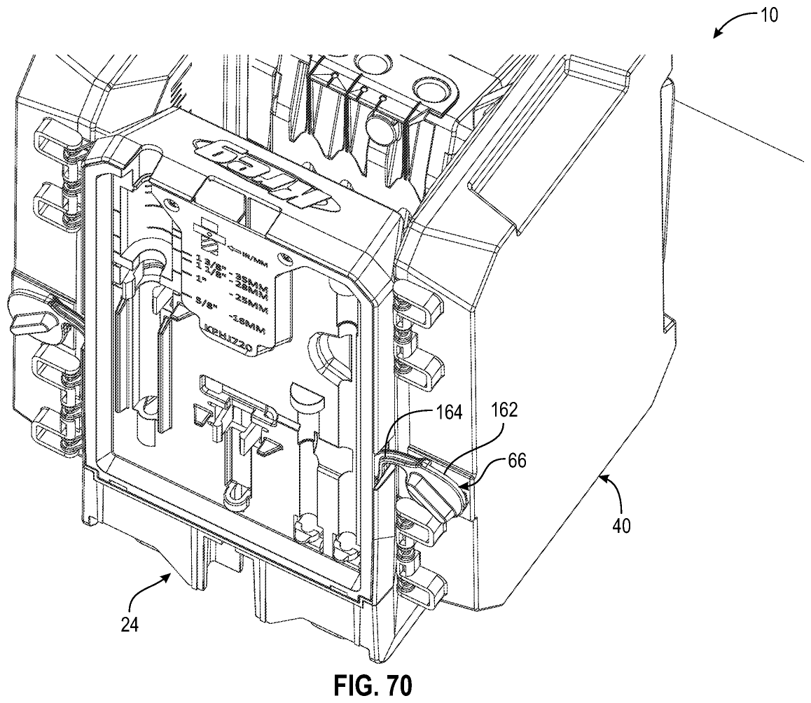

FIG. 71 shows an upper front left perspective view of a docking station system with side supports and pocket hole jig system, in accordance with one or more embodiments; the view showing side supports lifted to a retracted position.

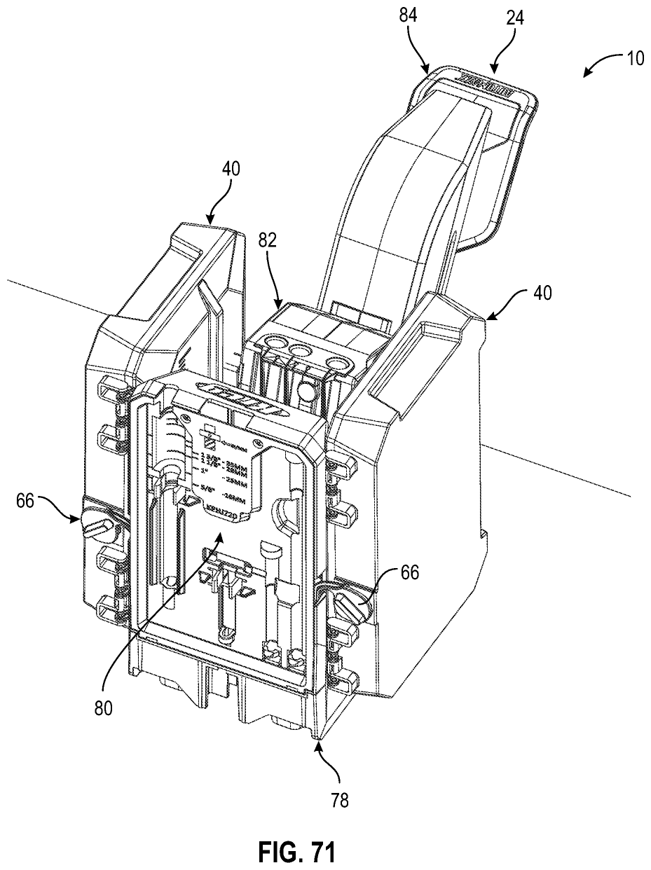

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, the term “or” includes one or more of the associated listed items, such that “A or B” means “either A or B”. As used herein, the term “and” includes all combinations of one or more of the associated listed items, such that “A and B” means “A as well as B.” The use of “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of use in association with pocket hole jigs and other jigs and tools. However, the embodiments are not so limited. It is appreciated that the embodiments may be adapted for use in various other applications, which may be improved by the disclosed structures, arrangements and/or methods. The system is merely shown and described as being used in the context of use with pocket hole jigs for ease of description and as one of countless examples.

System 10:

In the arrangement shown, as one example, a docking station system 10 (or simply “system 10”) is presented. In the arrangement shown, as one example, docking station system 10 has a forward end 12, a rearward end 14, a top side 16, a bottom side 18, a left side 20 and a right side 22.

Docking station system 10 is formed of any suitable size, shape and design and is configured facilitate quick and easy and secure attachment to various jigs, such as pocket hole jig system 24 and provides improved support and alignment of workpieces 26 of various thickness as well as various sizes and shapes on a work surface 27.

In one arrangement, docking station system 10 includes a base section 28, an upright section 30, hinge members 32, a clamp receiver 34, a connection member 36, and a lock member 38, among other parts, components, systems and feature as are described herein.

In one arrangement, docking station system 10 includes side supports 40 having a hinge member 42; a base member 44 having a bottom wall 46, end walls 48 and sidewalls 50; a cover member 52 having top wall 54, end walls 56 and sidewalls 58, a guide member 60 and indicia 62; a hollow interior 64 and a lock member 66, among other parts, components, systems and feature as are described herein.

In one arrangement, docking station system 10 includes a stop member 68 having a main body 70, an extension member 72 and a locking member 74, among other parts, components, systems and feature as are described herein.

In one arrangement, docking station system 10 is configured to receive a pocket hole jig system 24 having a base 78 having a connection member 86, an upright assembly 80, a drill guide assembly 82, a clamp assembly 84, and a connection member 86, among other parts, components, systems and feature as are described herein.

In one arrangement, docking station system 10 is configured to receive a clamp 88 having a first section 90, a second section 92, a third section 94 and an adjustment member 96, among other parts, components, systems and feature as are described herein.

In one arrangement, docking station system 10 includes an adapter bracket 98 having a base section 100, a hinge member 102 and connection members 104, among other parts, components, systems and feature as are described herein.

Not Limited to Pocket Hole Jigs:

It is to be noted, that while various views show use of docking station system 10 in association with a pocket hole jig system 24, and the disclosure discusses use of docking station system 10 in association with a pocket hole jig system 24, it is to be understood that use of docking station 10 in association with a pocket hole jig system 24 is only one of countless examples of use and is not meant to be limiting. Instead, it is hereby contemplated that docking station system 10 may be used with any jig system or any holding device or any other tool for that matter.

Not Limited to Woodworking:

It is to be noted, that docking station system 10 is not limited to use with workpieces 26 that are formed of wood or a wood-like composite material. Instead, it is hereby contemplated that docking station system 10 may be used with any form of material or workpiece 26 such as plastic, metallic, stone, ceramic, concrete, or any other material or combination of materials.

Workpiece 26:

In the arrangement shown, as one example, docking station system 10 is used to form pocket holes in a workpiece 26. Workpiece 26 may be formed of any size, shape and design. In the arrangement shown, as one example, workpiece 26 is a generally planar shaped piece of material that may be formed of wood, plywood, composite wood, plastic, MFD (medium density fiberboard) or any other material. Workpiece 26 may be a solid piece of wood, or it may be a composite piece of wood or other material. Workpiece 26 may be a large planar member, such as a four-by-eight sheet of plywood, or it may be a narrow and small member such as a piece of face-frame, or workpiece 26 may be anything in-between. Workpiece 26 may be thick, such as one and a half inches thick, such as a two-by-four, or thicker; or workpiece 26 may be as narrow as half an inch, or thinner. Essentially workpiece 26 may be formed of any size, shape and design.

Work Surface 27:

In the arrangement shown, as one example, docking station system 10 is used in association with work surface 27. Work surface 27 may be formed of any size, shape and design. In the arrangement shown, as one example, work surface 27 is a generally planar and flat surface that the bottom side 18 of docking station system 10 rests upon. In this way, when the flat bottom side 18 of docking station system 10 rests upon the flat work surface 27 a stable and secure platform and engagement is provided. In one arrangement, work surface is formed of a piece of material that may be formed of wood, plywood, composite wood, plastic, MFD (medium density fiberboard) or any other material. In one arrangement, work surface 27 receives the lower end of fasteners 106 that extend through docking station system 10 and into work surface 27, thereby securing docking station system 10 to work surface 27.

Base Section 28:

In the arrangement shown, as one example, docking station system 10 includes a base section 28. Base section 28 may be formed of any suitable size, shape and design and is configured to provide support and structural rigidity to docking station system 10 as well as connect upright section 30 and hinge members 32, provide support for docking station system 10 as well as receive pocket hole jig system 24, among other features and benefits.

In the arrangement shown, as one example, base section 28 is a generally square or rectangular member that has a lower face 108 and an upper face 110, a forward end 112 and a rearward end 114, and opposing sidewalls 116, among other features.

In the arrangement shown, as one example, lower face 108 forms a generally flat and planar surface or plane that is configured to rest in flat and flush engagement with the upper surface of work surface 27. In this way, the generally flat plane of lower face 108 provides a stable base for docking station system 10.

In the arrangement shown, as one example, upper face 110 forms a generally flat and planar surface or plane that is configured to receive the lower end of base 78 of pocket hole jig system 24 in flat and flush engagement. In this way, the generally flat plane of upper face 110 provides a stable base for receiving pocket hole jig system 24. In the arrangement shown, as one example, the planes that form lower face 108 and upper face 110 extend in approximate parallel planar spaced alignment to one another.

In the arrangement shown, as one example, forward end 112 forms a generally flat and planar surface or plane. In the arrangement shown, as one example, rearward end 114 forms a generally flat and planar surface or plane. In the arrangement shown, as one example, the planes that form forward end 112 and rearward end 114 extend in approximate parallel planar spaced alignment to one another.

In the arrangement shown, as one example, the planes that form lower face 108 and upper face 110 extend in approximate perpendicular planar alignment to the planes that form forward end 112 and rearward end 114. However, any other arrangement is hereby contemplated for use.

In the arrangement shown, as one example, opposing sidewalls 116 enclose the sides of base section 28. In the arrangement shown, as one example, opposing sidewalls 116 extend in approximate parallel spaced relation to one another, however in one arrangement, when viewed from above or below, sidewalls 116 slightly curve or angle or recess inward so as to provide room and access for hinge member 32. In the arrangement shown, as one example, opposing sidewalls 116 extend in approximate perpendicular planar alignment to the planes that form forward end 112 and rearward end 114. In the arrangement shown, as one example, opposing sidewalls 116 extend in approximate perpendicular planar alignment to the planes that form lower face 108 and upper face 110.

In the arrangement shown, as one example, upright section 30 connects adjacent the forward end 112 of base section 28. In the arrangement shown, as one example, hinge members 32 connect adjacent the sidewalls 116 of base section 28.

Upright Section 30:

In the arrangement shown, as one example, docking station system 10 includes an upright section 30. Upright section 30 may be formed of any suitable size, shape and design and is configured to provide support and structural rigidity to docking station system 10 as well as connect to base section 28 and receive upright assembly 80 of pocket hole jig system 24, among other features and benefits.

In the arrangement shown, as one example, upright section 30 is a generally square or rectangular member that has a lower end 118 and an upper end 120, a forward face 122 and a rearward face 124, and opposing sidewalls 126, among other features.

In the arrangement shown, as one example, lower end 118 forms a generally flat and planar surface or plane that is configured to rest in flat and flush engagement with the upper surface of work surface 27. In this way, the generally flat plane of lower end 118 provides a stable base for docking station system 10. In one arrangement, the lower end 118 of upright section 30 and the forward end 112 of base section 28 include interlocking or meshing features, such as a centrally positioned cut-out section of one of the upright section 30 and base section 28 that is positioned between outwardly positioned protrusions in the other of the upright section 30 and base section 28 that enclose the generally centrally positioned cut-out section.

In the arrangement shown, as one example, upper end 120 terminates in a free end. In the arrangement shown, as one example, upper end 120 forms a generally flat and planar surface or plane that with a generally centrally positioned upward extension of upright section 30. In the arrangement shown, as one example, the planes that form upper end 120 and lower end 118 extend in approximate parallel planar spaced alignment to one another.

In the arrangement shown, as one example, forward face 122 forms a generally flat and planar surface or plane.

In the arrangement shown, as one example, rearward face 124 forms a generally flat and planar surface or plane that is configured to receive the forward end of upright assembly 80 of pocket hole jig system 24 in generally flat and flush engagement. In this way, the generally flat plane of rearward face 124 provides secure attachment for as well as additional strength of rigidity to pocket hole jig system 24. In the arrangement shown, as one example, the planes that form forward face 122 and rearward face 124 extend in approximate parallel planar spaced alignment to one another.

In the arrangement shown, as one example, opposing sidewalls 126 enclose the sides of upright section 30. In the arrangement shown, as one example, opposing sidewalls 126 extend in approximate parallel spaced relation to one another. In the arrangement shown, as one example, opposing sidewalls 126 extend in approximate perpendicular planar alignment to the planes that form forward face 122 and rearward face 124. In the arrangement shown, as one example, opposing sidewalls 126 extend in approximate perpendicular planar alignment to the planes that form lower end 118 and upper end 120.

In the arrangement shown, as one example, a guide 128 is positioned adjacent each sidewall 126, or adjacent each outward side of rearward face 124. In the arrangement shown, as one example, guides 128 extend rearward a distance from rearward face 124. In the arrangement shown, as one example, the distance between the inward facing sides 130 of guides 128 is sized and shaped to receive upright assembly 80 of pocket hole jig system 24 there between with close and tight tolerances. In this way, the presence of rearward extending guides 128 in upright section 30 helps to align and guide upright assembly 80 of pocket hole jig system 24 during installation. In addition, once pocket hole jig system 24 is installed, the presence of guides 128 on each side of upright assembly 80 of pocket hole jig system 24 forms a more rigid and durable assembly that tightly and securely and rigidly holds pocket hole jig system 24 within docking station system 10. Or, more specifically, that tightly and securely and rigidly holds upright assembly 80 of pocket hole jig 24 within upright section 30 of docking station system 10.

In one arrangement, upright section 30 and base section 28 are formed of a single, monolithic and continuous member that is formed of a single piece of material such as through machining, forming, molding, casting, injection molding or the like processes. In an alternative arrangement, upright section 30 and base section 28 are formed of separate components that are connected to one another through a joining process such as by screwing, bolding, welding, adhering, gluing, friction fitting, interlocking or any other manner, method or means or any combination thereof.

In the arrangement shown, as one example, base section 28 and upright section 30 are formed of separate components. In the arrangement shown as one example, upright section 30 includes a notch at its lower end 118 that receives a protrusion at the forward end 112 of base section 28 in an interlocking manner. In addition, in the arrangement shown, as one example, when the lower end 118 of upright section 30 is interlocked with or engaged with the forward end 112 of base section 28, fasteners 132 extend through base section 28 and into upright section 30 thereby affixing base section 28 and upright section 30 together. However, any other manner, method or means of connecting base section 28 and upright section 30 together is hereby contemplated for use.

Lock Member 38:

In the arrangement shown, as one example, upright section 30 includes at least one lock member 38. Lock member 38 is formed of any suitable size, shape and design and is configured to receive a portion of lock member 66 of side supports 40 when side supports 40 are in a retracted position thereby holding the side support 40 in a retracted position. In the arrangement shown, as one example, a lock member 38 is positioned in each sidewall 126 of upright section 30 about mid-way between the upper end 120 and lower end 118. In the arrangement shown, as one example, lock member 38 is an opening in sidewall 126 that receives a portion of lock member 66 thereby locking side support 40 in a retracted position. However, any other arrangement or configuration for lock member 38 is hereby contemplated for use such as a friction fit member, a post, a hook, a loop, a lock, a stop, or any other member or combination thereof.

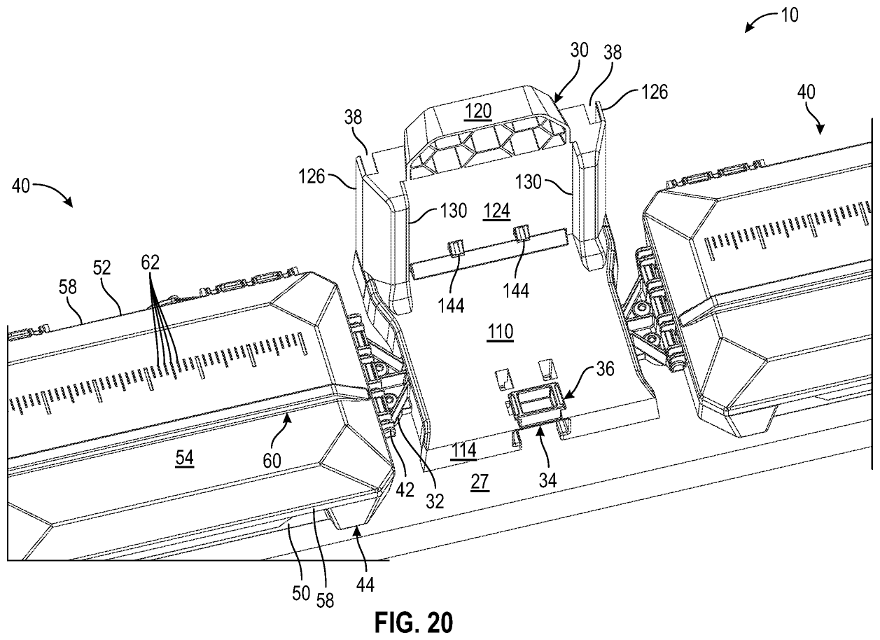

In one arrangement, lock member 38 is formed of a notch or slot in the upper outward edge of upright section 30 as is shown in FIG. 20 as one example.

Hinge Members 32:

In the arrangement shown, as one example, docking station system 10 includes at least one hinge member 32. Hinge members 32 may be formed of any suitable size, shape and design and are configured to facilitate the connection of side supports 40 to docking station system 10 or more specifically base section 28 while also allowing for movement between an extended position and a retracted position of side supports 40 upon base section 28.

In the arrangement shown, as one example, a hinge member 32 is positioned adjacent each sidewall 116 of base section 28 and hinge members 32 extend outward therefrom a distance. In the arrangement shown, as one example, when viewed from the forward end 12 or rearward end 14, hinge members 32 connect adjacent the lower end of sidewalls 116 and extend outward horizontally a distance before curving upward and extending in a vertical fashion before terminating in a hinge portion 134. Hinge portion 134 is formed of any suitable size, shape and design and is configured to engage a similar or corresponding hinge portion 136 of hinge member 42 of side support 40.

As is also shown, as one example, when viewed from the forward end 12 or rearward end 14, a support member 138 extends between sidewall 116 of base section 28 and the upwardly extending portion of hinge member 32. Support member 138 provides added strength and rigidity to hinge member 32.

In the arrangement shown, as one example, when viewed from the above or below, hinge members 32 connect adjacent their inward ends to sidewalls 116 and extend laterally outward as they angle outward as well before connecting to hinge portion 134.

In the arrangement shown, as one example, hinge portion 134 of hinge member 32 includes a plurality of upwardly facing C-shaped receivers that are configured to receive portions of hinge portion 136 of side supports 40. These C-shaped receivers may be referred to as sockets as they receive a portion of hinge portions 136 of side supports 40. However, any other arrangement or configuration is hereby contemplated for use as hinge members 32.

Clamp Receiver 34:

In the arrangement shown, as one example, docking station system 10 includes at least one clamp receiver 34. Clamp receiver 34 may be formed of any suitable size, shape and design and is configured to facilitate the connection of clamp 88 to docking station system 10 or more specifically base section 28 thereby facilitating clamping of docking station system 10 to work surface 27 to provide a stable and secure connection thereby improving safety, accuracy and ease of use.

In the arrangement shown, as one example, a clamp receiver 34 is formed of an opening or recess in rearward end 114 of base section 28 and extends forward a distance therein. In the arrangement shown, as one example, a single clamp receiver 34 is shown that is generally centrally positioned between opposing sidewalls 116, however any number of clamp receivers 34 as well as any other position of clamp receivers 34 is hereby contemplated for use. As one example, two clamp receivers 34 is hereby contemplated for use across the rearward end 114. In addition, it is hereby contemplated that a clamp receiver 34 may be placed in the forward end 112 of base section 28. It is also hereby contemplated that a clamp receiver 34 may be placed in upright section 30.

In the arrangement shown, as one example, when viewed from the rearward end 14 clamp receiver 34 is formed of a generally T-shaped slot that opens through the rearward end 114 of base section 28 with the narrow portion of the slot opening to the lower face 108 of base section 28. However, any other arrangement or configuration is hereby contemplated for use.

In the arrangement shown, as one example, when viewed from the lower face 108 clamp receiver 34 also includes a generally T-shaped slot that opens through the lower face 108 of base section 28 as well. However, any other arrangement or configuration is hereby contemplated for use.

Clamp receiver 34 is configured to receive clamp 88 therein as to facilitate clamping of docking station system 10 to work surface 27.

Clamp 88:

In the arrangement shown, as one example, docking station system 10 includes at least one clamp 88. Clamp 88 may be formed of any suitable size, shape and design and is configured to facilitate the connection of docking station system 10 to work surface 27 to provide a stable and secure connection thereby improving safety, accuracy and ease of use.

In the arrangement shown, as one example, a clamp 88 is formed of any clamping device. In the arrangement shown, as one example, clamp 88 is what is known as a generally C-shaped clamp or project clamp, however any other form of a clamping device is hereby contemplated for use.

In the arrangement shown as one example, clamp 88 includes a first section 90, a second section 92, a third section 94, and an adjustment member 96. In the arrangement shown, as one example, first section 90 extends in approximate perpendicular alignment to second section 92, and third section 94 extends in approximate perpendicular alignment to second section 92 and in approximate parallel spaced alignment to first section 90 thereby forming an approximate C-shaped member. In the arrangement shown, as one example, adjustment member 96 includes a threaded shaft that extends through third section 94 and includes a knob at a lower end and a pad at an upper end. As the knob is rotated the threaded shaft rotates through third section 94 moving the pad up or down thereby tightening clamp 88 to work surface 27 when the clamp pad engages the lower surface of work surface or loosening clamp 88 when the clamp pad disengages from the work surface 27.

In the arrangement shown, as one example, to clamp docking station system 10 to work surface 27, the forward end of first section 90 is inserted within clamp receiver 34, lower face 108 of base section 28 is placed upon the upper surface of work surface 27 and the opening of the C-shaped clamp 88 is placed around the edge of work surface 27. Once in this position, the knob of adjustment member 96 is rotated until the pad of adjustment member 96 engages the lower surface of work surface 27 until tight. Once in this position, docking station system 10 is secured in place and pocket hole jig system 24 may be installed upon docking station system 10 and pocket hole jigs can be formed without docking station 10 or pocket hole jig system 24 moving. This improves safety and increases accuracy of use of pocket hole jig system 24. Plus, this increases the ease of use and functionality.

To remove docking station system 10 from work surface 27, the knob of adjustment member 96 is rotated the opposite direction until the pad releases from work surface 27 and the docking station system 10 may be removed from work surface 27.

Any other form of a clamp system may be used as clamp 88 in a similar or identical manner to that described herein. This includes the use of what are known as project clamps, such as those manufactured by Irwin among others that utilize a grip tightening mechanism.

Connection Member 36:

In the arrangement shown, docking station system 10 includes a connection member 36. Connection member 36 may be formed of any suitable size, shape and design and is configured to facilitate the connection of pocket hole jig system 24, or any other jig or tool, to docking station system 10.

In the arrangement shown, as one example, connection member 36 includes a protrusion 140 positioned adjacent the rearward end 114 of base section 28 of docking station 10. In the arrangement shown, as one example, protrusion 140 extends upward from upper face 110 a distance and has a generally square or rectangular shape and terminates in an upper end that includes a pair flanges 142 that extend outward from the sides of protrusion 140. However, any other size, shape and configuration for connection member 36 is hereby contemplated for use.

Connection member 36 of base section 28 of docking station system 10 is configured to be received within connection member 86 of base 78 of pocket hole jig system 24 thereby locking pocket hole jig system 24 to docking station system 10. Connection member 86 of base 78 of pocket hole jig system 24 has a corresponding size and shape and configuration as connection member 36 of base section 28 of docking station system 10 so as to facilitate locking of pocket hole jig system 24 to docking station system 10.

In one arrangement, connection member 86 of base 78 of pocket hole jig system 24 is an opening in bottom side of base 78 and is placed over connection member 36 of base section 28 of docking station system 10. In one arrangement, once connection member 86 of base 78 of pocket hole jig system 24 is placed over connection member 36 of base section 28 of docking station system 10, pocket hole jig system 24 is locked to docking station system 10 by sliding pocket hole jig system 24 forward relative to docking station system 10, which engages the connection member 36 of base section 28 of docking station system 10 with the connection member 86 of base 78 of pocket hole jig system 24 in a locking manner. In this arrangement, the flanges 142 of connection member 36 of base section 28 of docking station system 10 are received, engaged and locked to internal features of connection member 86 of base 78 of pocket hole jig system 24. This prevents the unintentional removal of pocket hole jig system 24 from docking station system 10. In this example arrangement, pocket hole jig system 24 can only be removed from docking station system 10 by sliding pocket hole jig system 24 rearward relative to docking station system 10 until the flanges 142 of connection member 36 of base section 28 of docking station system 10 are disengaged from the internal features of connection member 86 of base 78 of pocket hole jig system 24. However, any other size, shape, placement or configuration is hereby contemplated for use.

In the arrangement shown, as one example, a pair of protrusions 144 extend rearward from rearward face 124 of upright section 30 of docking station system 10. These protrusions 144 are configured to be received within recesses 146 in the forward side 148 of upright assembly 80 of pocket hole jig system 24. In the arrangement shown, as one example, protrusions 144 have a generally horizontal and flat lower surface that extends outward from rearward face 124 of upright section 30 a distance and includes an upper surface that angles forward as it extends upward. In this way, when viewed from the side, protrusions 144 have a generally triangular shape.

In this arrangement, when pocket hole jig system 24 is locked into place on docking station system 10 these protrusions 144 are received within similarly shaped recesses 146 in forward side 148 of upright assembly 80 of pocket hole jig system 24. The engagement between the generally flat and horizontal lower surface of protrusions 144 with the upright assembly 80 of pocket hole jig system 24 prevents the forward end of pocket hole jig system 24 from rising or moving during use. However, any other size, shape, placement or configuration is hereby contemplated for use.

Side Supports 40:

In the arrangement shown, docking station system 10 includes one or more side supports 40. Side supports 40 may be formed of any suitable size, shape and design and are configured to connect to docking station system 10 and move between an extended position and a retracted position while also serving the purposes of providing storage as well as providing extended support for workpiece 26 and a place for stop member 68.

In the arrangement shown, as one example, side supports 40 have a hinge member 42; a base member 44 having a bottom wall 46, end walls 48 and sidewalls 50; a cover member 52 having top wall 54, end walls 56 and sidewalls 58, a guide member 60 and indicia 62; a hollow interior 64 and a lock member 66, among other parts, components, systems and feature as are described herein.

Hinge Member 42:

In the arrangement shown, as one example, side supports 40 include at least one hinge member 42. Hinge members 42 may be formed of any suitable size, shape and design and are configured to facilitate the connection of side supports 40 to hinge member 32 of docking station system 10, or more specifically base section 28 of docking station system 10, while also allowing for movement of side support 40 between an extended position and a retracted position upon base section 28.

In the arrangement shown, as one example, a hinge member 42 is positioned adjacent the inward facing end wall 48 of each side support 40 and extends outward therefrom a distance. In the arrangement shown, as one example, when viewed from the forward end 12 or rearward end 14, hinge members 42 connect adjacent the upper end of base member 44 and extend outward horizontally a distance toward base section 28 before terminating at a hinge portion 136. Hinge portion 136 is formed of any suitable size, shape and design and is configured to engage a similar or correspondingly shaped hinge portion 134 of hinge member 32 of base section 28 of docking station system 10.

In the arrangement shown, as one example, hinge portion 136 of side supports 40 includes a plurality of generally cylindrical shafts that extend laterally and/or horizontally between spaced support members. In the arrangement shown, as one example, these generally laterally and/or horizontally extending cylindrical shafts are configured to be received within the receivers or sockets of hinge portion 134 of hinge members 32 of base section 28.

In the arrangement shown, as one example, the generally cylindrical shafts of hinge portion 136 of side supports 40 are received within the receivers or sockets of hinge portion 134 of base section 28 thereby forming a functional hinge or joint that establishes an axis of rotation that facilitates side support 40 to rotate upon base section 28.

In the arrangement shown, as one example, hinge portion 134 of hinge member 32 of base section 28 of docking station system 10 include sockets that have a slot in their upper side that connect to a generally cylindrical opening at their approximate center. These sockets of hinge portion 134 of hinge member 32 of base section 28 of docking station system 10 are configured to receive the generally cylindrical shafts of hinge portion 136 of side supports 40 while allowing rotation therein.

In the arrangement shown, as one example, to install side support 40 upon base section 28, the generally cylindrical shafts of hinge portion 136 of side supports 40 are aligned with the upwardly facing slots in the hinge portion 134 of hinge member 32 of base section 28 of docking station system 10. First, the generally cylindrical shafts of a side support 40 is aligned with the slots in the upper side of sockets of base section 28. Once aligned in this manner, the side support 40 is forced downward until the generally cylindrical shafts of a side support 40 are received within the sockets of base section 28. Once in this position, side support 40 is fully installed upon base section 28 and side support 40 can freely move between an extend position and a retracted position.

As side support 40 moves between an extended position and a retracted position, side support 40 rotates upon an axis of rotation that extends through the overlapping center of hinge portion 134 of hinge member 32 of base section 28 of docking station system 10 and hinge portion 136 of side supports 40.

In the arrangement shown, as one example, a side support 40 is in an extended position when side support 40 is in a horizontal or lowered position. In the arrangement shown, as one example, a side support 40 is in a retracted position when side support 40 is in a vertical or raised position.

Base Member 44:

In the arrangement shown, as one example, side supports 40 include a base member 44. Base member 44 may be formed of any suitable size, shape and design and is configured form the lower side of side support 40 and facilitate connection of cover member 52 thereto as well as to facilitate storage of parts and components.

In the arrangement shown, as one example, base member 44 is formed of a generally square or rectangular shaped member when viewed from above or below, as well as when viewed from the forward side or rearward side, as well as when viewed from either end. In the arrangement shown, as one example, base member 44 includes a bottom wall 46, end walls 48 and sidewalls 50, among other features.

In the arrangement shown, as one example, bottom wall 46 is formed of a generally flat and planar member and serves to enclose the lower end of base member 44. In the arrangement shown, as one example, the lower surface of base member 44 is generally flat and planar and therefor provides stable support for resting upon the upper surface of work surface 27.

In the arrangement shown, as one example, bottom wall 46 connects at its outward ends to end walls 48 which extend upward therefrom a distance before terminating in an upper end at peripheral edge 150. In the arrangement shown, as one example, bottom wall 46 connects at its forward and rearward ends to sidewalls 50 which extend upward therefrom a distance before terminating in an upper end at peripheral edge 150.

In the arrangement shown, as one example, the upper end of end walls 48 and sidewalls 50 terminate in a peripheral edge 150 that forms the upper edge of base member 44 opposite bottom wall 46. In the arrangement shown, as one example, peripheral edge 150 is configured to be engaged by cover member 52 when cover member 52 is in a closed position.

In one arrangement, base member 44 forms hollow interior 64 between the upper surface of bottom wall 46, and the inward facing surfaces of end walls 48 and sidewalls 50. In one arrangement, hollow interior 64 is generally empty thereby allowing for the unrestricted storage of parts and components. In another arrangement, hollow interior 64 includes divider 152 which partitions hollow interior 64 into various compartments for the restricted storage of parts and components.

In the arrangement shown, as one example, the upper end of the forward positioned sidewall 50 includes a hinge 154 that is configured to facilitate the attachment of cover member 52 to base member 44 as well as facilitate the rotational opening and closing of cover member 52 upon base member 44.

In the arrangement shown, as one example, the upper end of the rearward positioned sidewall 50 of base member 44 includes a lip 156 that is configured to engage lip 158 of cover member 52 thereby holding cover member 52 closed upon base member 44 while allowing cover member 52 to selectively open upon user operation.

Cover Member 52:

In the arrangement shown, as one example, side supports 40 include a cover member 52. Cover member 52 may be formed of any suitable size, shape and design and is configured form the upper side of side support 40 and is configured to connect to base member 44 in a manner that allows side support 40 to selectively open and close to facilitate storage and retrieval of parts and components from hollow interior 64.

In the arrangement shown, as one example, cover member 52 is formed of a generally square or rectangular shaped member when viewed from above or below, as well as when viewed from the forward side or rearward side, as well as when viewed from either end. In the arrangement shown, as one example, cover member 52 includes a top wall 54, end walls 56 and sidewalls 58, among other features.

In the arrangement shown, as one example, top wall 54 is formed of a generally flat and planar member and serves to enclose the upper end of cover member 52. In the arrangement shown, as one example, the upper surface of cover member 52 is generally flat and planar and therefor provides stable support surface for workpiece 26 to rest upon.

In the arrangement shown, as one example, top wall 54 connects at its outward ends to end walls 56 which extend downward therefrom a distance before terminating in a lower end at peripheral edge 160. In the arrangement shown, as one example, top wall 54 connects at its forward and rearward ends to sidewalls 58 which extend downward therefrom a distance before terminating in a lower end at peripheral edge 160.

In the arrangement shown, as one example, the lower end of end walls 56 and sidewalls 58 terminate in a peripheral edge 160 that forms the lower edge of cover member 52 opposite top wall 54. In the arrangement shown, as one example, peripheral edge 160 is configured to fit around peripheral edge 150 of base member when cover member 52 is in a closed position.

In the arrangement shown, as one example, the lower end of the forward positioned sidewall 58 includes a hinge 154 that is configured to facilitate the attachment of cover member 52 to base member 44 as well as facilitate the rotational opening and closing of cover member 52 upon base member 44.

In the arrangement shown, as one example, the lower end of the rearward positioned sidewall 58 of cover member 52 includes a lip 158 that is configured to engage lip 156 of base member 44 thereby holding cover member 52 closed upon base member 44 while allowing cover member 52 to selectively open upon user operation.

Guide Member 60:

In the arrangement shown, as one example, cover member 52 includes a guide member 60. Guide member 60 may be formed of any suitable size, shape and design and is configured facilitate a connection point for stop member 68 while also allowing for infinite adjustment of stop member 68 in a quick, easy and secure manner.

In the arrangement shown, as one example, guide member 60 is connected to upper surface of top wall 54 of cover member 52. In the arrangement shown, as one example, when viewed from an end wall 56, guide member 60 is a generally square or rectangular shaped member that extends upward from the upper surface of top wall 54, however any other size, shape or configuration is hereby contemplated for use such as a T-shaped protrusion, T-shaped slot, any other shaped protrusion or any other shaped slot or any combination thereof.

In the arrangement shown, as one example, guide member 60 extends in approximate parallel spaced relation to sidewalls 58 of cover member 52 and sidewalls 50 of base member 44. In the arrangement shown, as one example, guide member extends in approximate perpendicular alignment to end walls 56 of cover member 52 and end walls 48 of base member 44. However, any other configuration is hereby contemplated for use.

Indicia 62:

In the arrangement shown, as one example, cover member 52 includes indicia 62. Indicia 62 may be formed of any suitable size, shape and design and are configured to provide an indication of distance for stop member 68 so as to facilitate the setting of the position of stop members 68 in a quick, easy and accurate manner.

In the arrangement shown, as one example, indicia 62 are formed of a plurality of marks or hash marks or spaced lines, which may or may not include numbers or other indicia that relates thereto. In the arrangement shown, as one example, indicia 62 are positioned adjacent the forward side of guide member 60 in the upper surface of top wall 54 of cover member 52.

In this arrangement, when stop member 68 is installed on cover member 52, indicia 62 is present adjacent stop member 68 thereby providing a repeatable and accurate indication of the position of stop member 68 thereby speeding and easing and increasing the accuracy of setting the position of stop member 68. This is especially true when attempting to position a stop member 68 on each side of docking station system 10 at equal offsets to the center of docking station system 10.

Lock Member 66:

In the arrangement shown, as one example, side supports 40 include a lock member 66. Lock member 66 may be formed of any suitable size, shape and design and is configured to selectively lock side support 40 in a retracted position in a quick, easy and secure manner.

In the arrangement shown, as one example, lock member 66 is connected to the forward positioned sidewall 50 of base member 44 of side support 40, however any other placement is hereby contemplated for use. In the arrangement shown, as one example, lock member 66 includes a knob 162 having a hook member 164 and an axis of rotation, however any other configuration is hereby contemplated for use.

In the arrangement shown, as one example, knob 162 of lock member 66 is positioned on the forward side of sidewall 50 of base member 44 between hinges 154. In the arrangement shown, as one example, hook member 164 extends outward from the peripheral edge of knob 162 before terminating in a free end. In this way, as knob 162 rotates, so rotates hook member 164.

In the arrangement shown, as one example, knob 162 includes a rearward extending protrusion that connects to and/or extends through sidewall 50 of base member 44 thereby forming axis of rotation 166. That is, knob 162 and hook member 164 rotate upon base member 44 around axis of rotation 166.

In the arrangement shown, as one example, lock member 66 is configured to selectively lock side support 40 in a retracted position. In the arrangement shown, as one example, side support 40 is raised to a retracted position, wherein side support 40 is approximately vertical. In this position, knob 162 of lock member 66 is rotated. As knob 162 is rotated, the free end of hook member 164 is configured to engage lock member 38 of upright section 30 of docking station system 10 or upright assembly 80 of pocket hole jig system 24. In the arrangement shown, as one example, lock member 38 of upright section 30 of docking station system 10 or upright assembly 80 of pocket hole jig system 24 is formed of an opening that is configured to receive hook member 164 of lock member 66 of side support 40, however any other configuration is hereby contemplated for use.

Once hook member 164 is received within or engaged with lock member 38 of upright section 30 of docking station system 10 or upright assembly 80 of pocket hole jig system 24 the side support 40 is locked in a retraced position for storage or transport. To lower side support 40 to an extended position, knob 162 is rotated in an opposite direction thereby disengaging hook member 164 from lock member 38 of upright section 30 of docking station system 10 or upright assembly 80 of pocket hole jig system 24 thereby allowing side support 40 to be lowered to an extended position for use.

Any other configuration is hereby contemplated for use as lock member 66. As one example, lock member 66 and lock member 38 may swap positions. Alternatively, lock member 66 and lock member 38 may take on different configurations such as an elastic member, a loop and hook, a button and snap, a friction fit member, a threaded member, a spring loaded pin member, or any other mechanical arrangement that connects two components together or any combination thereof

Stop Member 68:

In the arrangement shown, as one example, docking station system 10 includes a stop member. Stop member 68 may be formed of any suitable size, shape and design and is configured to form a positive stop for workpiece 26 to engage thereby setting the position for drilling a pocket hole in multiple similar sized workpieces 26 in a fast, accurate and repeatable manner.

In the arrangement shown, as one example, stop member 68 includes a main body 70, an extension member 72 and a locking member 74, among components and features.

Main Body 70: In the arrangement shown, as one example, main body 70 extends a length between a forward end 168 and a rearward end 170 and extends a width between opposing sides 172 and extends a height between lower end 174 and upper end 176. In the arrangement shown, as one example, forward end 168 is formed of a generally flat and straight plane whereas rearward end 170 is rounded. In the arrangement shown, as one example, sides 172 are formed of a generally flat and straight plane that extend in approximate parallel spaced relation to one another. In the arrangement shown, as one example, sides 172 are formed of a generally flat and straight plane that extend in approximate perpendicular alignment to the plane formed by forward end 168.

In the arrangement shown, as one example, lower end 174 and upper end 176 are formed of a generally flat and straight plane that extend in approximate parallel spaced relation to one another. In the arrangement shown, as one example, lower end 174 and upper end 176 are formed of a generally flat and straight plane that extend in approximate perpendicular alignment to the plane formed by forward end 168. In the arrangement shown, as one example, lower end 174 and upper end 176 are formed of a generally flat and straight plane that extend in approximate perpendicular alignment to the planes formed by sides 172.

In the arrangement shown, as one example, forward end 168 of main body 70 includes a connection member 178 that is configured to engage a connection member 180 of extension member 72 of corresponding size, shape and configuration thereby selectively connecting main body 70 and extension member 72 in a removable but secure manner. In the arrangement shown, as one example, connection member 178 in forward end 168 of main body 70 is formed of a generally square or rectangular shaped protrusion with a locking feature or locking features therein. In the arrangement shown, as one example, connection member 180 in of extension member 72 is formed of a generally square or rectangular shaped recess with a locking feature or locking features therein. In this arrangement, extension member 72 is connected to main body 70 by placing the connection member 180 of extension member 72, that is a recess, over the connection member 178 of main body 70, that is a protrusion, and sliding the extension member 72 downward until the bottom plane of the extension member 72 and main body 70 are in approximate planar alignment with one another.

Once extension member 72 is installed upon main body 70, extension member 72 and main body 70 are frictionally held together by frictional engagement between the connection member 178 of main body 70 and the connection member 180 of extension member 72. To remove or adjust the position of extension member 72 relative to main body 70, extension member 72 is simply slid upward relative to main body 70 thereby separating frictional engagement between the connection member 178 of main body 70 and the connection member 180 of extension member 72. Once extension member 72 is removed from main body 70, extension member 72 may be reattached to main body 70 by using a different connection member 180, thereby changing the position of extension member 72 relative to main body 70. Alternatively, main body 70 may be used without extension member 72.

In the arrangement shown, as one example, lower end 174 of main body 70 includes a receiver 182 that is formed of any suitable size, shape and design and is configured to receive and engage guide member 60 of cover member 52 of side support 40. Receiver 182 is formed of a corresponding size, shape and configuration as guide member 60 of cover member 52 of side support 40.

In the arrangement shown, where guide member 60 is a relatively square or rectangular rail or protrusion that extends across cover member 52 of side support 40, receiver 182 is a similarly shaped square or rectangular shaped recess or groove in the lower end 174 of main body 70. In this example arrangement, the recess or groove in the lower end 174 of main body 70 that forms receiver 182 is configured to fit over guide member 60 with close and tight tolerances, while also allowing for sliding movement of main body 70 along the length of guide member 60.

In the arrangement shown, as one example, receiver 182 extends in approximate perpendicular alignment to the planes formed by side 172 of main body 70. In this way, when main body 70 is attached to guide member 60, main body 70 extends in a relatively perpendicular manner to guide member 60. More specifically, the length of main body 70 between receiver 182 and forward end 168, extends forward from guide member 60 a length in a generally perpendicular manner.

In the arrangement shown, as one example, locking member 74 is connected to main body 70.

Extension Member 72: In the arrangement shown, as one example, extension member 72 extends a length between a first end 184 and a second end 186 and extends a width between opposing sides 188 and extends a height between lower end 190 and upper end 192. In the arrangement shown, as one example, first end 184 includes a generally flat and straight plane positioned at its center that trails off or angles off or curves off from this front plane toward sides 188 at its outward edges. In the arrangement shown, as one example, second end 186 is formed of a generally flat and straight plane. In the arrangement shown, as one example, sides 188 are formed of a generally flat and straight plane that extend in approximate parallel spaced relation to one another. In the arrangement shown, as one example, sides 188 are formed of a generally flat and straight plane that extend in approximate perpendicular alignment to the plane formed by first end 184 as well as second end 186.

In the arrangement shown, as one example, lower end 190 is formed of a generally flat and straight plane. In the arrangement shown, as one example, upper end 192 includes a generally flat and straight plane positioned at its center that trails off or angles off or curves off from this upper plane toward sides 188 at its outward edges. In the arrangement shown, as one example, the planes formed by lower end 190 and upper end 192 extend in approximate parallel spaced relation to one another. In the arrangement shown, as one example, lower end 190 and upper end 192 are formed of a generally flat and straight plane that extend in approximate perpendicular alignment to the plane formed by first end 184 and second end 186. In the arrangement shown, as one example, lower end 190 and upper end 192 are formed of a generally flat and straight plane that extend in approximate perpendicular alignment to the planes formed by sides 188.

In the arrangement shown, as one example, extension member 72 is configured to be reversible. That is, both first end 184 and second end 186 include connection members 180 therein. In this way, extension member 72 can be connected to main body 70 with the first end 184 or second end 186 facing forward, depending on which connection member 180 is used to attach to main body 70.

In the arrangement shown, as one example, a connection member 180 is placed in first end 184 of extension member 72. This connection member 180 is generally centrally positioned between opposing sides 188. As such, when extension member 72 is connected to main body 70 using this connection member 180, second end 186 faces forward and sides 188 extend equally past each side 172 of main body 70.

In the arrangement shown, as one example, two connection members 180 are placed in second end 186 of extension member 72. These connection members 180 are positioned between the side 188 to side 188 center of extension member 72 and outward sides 188 of extension member 72. As such, when extension member 72 is connected to main body 70 using one of these connection members 180, first end 184 faces forward and one of the sides 188 extend a side 172 of main body 70 a distance. In this way, in this configuration, extension member 72 may reach over and past main body 70 a distance and over a portion of a base 78 of pocket hole jig system 24. This arrangement may be particular useful for narrower workpieces 26. The arrangement wherein a connection member 180 is placed adjacent each side 188 of extension member 72 in second end 186 allows extension member 72 to extend past either side 172 of main body 70. This allows the same stop member 68 to be used on a side support 40 positioned on either side of docket station system 10 and/or pocket hole jig system 24.

Locking Member 74: In the arrangement shown, as one example, stop member 68 includes a locking member 74. Locking member 74 is formed of any suitable size, shape and design and is configured to facilitate selective locking and unlocking of stop member 68 relative to side support 40 and/or guide member 60.

In the arrangement shown, as one example, locking member 74 includes a knob 194, fastener 196 and shoe 198. Knob 194 is formed of any suitable size, shape and design and is configured to be easily used by a user to tighten or loosen, engage or disengage, lock or unlock, locking member 74. In the arrangement shown, as one example, knob 194 is a generally cylindrical shaped head that extends upward from the upper end 176 of main body 70 a distance and facilitates easy user engagement. In the arrangement shown, as one example, knob 194 connects to fastener 196 and as knob 194 rotates so rotates fastener 196.

Fastener 196 is formed of any suitable size, shape and design and is configured to connect to knob 194 and shoe 198 and transmit rotational motion of knob 194 to shoe 198. In the arrangement shown, as one example, fastener 196 is formed of a shaft having at least a portion of when includes threads thereon. In one or more arrangements, fastener 196 also includes a head that connects to knob 194. As knob 194 rotates so rotates fastener 196. This rotation of fastener 196 transfers rotational motion to shoe 198.

Shoe 198 is formed of any suitable size, shape and design and is configured to connect to shoe 198 and transmit rotational motion of knob 194 and shoe 198 to a locking motion. In the arrangement shown, as one example, shoe 198, when viewed from below, is formed of a generally square or rectangular or other non-round shape that is received within a similarly sized and shaped opening in the lower end 174 of main body 70. The corresponding size of shoe 198 and the opening that shoe 198 is held within prevents the rotation of shoe 198 when fastener 196 rotates. This close and matching engagement between the opening in the lower end 174 of main body 70 and shoe 198 prevents shoe 198 from rotating. However, shoe 198 may move vertically within this opening in the lower end 174 of main body 70 as fastener 196 rotates.

In the arrangement shown, as one example, shoe 198 receives the lower end of fastener 196 in threaded engagement in a generally centrally positioned hole. As such, as the fastener 196 rotates, shoe 198 moves up or down due to the threaded engagement of shoe 198 and fastener 196.

In the arrangement shown, shoe 198 is positioned within main body 79 adjacent receiver 182. In the arrangement shown, as one example, a bias member 200 is positioned between shoe 198 and receiver 182. In the arrangement shown, the side of shoe 198 that faces and engages bias member 200 has an angled surface that widens as it extends downward. Or, said another way, the side of shoe 198 that faces and engages bias member 200 is narrower at its upper end and is wider at its lower end. In one arrangement, bias member 200 includes a similar but opposite angled or curved or shaped surface that engages shoe 198. In one arrangement, bias member 200 connects to main body 70 at a hinge positioned at the upper end of bias member 200, which allows for the lower end of bias member to move inward and outward.

As such, as shoe 198 moves upward within main body 70 due to the rotation of knob 194 and shaft 196, the engagement between shoe 198 and bias member 200 causes the lower end of bias member 200 to move outward. This outward movement of the lower end of bias member 200 causes bias member 200 to engage and tighten against guide member 60 of cover member 52 of side support 40, thereby locking stop member 68 in place.

That is, to tighten stop member 68 in place, the user rotates knob 194 in a tightening direction that causes shoe 198 to move up which causes bias member 200 to move outward and engage and lock onto guide member 60 of cover member 52 of side support 40, thereby locking stop member 68 in place. To adjust the position of stop member 68 relative to guide member 60 of cover member 52 of side support 40, the user rotates knob 194 in a loosening direction which causes shoe 198 to move down that causes bias member 200 to move inward and disengage and unlock from guide member 60 of cover member 52 of side support 40, thereby allowing stop member 68 to be slid along guide member 60 of cover member 52 of side support 40 to a different position or removed altogether.

Pocket Hole Jig System 24:

In the arrangement shown, as one example, docking station system 10 is configured to be used with a pocket hole jig system 24, or any other jig or tool for that matter. Pocket hole jig system 24 may be formed of any suitable size, shape and design and is configured to facilitate the formation of pocket holes in workpiece in a fast, easy, accurate and repeatable manner.

In the arrangement shown, as one example, pocket hole jig system 24 includes a base 78, an upright assembly 80, a drill guide assembly 82, a clamp assembly 84, and a connection member 86, among other parts, components, systems and feature as are described herein. Docking station system 10 is configured to receive and hold and add functionality to any form of a pocket hole jig system 24 or any other jig or tool.

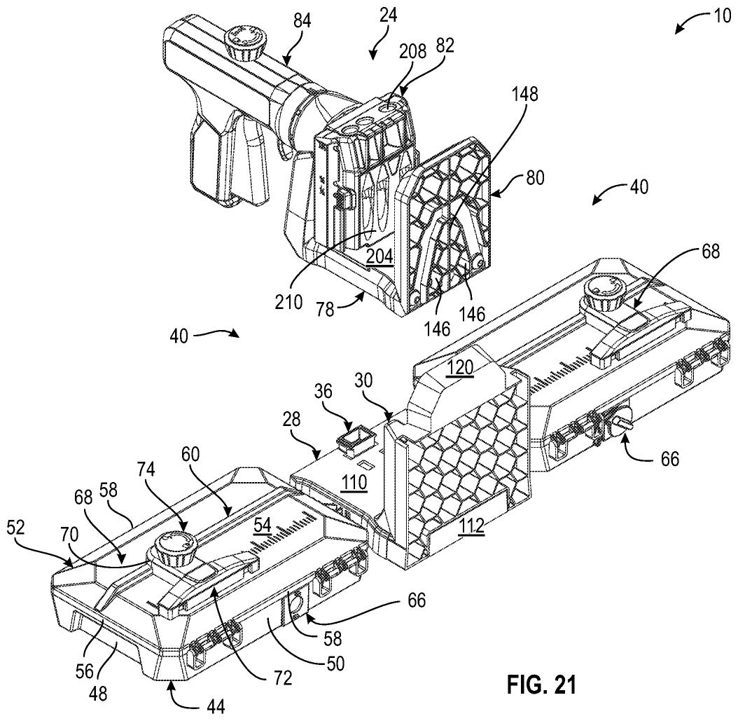

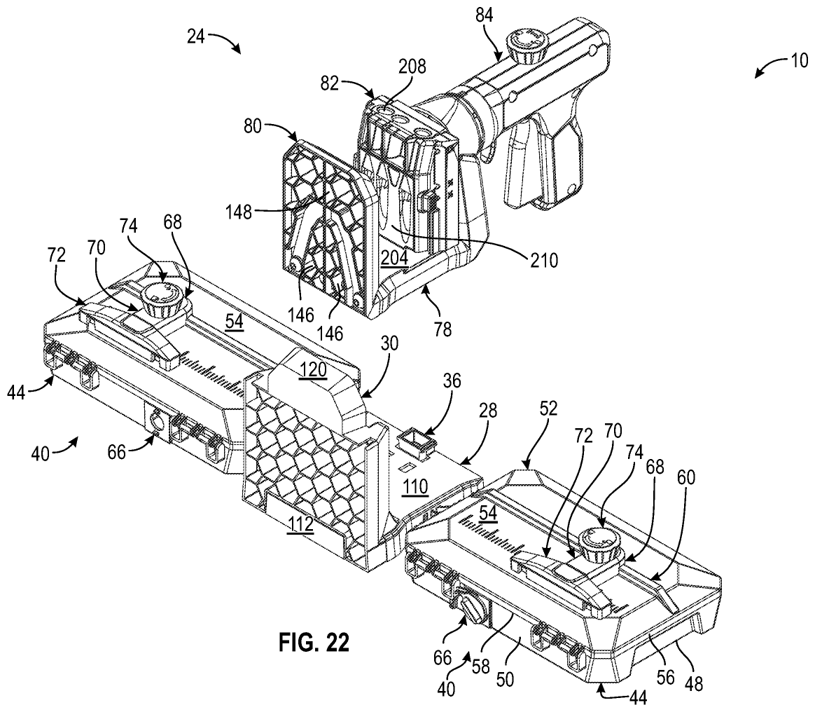

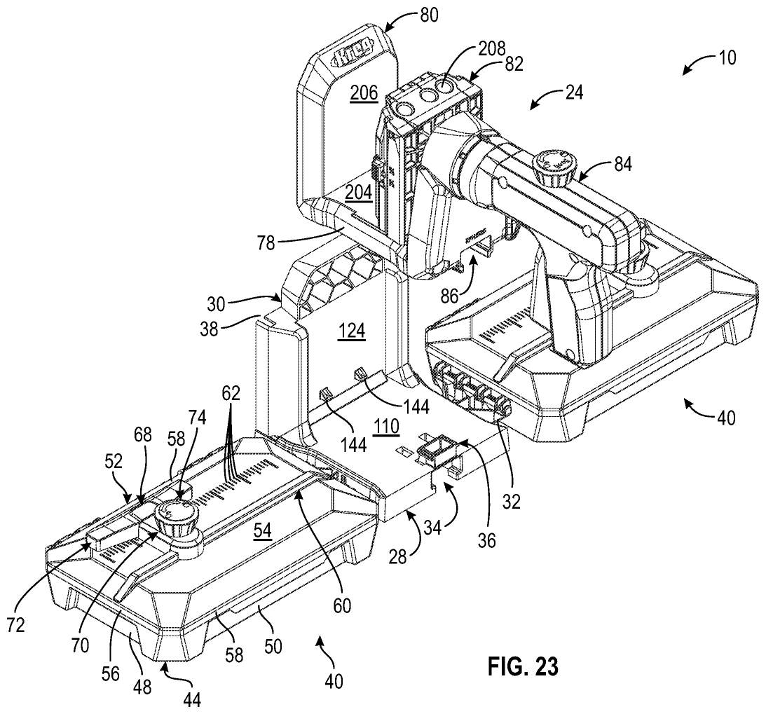

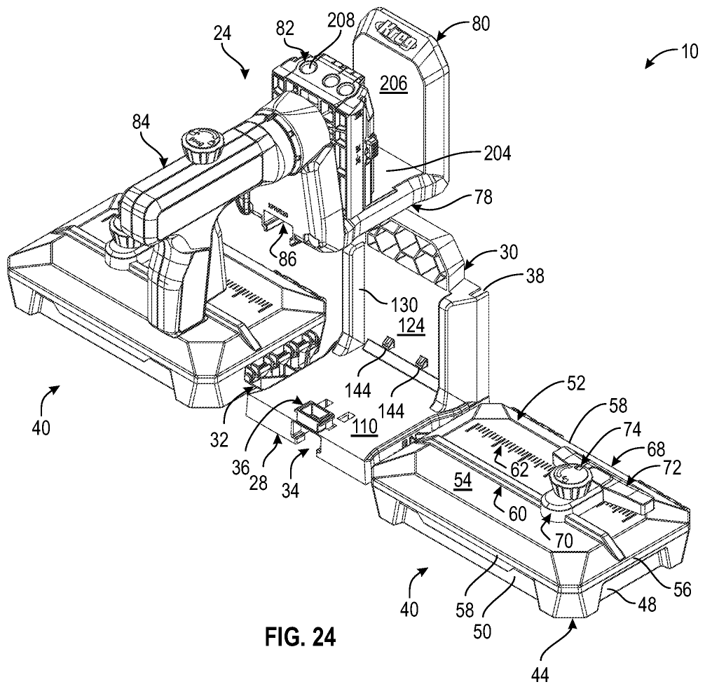

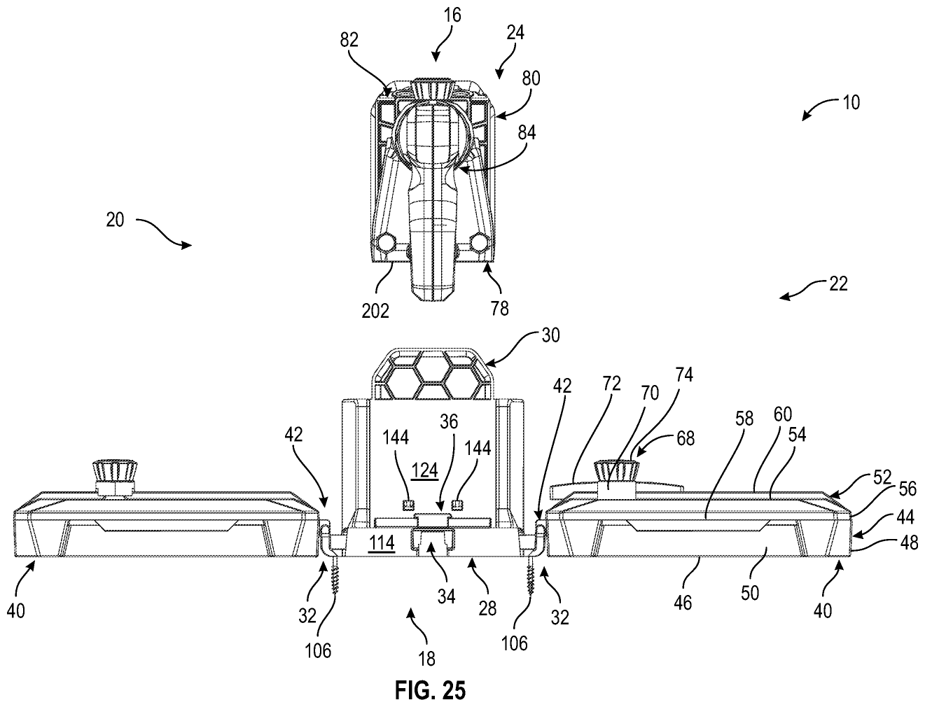

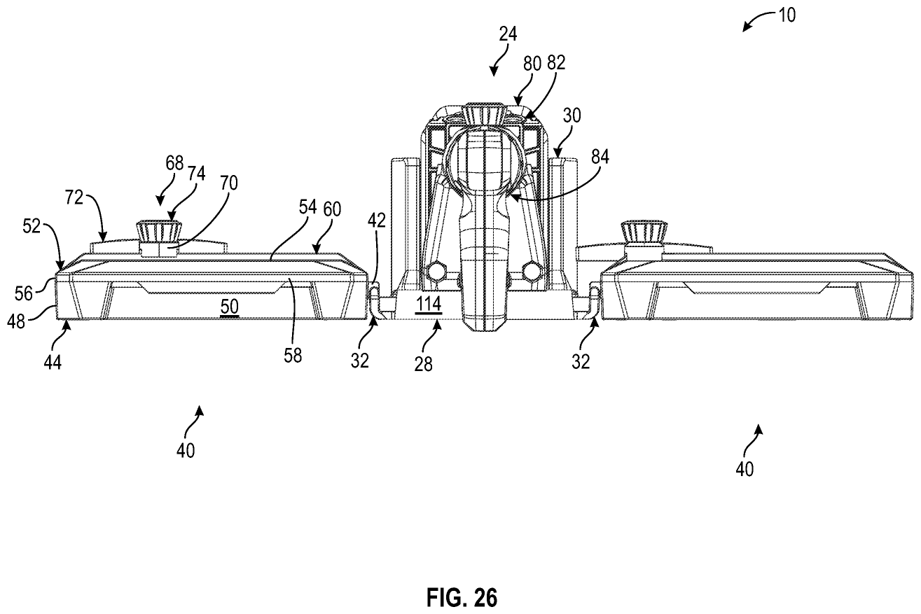

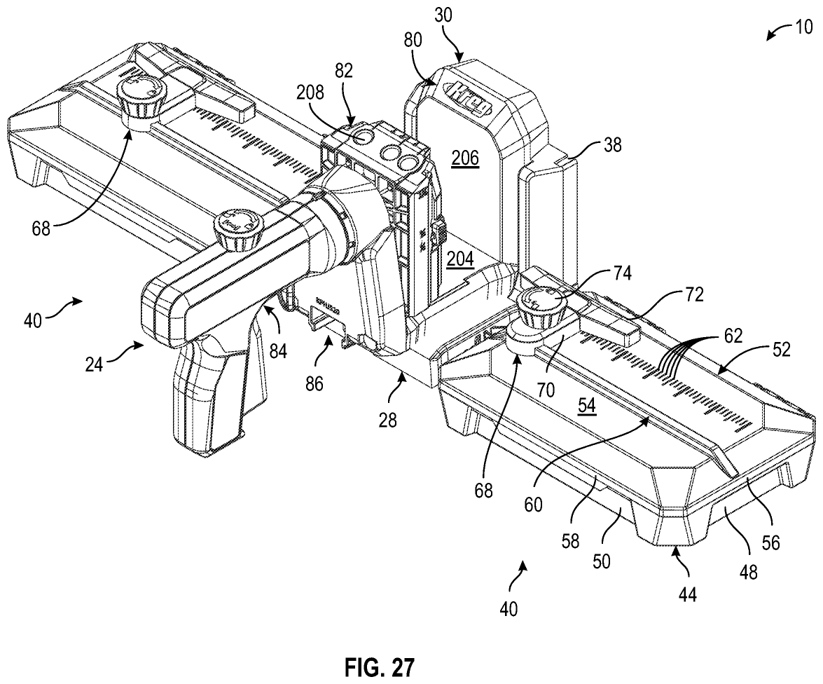

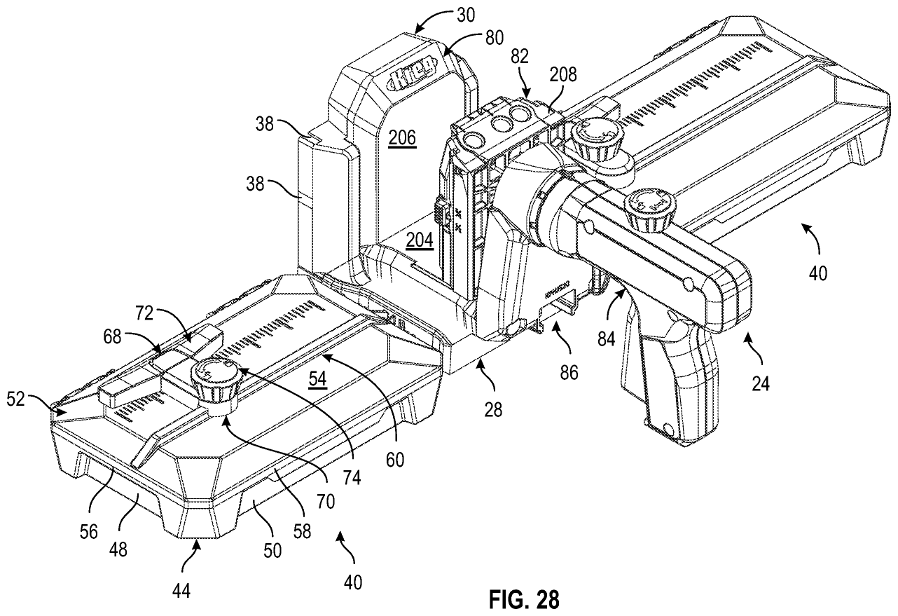

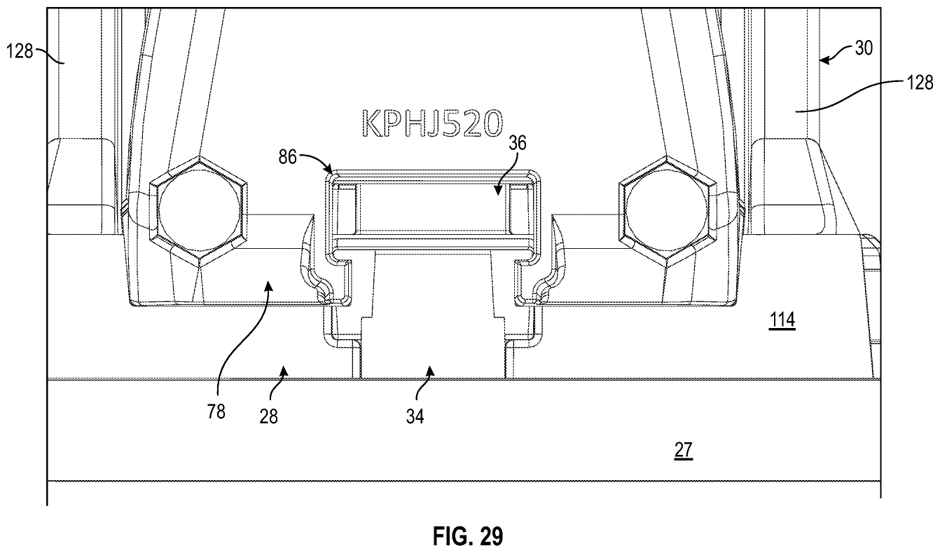

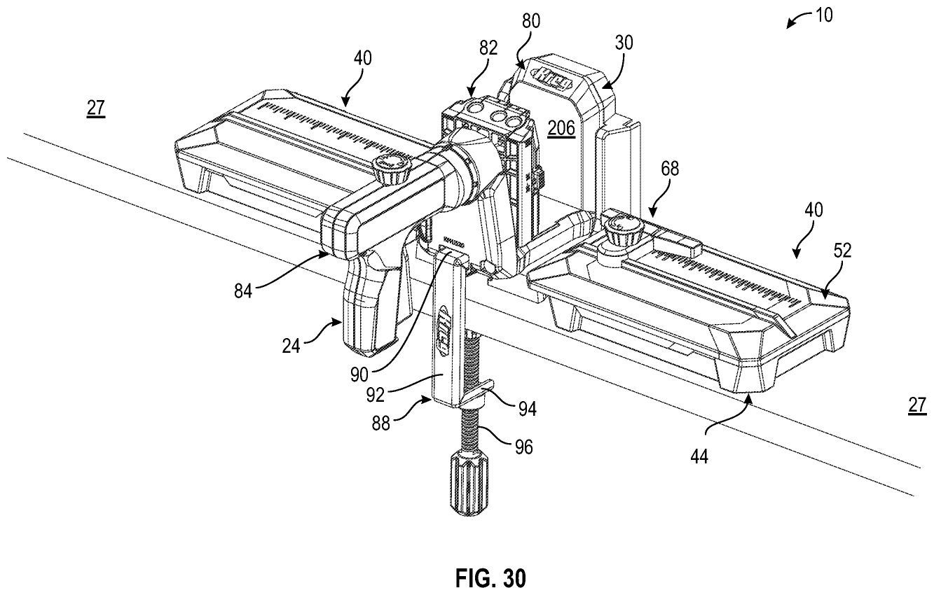

With reference to FIGS. 21-30, as one example, docking station system 10 is shown in use with one form of a pocket hole jig system 24. In these figures, a quick grip pocket hole jig system is shown, which is the subject of Applicant's own U.S. Provisional Patent Application No. 62/797,492 filed on Jan. 28, 2019, which is hereby fully incorporated by reference herein by reference.

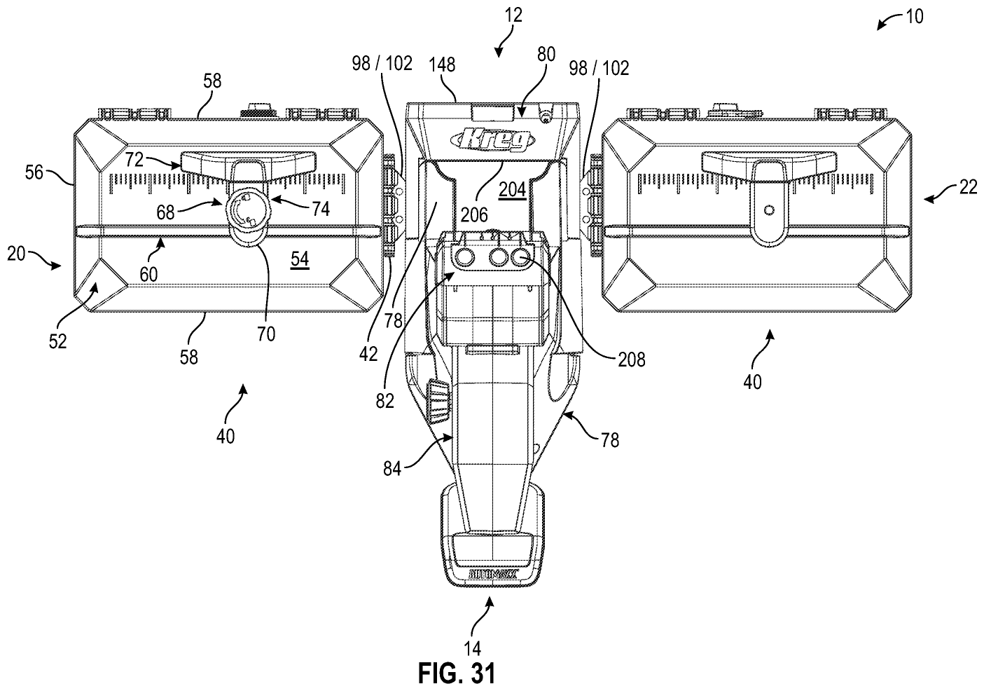

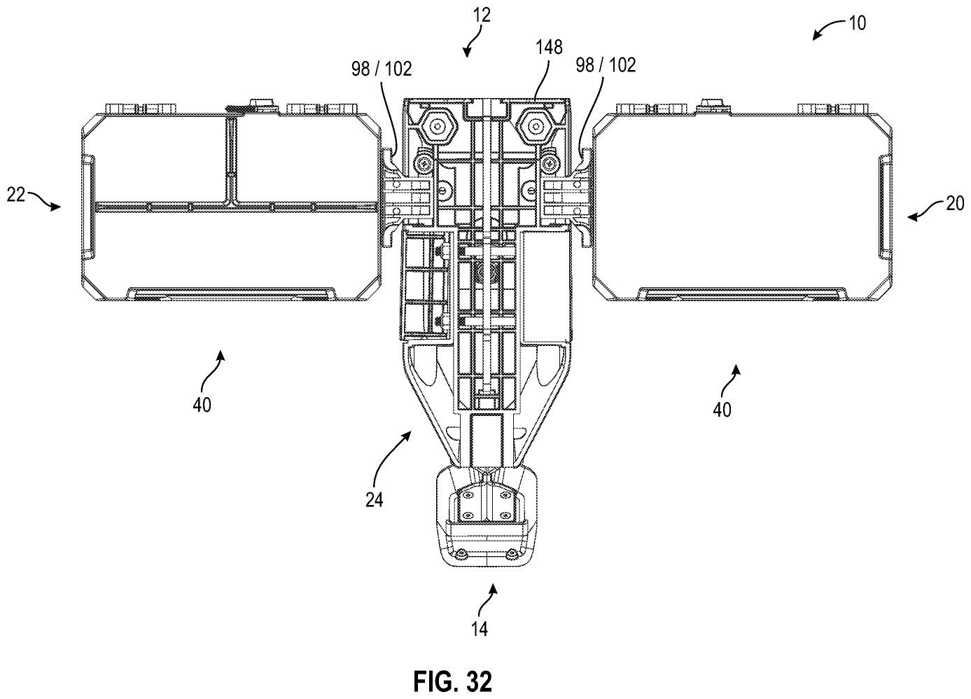

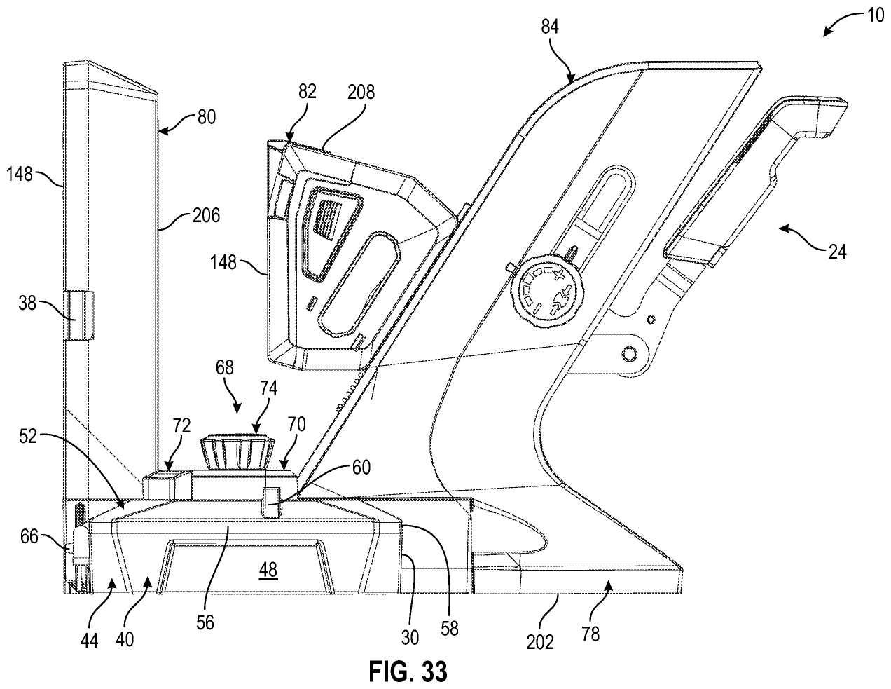

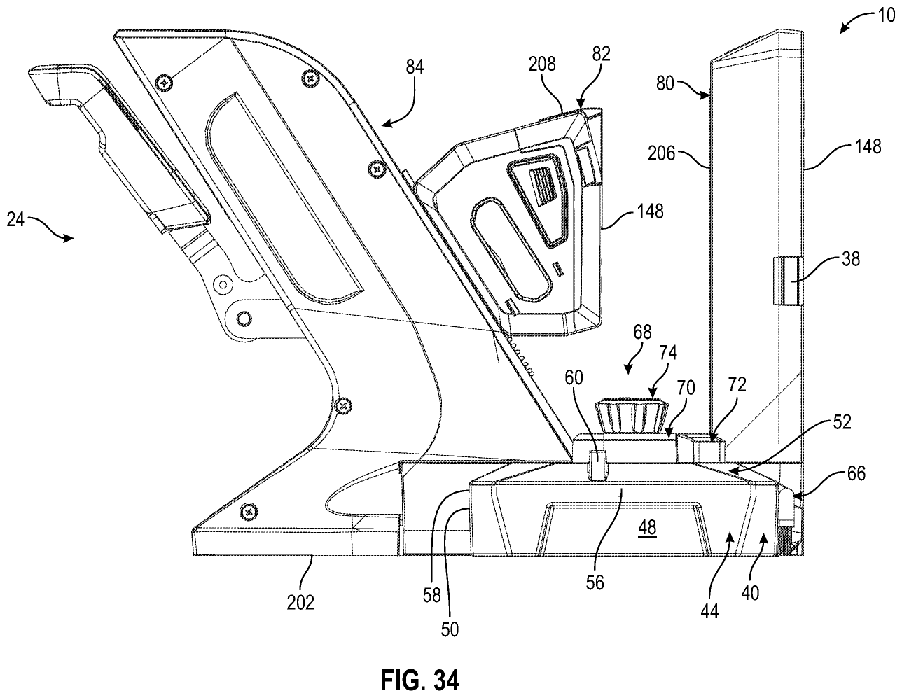

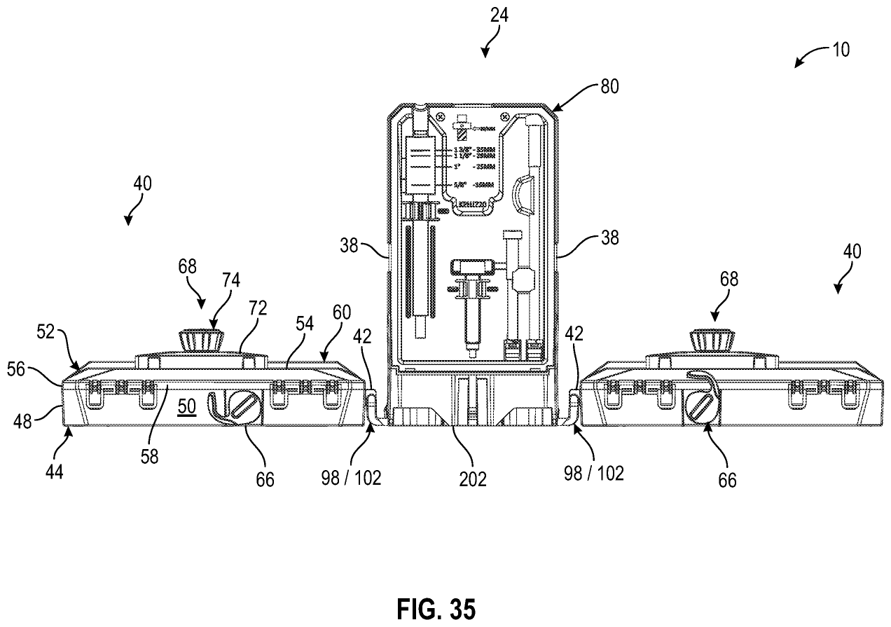

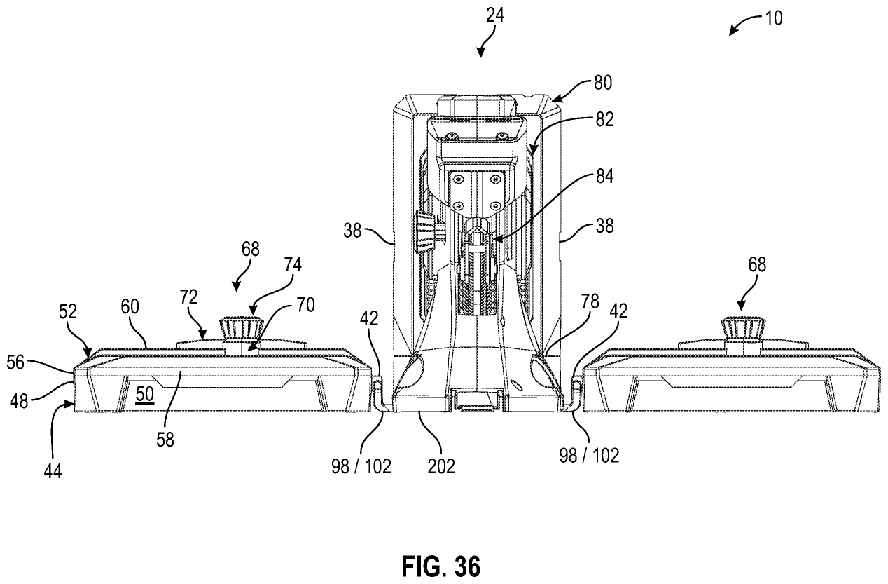

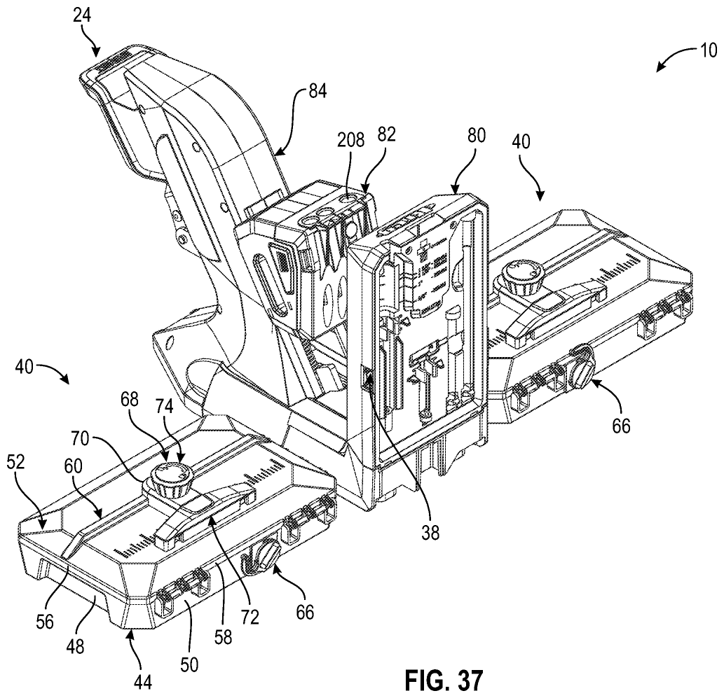

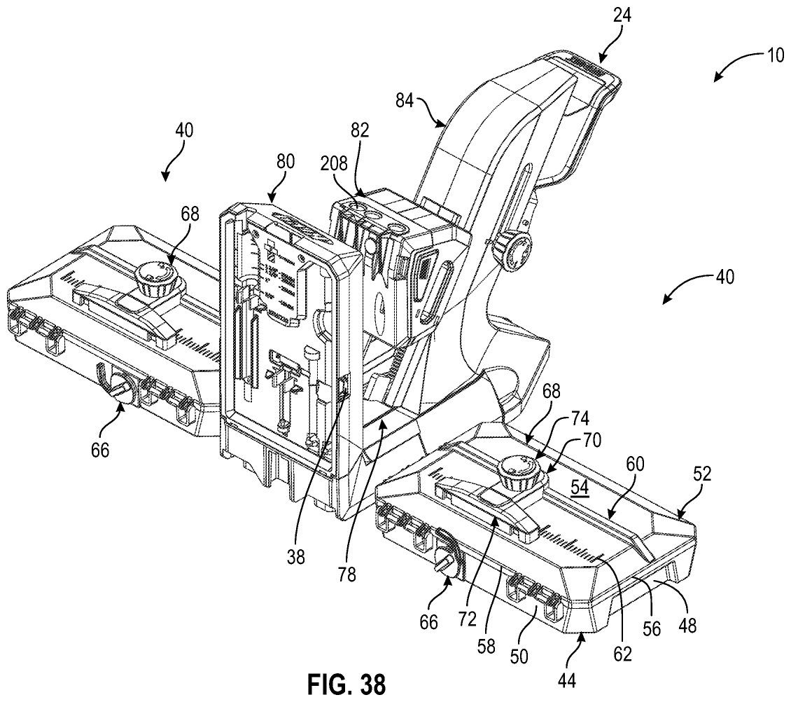

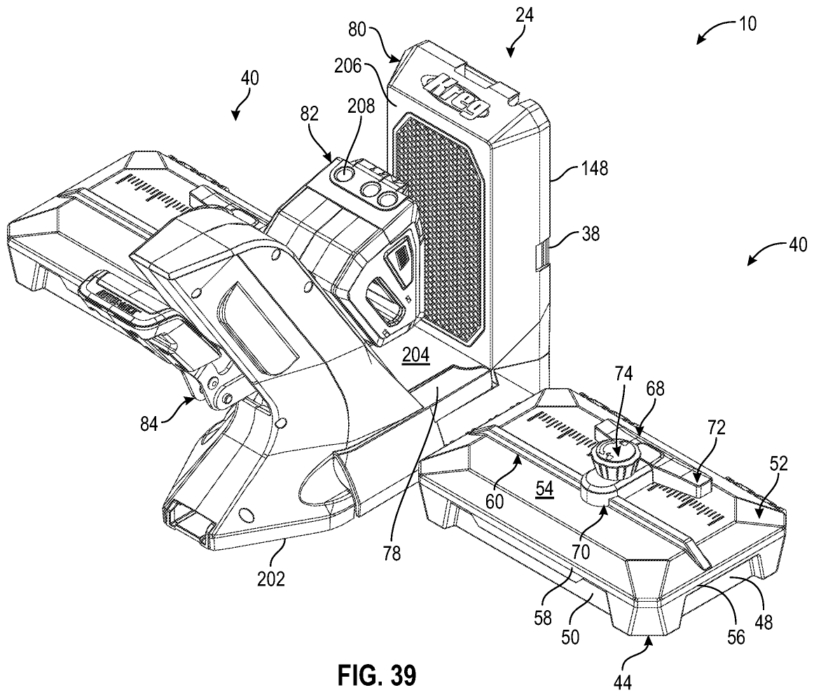

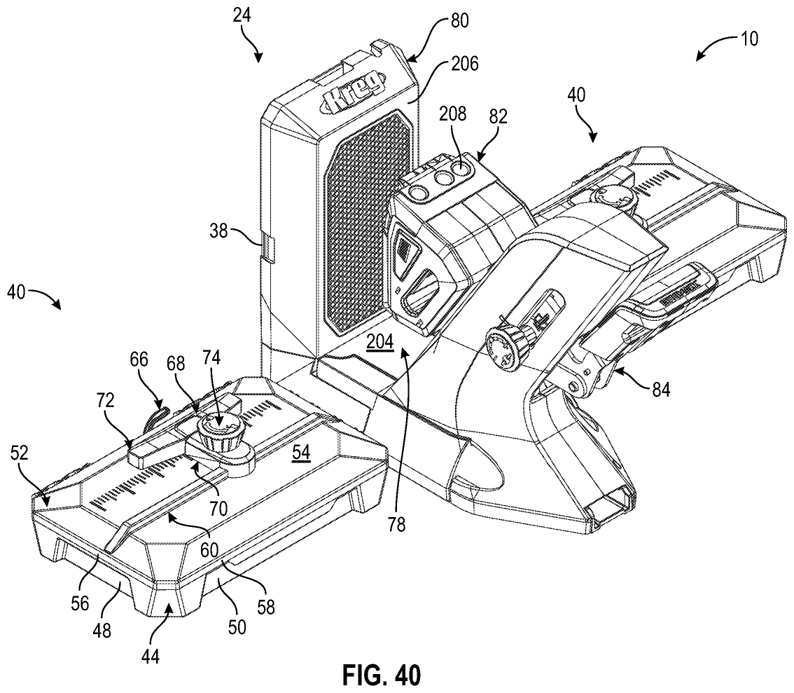

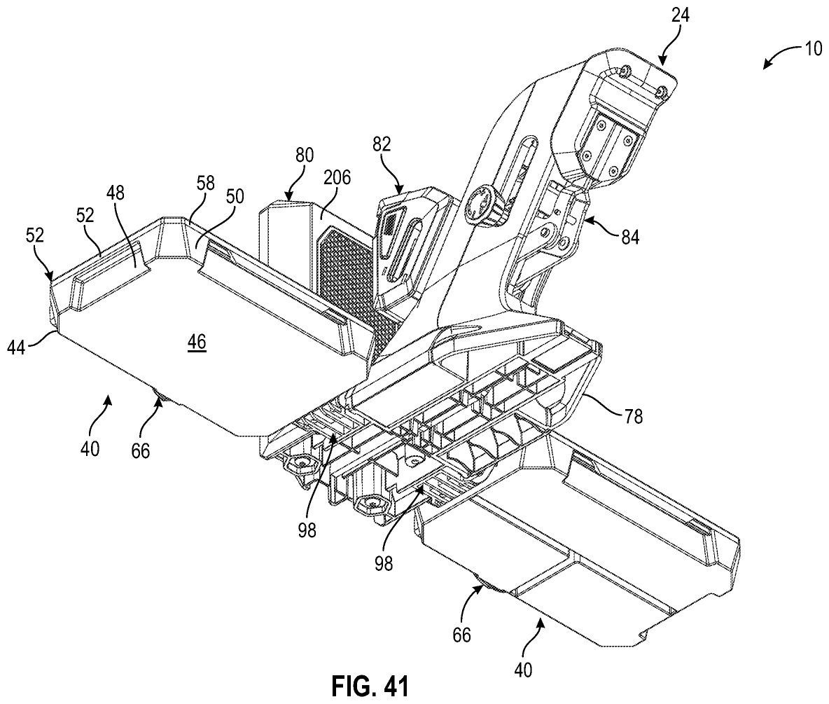

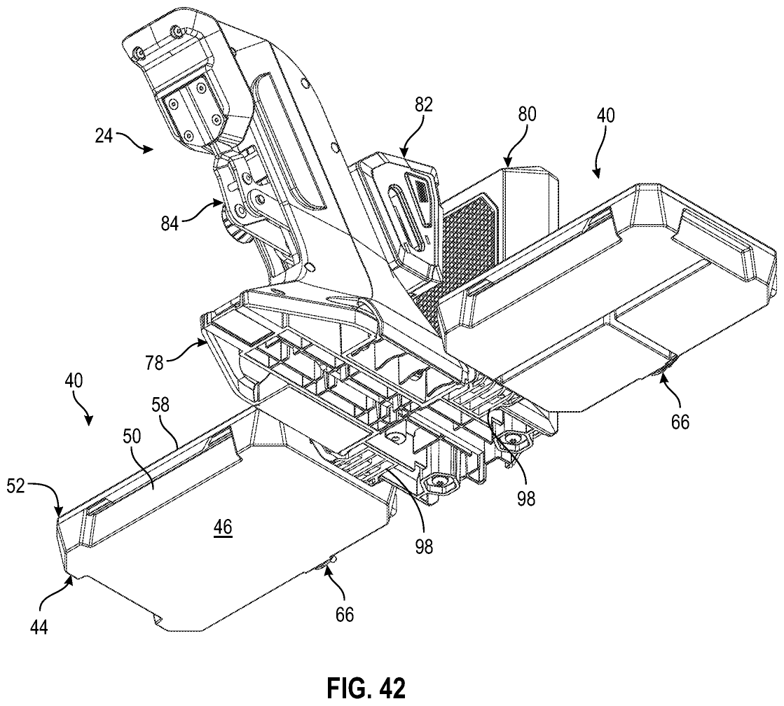

With reference to FIGS. 31-42, as another example, docking station system 10 having adapter brackets 98 is shown in use with another form of a pocket hole jig system 24. In these figures, a self-adjusting pocket hole jig system is shown which is the subject of Applicant's own U.S. Provisional Patent Application No. 62/804,847 filed on Feb. 13, 2019, which is fully incorporated by reference herein by reference. However, any other form of a pocket hole jig system 24 is hereby contemplated for use.

Base 78: In the arrangement shown, as one example, pocket hole jig system 24 includes a base 78. Base 78 is formed of any suitable size, shape and design and is configured to connect to upright assembly 80 and/or drill guide assembly 82 and/or clamp assembly 84 and provide a structural component of pocket hole jig system 24. In the arrangement shown, as one example, base 78 has a generally flat lower surface 202 and an opposing generally flat upper surface 204 that extend in approximate parallel spaced relation to one another.

In the arrangement shown, as one example, the lower surface 202 of base 78 is configured to be placed upon and engage the upper face 110 of base section 28 in a generally flat and flush manner. In this way, when base 78 of pocket hole jig system 24 is placed upon the upper face 110 of base section 28, due to the flat and flush engagement between these two components a stable and secure connection is made. In the arrangement shown, as one example, the forward end of base 78 connects to the lower end of upright assembly 80 and the rearward end of base 78 connects to clamp assembly 84.

Upright Assembly 80: In the arrangement shown, as one example, pocket hole jig system 24 includes an upright assembly 80. Upright assembly 80 is formed of any suitable size, shape and design and is configured to connect to base 78 and provide a back stop for workpiece 26 on a side opposite drill guide assembly 82 and/or clamp assembly 84. In the arrangement shown, as one example, upright assembly 80 has a generally flat forward surface 148 and an opposing generally flat rearward surface 206 that extend in approximate parallel spaced relation to one another.

In the arrangement shown, as one example, the forward surface 148 of upright assembly 80 is configured to be placed against and engage the rearward face 124 of upright section 30 in a generally flat and flush manner. In this way, when upright assembly 80 of pocket hole jig system 24 is placed against the rearward face 124 of upright section 30, due to the flat and flush engagement between these two components, upright section 30 of docking station system 10 provides additional support and strength to upright assembly 80 thereby preventing deformation during clamping. In the arrangement shown, as one example, the lower end of upright assembly 80 connects to the forward end of base 78.

In the arrangement shown, as one example, the generally flat rearward surface 206 is configured to engage and support the forward facing surface of workpiece 26 when clamped.

Drill Guide Assembly 82: In the arrangement shown, as one example, pocket hole jig system 24 includes a drill guide assembly 82. Drill guide assembly 82 is formed of any suitable size, shape and design and is configured to connect to pocket hole jig system 24 and facilitates the guidance and alignment of a drill bit at an angle through workpiece 26 so as to form a pocket hole in workpiece 26. In the arrangement shown, as one example, drill guide assembly 82 includes a plurality of drill guides 208 therein. In the arrangement shown, as one example, three drill guides 208 are shown in use, however any other number are hereby contemplated for use.

In the arrangement shown, as one example, drill guide assembly 82 connects to clamping assembly 84 and moves as clamping assembly 84 clamps and unclamps. However, in another arrangement, it is hereby contemplated that drill guide assembly 82 remains stationary as clamping assembly 84 clamps and unclamps.

In the arrangement shown, as one example, drill guide assembly 82 includes a forward surface 210 that is generally flat and straight. In the arrangement shown, as one example, forward surface 210 extends in a generally parallel spaced alignment to the rearward surface 206 of upright assembly 80. In this way, in the arrangement shown, as one example, when clamping assembly 84 clamps, drill guide assembly 82 moves toward upright assembly 80 thereby clamping workpiece 26 between upright assembly 80 and drill guide assembly 82. When clamped, the forward facing surface of workpiece 26 is in flat and flush engagement with the rearward surface 206 of upright assembly 80, the lower surface of workpiece 26 is in flat and flush engagement with the upper surface 204 of base 78, and the rearward facing surface of workpiece 26 is in flat and flush engagement with the forward surface 210 of drill guide assembly 82. In this way, workpiece 26 is securely clamped in place within pocket hole jig system 24 within docking station system 10.

In the arrangement shown, as one example, rearward side of drill guide assembly 82 connects to clamp assembly 84, which moves drill guide assembly between a clamped position and an unclamped position.

Clamping Assembly 84: In the arrangement shown, as one example, pocket hole jig system 24 includes a clamping assembly 84. Clamping assembly 84 is formed of any suitable size, shape and design and is configured to facilitate clamping of workpiece 26. In the arrangement shown, as one example, clamping assembly 84 is connected to base 78 as well as drill guide assembly 82 and includes a clamping mechanism. In the arrangement shown, as one example, clamp assembly 84 is configured to move drill guide assembly 82 forward in a clamping direction to perform a clamping operation. In the arrangement shown, as one example, clamp assembly 84 is configured to move drill guide assembly 82 rearward in an unclamping direction to perform an unclamping operation. It is also contemplated that drill guide assembly 82 may be on an opposite side as clamp assembly 84 and is configured to clamp workpiece 26 against drill guide assembly 82 instead of upright assembly 80.

Any other configuration is hereby contemplated for use for pocket hole jig system 24 and any component thereof.

Connection Member 86: In the arrangement shown, as one example, pocket hole jig system 24 includes a connection member 86. Clamping assembly 84 is formed of any suitable size, shape and design and is configured to facilitate clamping of workpiece 26. In the arrangement shown, as one example, clamping assembly 84 is connected to base 78 as well as drill guide assembly 82 and includes a clamping mechanism. In the arrangement shown, as one example, clamp assembly 84 is configured to move drill guide assembly 82 forward in a clamping direction to perform a clamping operation. In the arrangement shown, as one example, clamp assembly 84 is configured to move drill guide assembly 82 rearward in an unclamping direction to perform an unclamping operation. It is also contemplated that drill guide assembly 82 may be on an opposite side as clamp assembly 84 and is configured to clamp workpiece 26 against drill guide assembly 82 instead of upright assembly 80.

Connection member 86 of lower surface 202 base 78 of pocket hole jig system 24 is formed of any suitable size, shape and design and is configured to facilitate the selective engagement of pocket hole jig system 24 with docking station 10 and the selective removal of pocket hole jig system 24 with docking station 10. In the arrangement shown, as one example, connection member 86 has a corresponding size and shape and configuration as connection member 36 of base section 28 of docking station system 10 so as to facilitate locking of pocket hole jig system 24 to docking station system 10.

In one arrangement, connection member 86 of lower surface 202 of base 78 of pocket hole jig system 24 is an opening in lower surface 202 of base 78 and is placed over connection member 36 of base section 28 of docking station system 10. In one arrangement, once connection member 86 of base 78 of pocket hole jig system 24 is placed over connection member 36 of base section 28 of docking station system 10, pocket hole jig system 24 is locked to docking station system 10 by sliding pocket hole jig system 24 forward relative to docking station system 10 which engages the connection member 36 of base section 28 of docking station system 10 with the connection member 86 of base 78 of pocket hole jig system 24 in a locking manner. In this arrangement, the flanges 142 of connection member 36 of base section 28 of docking station system 10 are received, engaged and locked to internal features of connection member 86 of base 78 of pocket hole jig system 24. This prevents the unintentional removal of pocket hole jig system 24 from docking station system 10. This provides a safe and secure and strong connection that can be quickly formed without any tools. In this example arrangement, pocket hole jig system 24 can only be removed from docking station system 10 by sliding pocket hole jig system 24 rearward relative to docking station system 10 until the flanges 142 of connection member 36 of lower surface 202 of base section 28 of docking station system 10 are disengaged from the internal features of connection member 86 of base 78 of pocket hole jig system 24. However, any other size, shape, placement or configuration is hereby contemplated for use as connection member 86.

In the arrangement shown, as one example, when pocket hole jig system 24 is fully installed upon docking station system 10, a pair of protrusions 144 that extend rearward from rearward face 124 of upright section 30 of docking station system 10 engage and are received within recesses 146 in the forward surface 148 of upright assembly 80 of pocket hole jig system 24. In this arrangement, when pocket hole jig system 24 is locked into place on docking station system 10, these protrusions 144 are received within similarly shaped recesses 146 in forward side 148 of upright assembly 80 of pocket hole jig system 24. The engagement between the generally flat and horizontal lower surface of protrusions 144 with the upright assembly 80 of pocket hole jig system 24 prevents the forward end of pocket hole jig system 24 from rising or moving during use. However, any other size, shape, placement or configuration is hereby contemplated for use. In this way, when pocket hole jig system 24 is installed upon docking station 10, the base 78 of pocket hole jig system 24 is connected to base section 28 of docking station system 10 and upright assembly 80 of pocket hole jig system 24 is secured to upright section 30 of docking station system 10. This dual connection arrangement provides increased strength and rigidity to the connection between pocket hole jig system 24 and docking station system 10.

In Operation:

In the arrangement shown, as one example, when pocket hole jig system 24 is installed upon docking station system 10, side supports 40 may be moved between an extended position and a retracted position by rotation of hinge member 42 of side supports 40 on hinge member 32 of docking station system 10.

In an extended position, side supports 40 extend outward from base section 28 of docking station system 10 in a generally horizontal manner. In this position, the base section 28 and side supports 40 rest upon the same plane formed by the upper surface of work surface 27. In this position, the upper surface of 204 of base 78 of pocket hole jig system 24 is in approximate planar alignment with the upper surface of cover member 52 of side supports 40. In this position, a workpiece 26 may be seamlessly slid across the upper surface 204 of base 78 of pocket hole jig system 24 as well as the upper surface of cover member 52 of side supports 40 in a seamless and uninterrupted manner as they essentially form the same plane. Similarly, when a workpiece 26 is placed upon the upper surface 204 of base 78 of pocket hole jig system 24 the workpiece 26 is seamlessly supported by the upper surfaces of cover member 52 of side supports 40 if it extends to overlap side supports 40 as they essentially form the same plane.

Once the side supports 40 are extended, and the pocket hole jig system 24 is installed upon docking station system 10, parts and components, such as drill bits, screws, stop collars, drivers, and the like, may be removed from the hollow interior 64 of side supports 40 by opening cover member 52 by lifting up on lip 158 of cover member 52. As lip 158 of cover member 52 is lifted up, lip 158 of cover member 52 separates from lip 156 of base member 44 and cover member 52 rotates upon hinge 154, thereby exposing hollow interior 64. Cover member 52 may be closed by simply pressing downward upon cover member 52 causing cover member 52 to rotate upon hinge 154 until cover member 52 closes and lip 158 of cover member 52 engages lip 156 of base member 44.

When drilling pocket holes in multiple workpieces 26 of the same size, stop member 68 may be set so that a pocket hole is drilled in precisely the same location on multiple workpieces 26. To do so, stop member 68 is installed upon guide member 60 and slid to the desired location. Positioning may be precisely achieved by using indicia 62 of cover member 52 to ensure stop members 68 on each side support 40 are in precisely the same location. Once in the desired location, the locking member 74 is engaged by rotating knob 194, thereby locking stop member 68 rigidly in place upon guide member 60. Once locked in place, multiple workpieces 26 may be slid against stop member 68 without stop member 68 moving. This increases the speed of drilling pocket holes in multiple workpieces 26 in a fast and accurate manner.

Once pocket hole jig system 24 is installed upon docking station system 10 and side supports 40 are deployed, workpiece 26 may be quickly and easily clamped in place by placing workpiece 26 on the upper surface 204 of base 78 and engaging the clamp assembly 84 of pocket hole jig system 24 until workpiece 26 is clamped between upright assembly 80 and drill guide assembly 82, at which point pocket holes may be formed by passing a drill bit through drill guides 208. Once the desired pocket holes have been formed, the workpiece 26 may be removed by disengaging the clamp assembly 84 and removing workpiece 26.

Once the user is done using the pocket hole jig system 24, the pocket hole jig system 24 may be removed from the docking station system 10 by sliding the pocket hole jig system 24 rearward relative to docking station system 10 until pocket hole jig system 24 separates from docking station system 10. Alternatively, once the user is done using the pocket hole jig system 24, the pocket hole jig system 24 may be left attached to the docking station system 10.

Either way, if pocket hole jig system 24 is removed from or remains attached to docking station system 10, to reduce the footprint of docking station system 10 and provide a more compact arrangement for storage and/or transport, side supports 40 may be moved to the retracted position. To do this, the user lifts up on the outward end of side supports 40 thereby causing rotation of hinge member 42 of side supports 40 on hinge member 32 of docking station system 10. This rotation continues until the side supports 40 are essentially in a vertical alignment, or a retracted position.

Once side supports 40 are in the retracted position, side supports 40 may be locked in place using lock member 66. To lock side supports 40 in a retracted position, knob 162 of lock member 66 is rotated until hook member 164 engages lock member 38 of upright section 30 of docking station system 10, or alternatively, lock member 38 of upright assembly 80 of pocket hole jig system 24. Once hook member 164 of lock member 66 engages lock member 38 of docking station system 10 or pocket hole jig system 24, side support 40 is locked in a compact retracted position and is easily stored and/or transported.

Side supports 40 can be quickly and easily deployed by disengaging lock member 66 and rotating side supports 40 downward again, which is easy and convenient to do. In this way, the combination of docking station system 10 and pocket hole jig system 24 provide a more-easily deployed system than has every before existed that provides improved support, improved stability, improved accuracy, improved ease of use, and improved ease of transportation and storage.

Adapter Bracket 98:

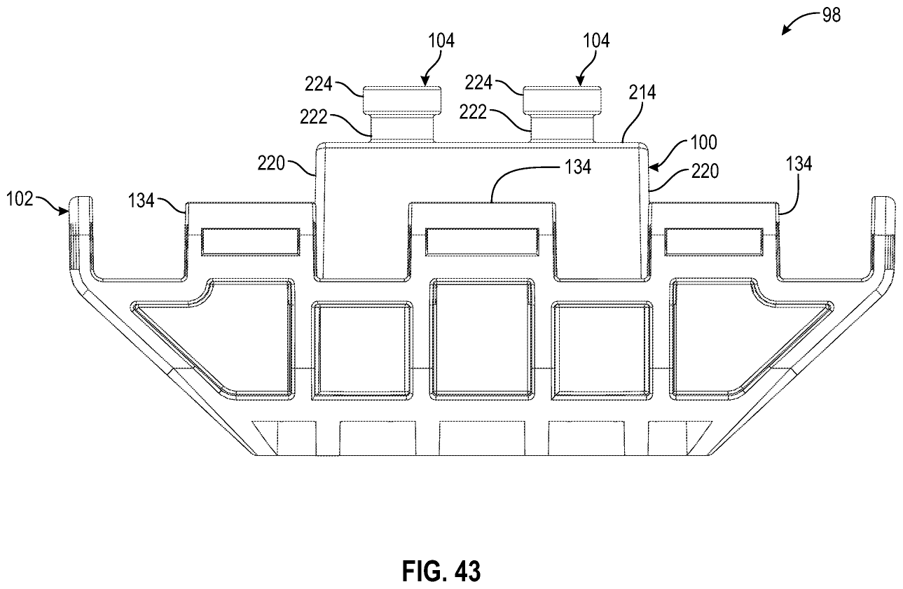

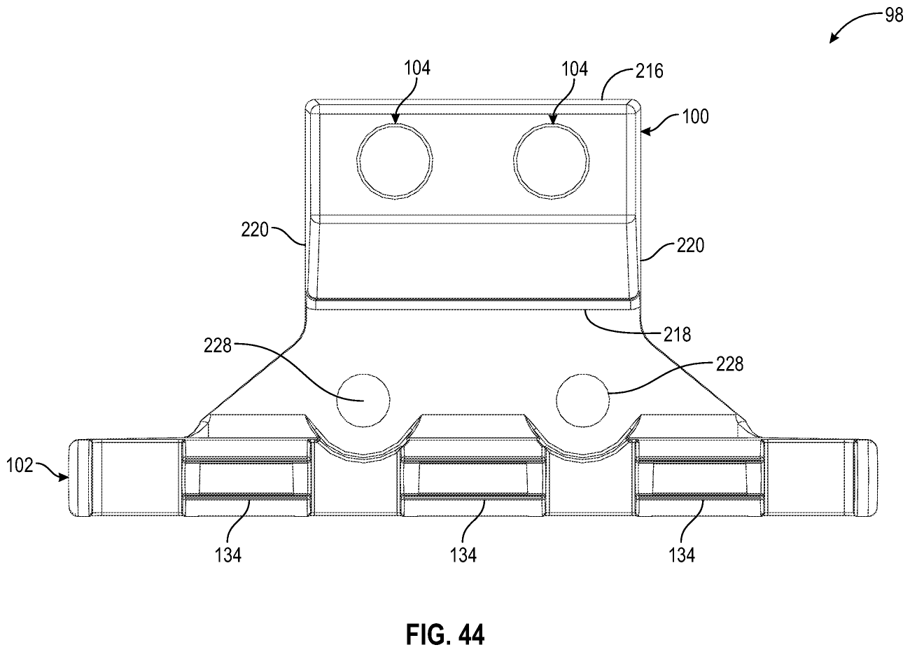

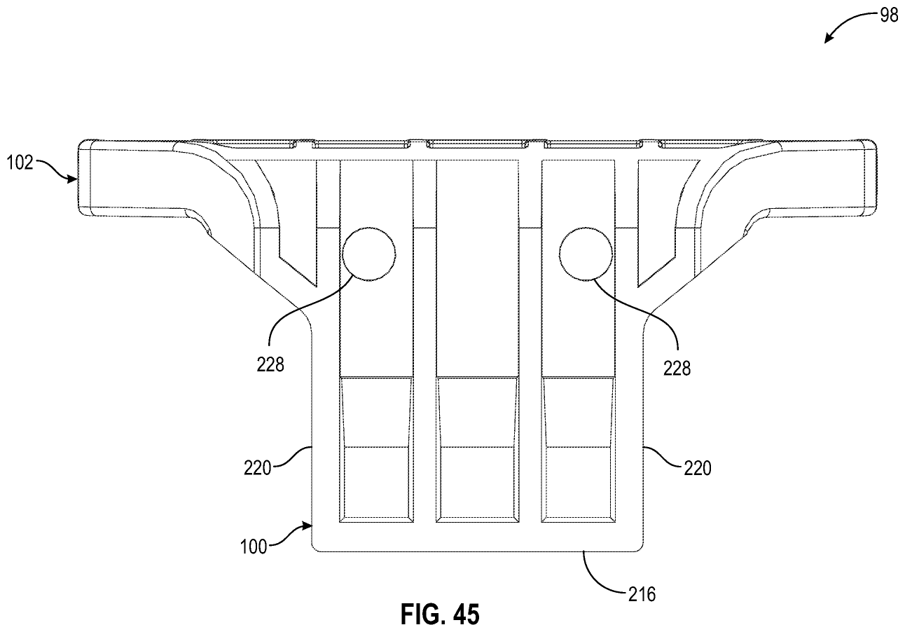

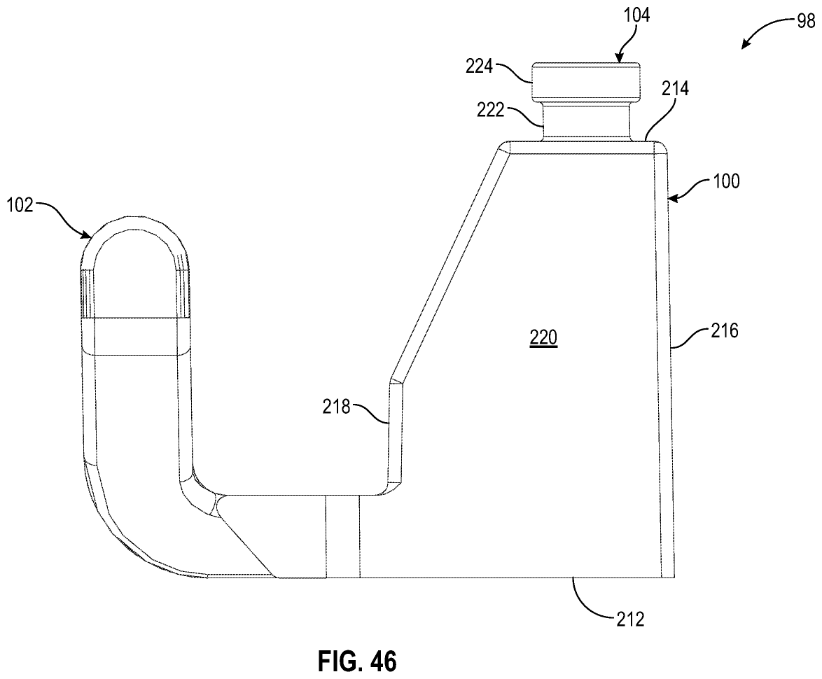

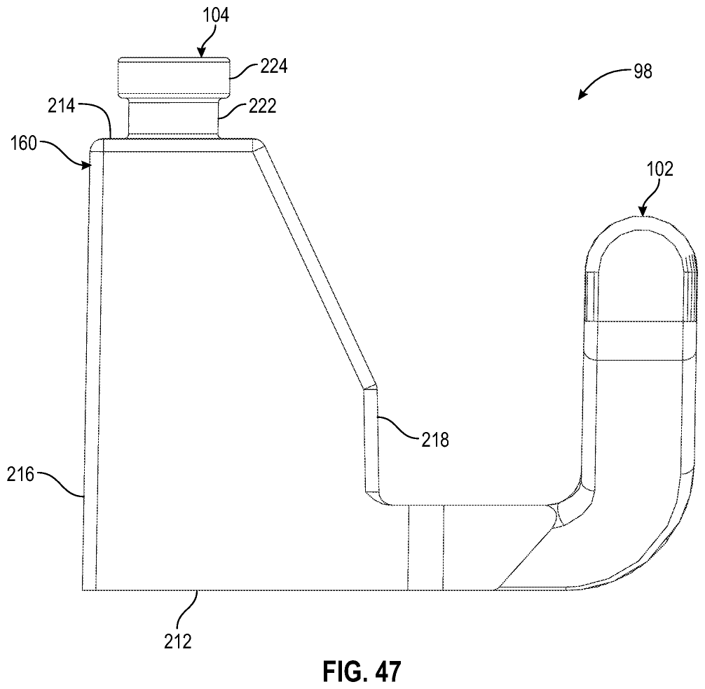

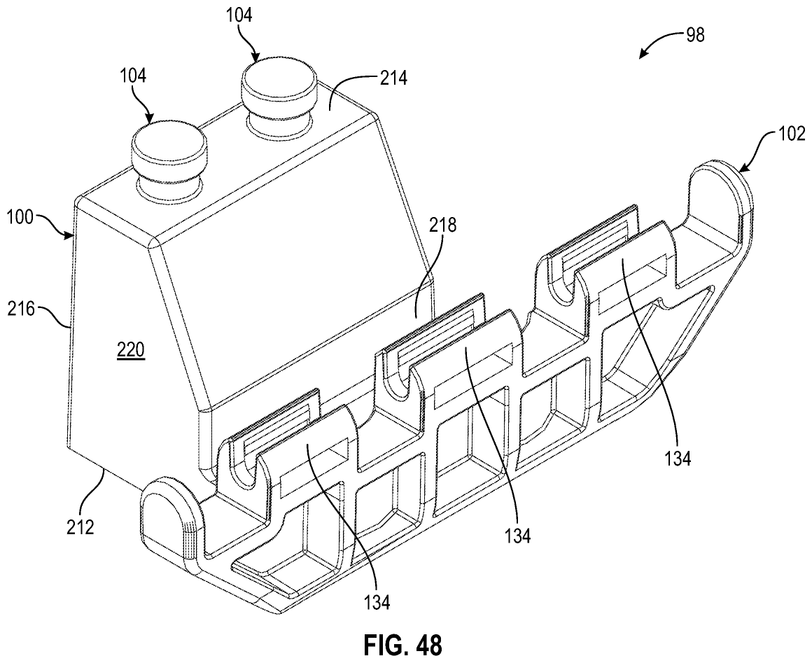

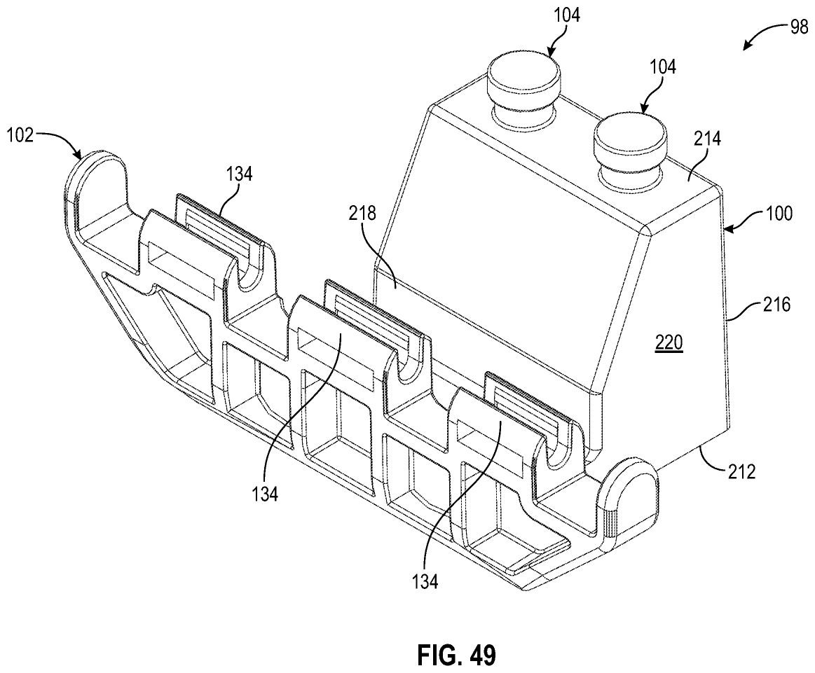

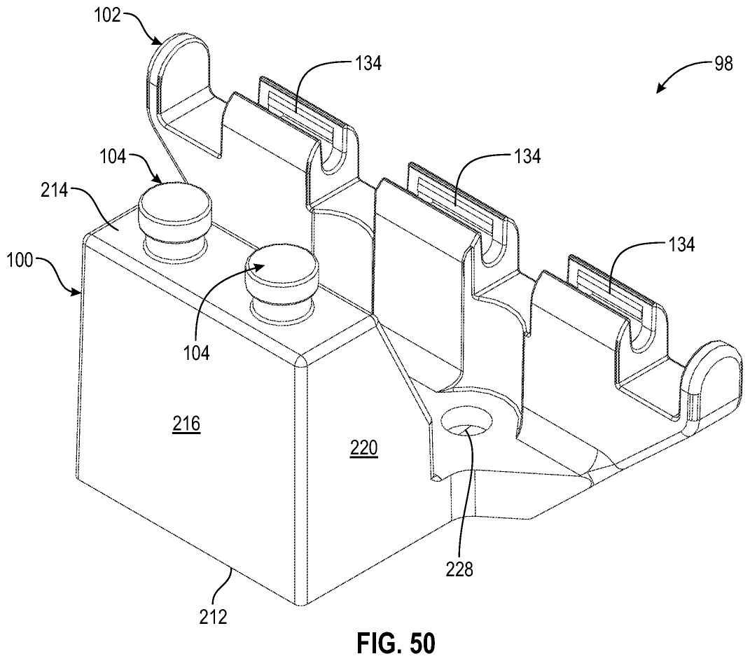

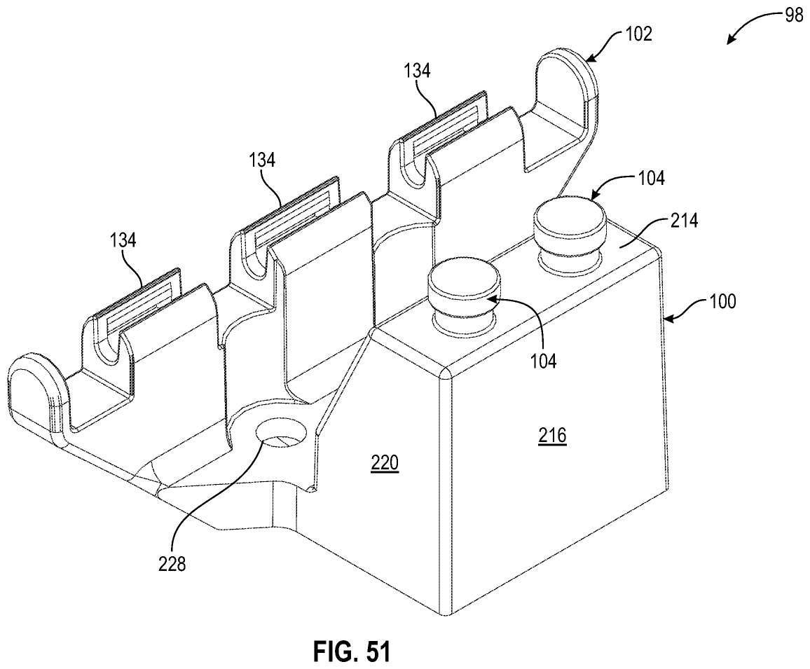

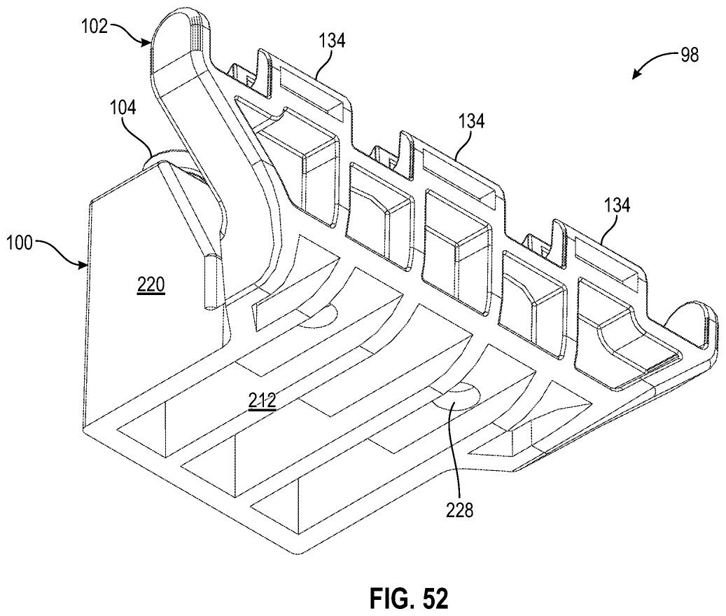

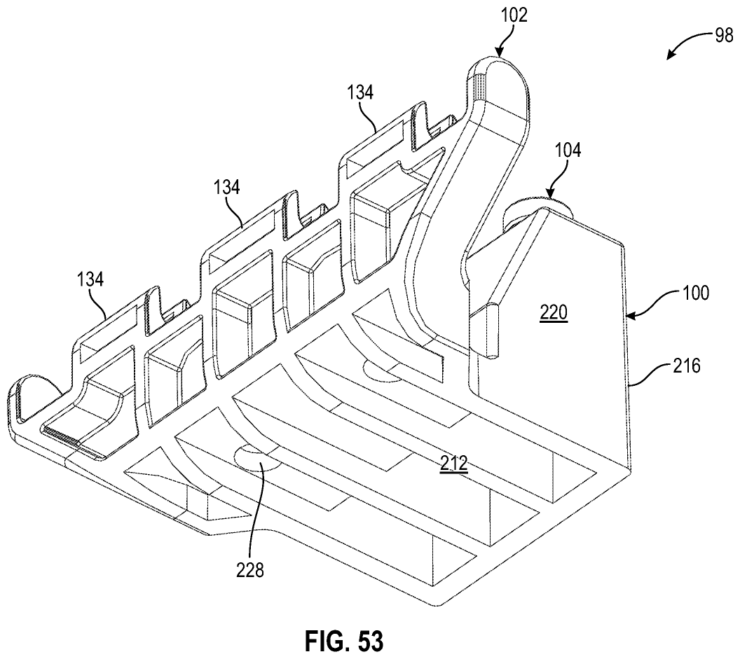

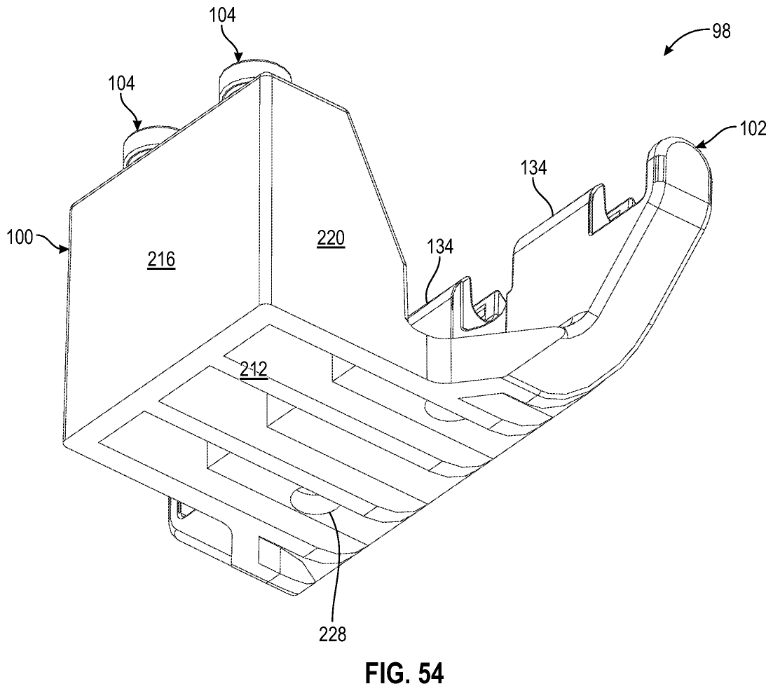

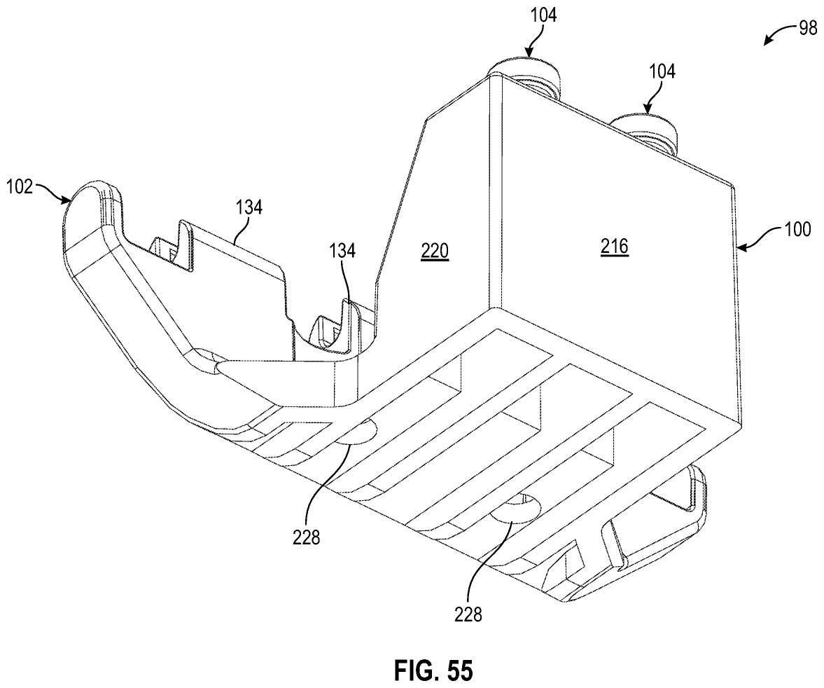

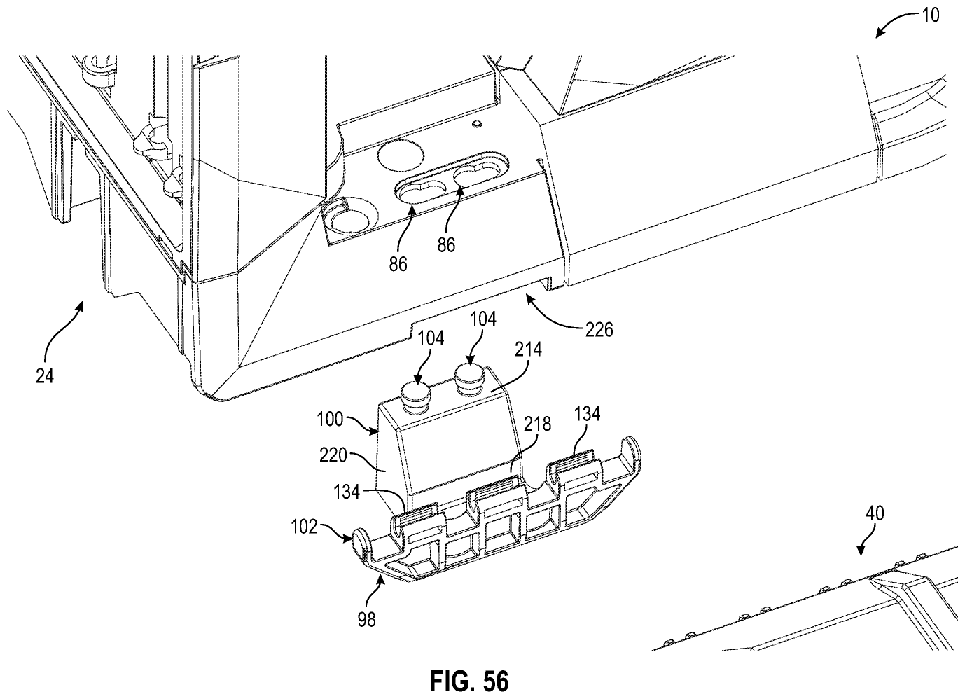

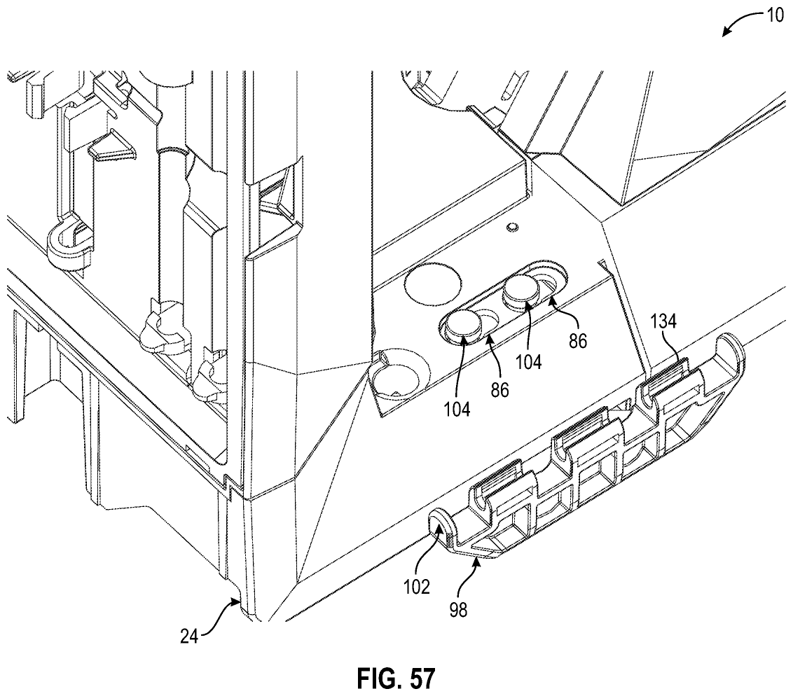

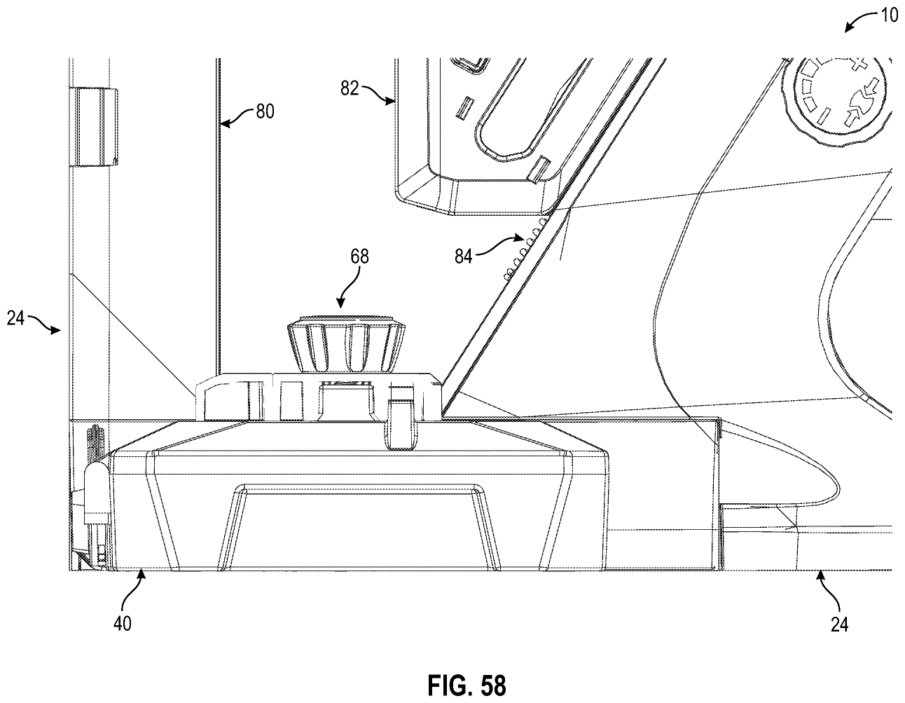

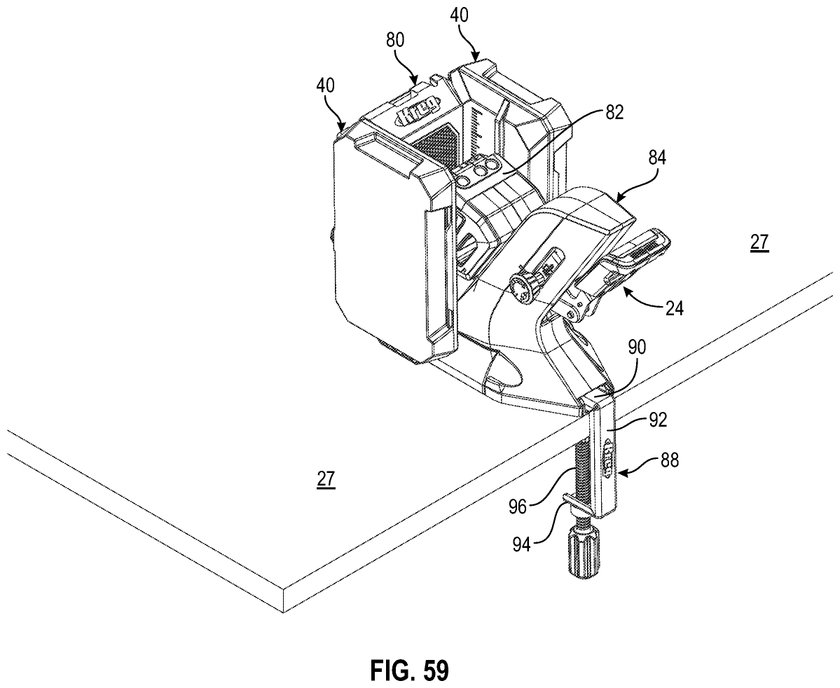

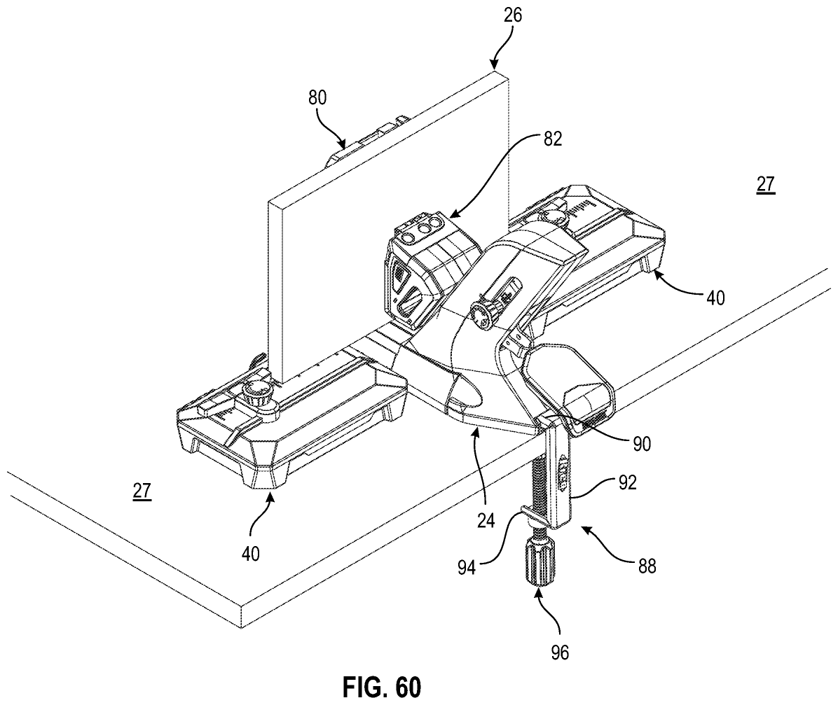

An alternative arrangement of docking station system 10 is shown in use with respect to FIGS. 31-60. In this arrangement, docking station system 10 includes the use of adapter brackets 98. All of the teaching and disclosure presented herein applies equally to the configuration of docking station system 10 having adapter brackets 98, unless specifically stated otherwise.

Adapter brackets 98 are formed of any suitable size, shape and design and are configured to connect to base 78 of pocket hole jig system 24 as well as facilitate connection of side support 40 to base 78 of pocket hole jig system 24. In the arrangement shown, as one example, adapter brackets 98, includes a base section 100, a hinge member 102 and connection members 104. Notably, unlike the previously disclosed embodiment of docking station system 10, while this embodiment of docking station system 10 includes a base section 100 (which functionally may be similar to base section 28 in the previously disclosed embodiment of docking station system 10) this embodiment does not include an upright section (which functionally may be similar to upright section 30 in the previously disclosed embodiment of docking station system 10).

In the arrangement shown, as one example, adapter brackets 98 has a base section 100. Base section 100 is formed of any suitable size, shape and design and is configured to engage base 78 of pocket hole jig system 24 and facilitate connection of side support 40 to the adapter bracket 98, which connects side support 40 to pocket hole jig system 24. In the arrangement shown, as one example, base section 100 includes a lower surface 212 and an opposing upper surface 214, an inward surface 216 and an outward end 218 and opposing ends 220.

In the arrangement shown, as one example, lower surface 212 and upper surface 214 are formed of a generally flat and straight plane that extend in approximate parallel spaced relation to one another. In the arrangement shown, as one example, inward end 216 and outward end 218 are formed of a generally flat and straight plane that extend in approximate parallel spaced relation to one another. In the arrangement shown, as one example, opposing ends 220 are formed of a generally flat and straight plane that extend in approximate parallel spaced relation to one another. In the arrangement shown, as one example, the planes formed by lower surface 212 and upper surface 214 extend in approximate perpendicular alignment to the planes formed by inward end 216 and outward end 218. In the arrangement shown, as one example, the planes formed by lower surface 212 and upper surface 214 extend in approximate perpendicular alignment to the planes formed by opposing ends 220. In the arrangement shown, as one example, the planes formed by inward end 216 and outward end 218 extend in approximate perpendicular alignment to the planes formed by opposing ends 220. In this way, the generally flat and straight planes of lower surface 212 and an opposing upper surface 214, an inward surface 216 and an outward end 218, and opposing ends 220 form a generally square or rectangular base section 100.

In the arrangement shown, as one example, the upper end of outward end 218 angles toward inward end 216 part way up as it extends toward upper surface 214 so as to provide for room for base 78 of pocket hole jig system 24.

In the arrangement shown, as one example, hinge members 102 are functionally and structurally equivalent, if not identical, to hinge members 32 previously described herein. As such, the same side supports 40 may be used with adapter brackets 98 as may be used with the previously described embodiment of docking station system 10. As such, so as to avoid redundancy, disclosure and teaching presented herein with respect to hinge members 32 applies to hinge members 102 of adapter bracket 98. Hinge members 102, like hinge members 32 include hinge portion 134 and receive hinge portion 136 of side supports 40 and facilitate rotation of side supports 40 on adapter bracket 98 between an extended position and a retracted position.

In the arrangement shown, as one example, upper surface 214 of adapter bracket 98 includes one or more connection members 104 therein. Connection members 104 are formed of any suitable size, shape and design and are configured to facilitate the fast, easy, accurate and secure attachment of adapter bracket 98 to base 78 of pocket hole jig system 24. Connection members 104 allow for easy and secure installation as well as easy removal.

Connection members 104 are formed of any form of a device that connects two components together. In the arrangement shown, as one example, a pair of connection members 104 are positioned in spaced alignment in the upper surface 214 of adapter bracket 98 and are formed of a pair of locking post mechanisms having a narrower shaft 222 that extends upward from the upper surface 214 of adapter bracket 98 that connects to a wider head 224. In the arrangement shown, as one example both shaft 222 and head 224 are cylindrical in shape, with head 224 having a larger diameter than shaft 222.

In the arrangement shown, as one example, base section 100 is configured to be received within a pocket 226 in the lower side of base 78 of pocket hole jig system 24. The upper end of this pocket 226 in pocket hole jig system 24 includes connection members 86 that are sized and shaped to receive the connection members 104 of adapter bracket 98. In the arrangement shown, as one example, connection members 86 of pocket 226 are formed of key holes having a wider section that allows for the passage of head 224 there through that is connected to a narrower section that receives shaft 222 therein but does not allow for the passage of head 224 there through.

In this arrangement, adapter bracket 98 is inserted into the pocket 226 in the lower end of base 78. The heads 224 of connection members 104 are inserted through the wider portions of the keyholes of the connection members 86 in base 78 of pocket hole jig system 24. Once heads 224 are inserted through the wider portions of the keyholes of the connection members 86 in base 78 of pocket hole jig system 24 the adapter bracket 98 is slid forward (or alternatively rearward, or sideways, or any other direction depending on the configuration of the keyholes) until the shafts 222 move from the wider section of the key holes into the narrower section of the keyholes.

In one arrangement, the tolerances of keyholes of connection members 86 of base 78 are such that friction is imparted upon shaft 222 when it moves from the wider portion of keyholes to the narrower portion of keyholes, which prevents adapter bracket 98 from freely sliding between the narrower portion of keyholes and the wider portion of keyholes. As such, user imparted force must be applied to overcome the friction imparted by connection members 86 when shafts 222 are held within the narrower portion of keyholes of connection members 86 to move shafts 222 to the wider portion of key holes of connection members 86. This provides a secure connection when adapter bracket 98 is installed upon base 78 of pocket hole jig system 24.

Once in the locked position the heads 224 are retained by the keyholes of connection member 86. Heads 224 cannot pull through the narrower portion of keyholes of connection member 86. In this position, adapter bracket 98 is locked to base 78.

In this position, an arm of adapter bracket 98 that connects to hinge member 102 extends through a recess, groove or slot in the lower side of base 78 of pocket hole jig system 24 that connects to pocket 226. The outward end of this arm includes hinge member 102 thereon. In this position, side support 40 may be installed on hinge member 102 and used in the manner described herein.

Adapter bracket 98 may be quickly and easily removed from base 78 by sliding adapter bracket 98 in an opposite direction from the installation direction, and then removed by pulling heads 224 through the wider portion of the keyholes of connection member 86 of base 78.

In this way another configuration of docking station system 10 is presented that provides similar if not identical benefits to those described herein with respect to other configurations of a docking station system 10.

In the arrangement shown, as one example, side supports 40 may be locked in a retracted position by engagement of the lock member 66 with the lock member 38, which in this case is connected to the upright assembly 80 of pocket hole jig system 24. More specifically, in the arrangement shown, as one example, lock member 38 is positioned in the outward side of upright assembly 80 and is formed of an opening, recess, slot, groove or pocket that is configured to receive the hook member 164 of lock member 66 when in a locked position. Side supports 40 may quickly and easily be lowered by unhooking lock member 66 from lock member 38 for use.

In the arrangement shown, as one example, both adapter brackets 98 and base section 28 include holes 228 therein that are configured to receive fasteners 106 there through that are used to secure docking station system 10 to work surface 27. Holes 228 are positioned between hinge members 102 and base section 100 of adapter brackets 98. Similarly, holes 228 are positioned between base section 28 and hinge members 32. Any other location is hereby contemplated for use.

Objectives Met:

In view of the above, it is evident that various embodiments of the docking station system presented herein meet the stated objectives as well as so many more. That is, in one or more embodiments, the docking station system presented herein: improves upon the state of the art; can receive different jigs; can be easily affixed to a work surface; includes storage; is easily stored; is easily transportable; provides additional support for a workpiece; provides repeatable adjustable stops for a workpiece; retracts into a compact configuration; expands into an extended configuration; locks into a retracted position; is easy to use; is efficient; can be used with any type of workpiece; is cost effective; forms accurate pocket holes; is safe to use; has a durable design; has a long useful life; provides additional functionality for pocket hole jigs and pocket hole joinery; has a wide variety of uses; has a wide variety of applications; provides cost savings to a user; is relatively inexpensive; provides value; prevents or reduces relative movement between the pocket hole jig and the workpiece; facilitates easier clamping; facilitates stable placement of a pocket hole jig system; is comfortable to use; is more stable than other pocket hole jigs; improves the ergonomics of use; facilitates the easy installation of various jigs; facilitates the secure installation of various jigs; and/or facilitates the formation of aesthetically pleasing finished products; among countless other improvements and advantages.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the following claims, and the full scope of equivalents thereof

What is claimed:

1. A docking station system, comprising:
a base section;
an upright section connected to the base section;
a first side support;
wherein the first side support operatively connects to the base section at a first hinge;
wherein the first side support is configured to move between an extended position and a retracted position upon the first hinge;
wherein the docking station system is configured to receive and connect with a pocket hole jig system.

2. The system of claim 1 further comprising the pocket hole jig system operatively connected to the docking station system.

3. The system of claim 1 further comprising the pocket hole jig system operatively connected to the docking station system, the pocket hole jig system having:
a base;
an upright assembly connected to the base;
a drill guide assembly operatively connected to the base;
a clamp assembly operatively connected to the base.

4. The system of claim 1 wherein when the pocket hole jig system is connected to the docking station system, an upper surface of a base of the pocket hole jig system is in approximate alignment with an upper surface of the first side support.

5. The system of claim 1 wherein the first side support rotates upon the first hinge between an extended position and a retracted position.

6. The system of claim 1 wherein the first hinge facilitates rotation of the first side support between an extended position and a retracted position.

7. The system of claim 1 wherein the first side support has a hollow interior for storage.

8. The system of claim 1 wherein the docking station system further includes the first side support having a base member and a cover member that form a hollow interior for storage.

9. The system of claim 1 wherein the docking station system further includes the first side support having a stop member that slides along the first side support thereby forming a positive stop for a workpiece.

10. The system of claim 1 wherein the docking station system further includes a second side support;
wherein the second side support operatively connects to the base at a second hinge;
wherein the first side support is configured to move between an extended position and a retracted position upon the second hinge.

11. A docking station system, comprising:
a docking station, including:
a base section;
a first side support;
wherein the first side support operatively connects to the base section at a first hinge;
wherein the first side support is configured to move between an extended position and a retracted position upon the first hinge;
a pocket hole jig system operatively connected to the base section of the docking station; and
wherein the first side support has a stop member that slides along the first side support thereby forming a positive stop for a workpiece.

12. The system of claim 11, wherein the pocket hole jig system includes:
a base;
an upright assembly connected to the base;
a drill guide assembly operatively connected to the base;
a clamp assembly operatively connected to the base.

13. The system of claim 11, wherein when the pocket hole jig system is connected to the docking station, an upper surface of a base of the pocket hole jig system is in approximate alignment with an upper surface of the first side support.

14. The system of claim 11, wherein the first side support rotates upon the first hinge between an extended position and a retracted position.

15. The system of claim 11, wherein the first hinge facilitates rotation of the first side support between an extended position and a retracted position.

16. The system of claim 11, wherein the first side support has a hollow interior for storage.

17. The system of claim 11, further comprising the first side support having a base member and a cover member that form a hollow interior for storage.

18. The system of claim 11, wherein the stop member includes:
a main body;
the main body extends a length between a forward end and a rearward end, extends a width between opposing sides, and extends a height between a lower end and an upper end;
an extension member operatively connected to the main body;
a locking member;
the locking member configured to facilitate selective locking and unlocking of the stop member relative to side support.

19. The system of claim 11, further comprising:
a second side support;
wherein the second side support operatively connects to the base section at a second hinge;
wherein the first side support is configured to move between an extended position and a retracted position upon the second hinge.

20. The system of claim 11, wherein the base section is part of an adapter bracket connected to a pocket hole jig system.

21. The system of claim 11, further comprising a lock member;
wherein when the first side support is in a retracted position, the lock member connects the first side support to the upright section and holds the first side support in a retracted position.

22. The system of claim 11, further comprising a lock member;
wherein when the first side support is in a retracted position, the lock member connects the first side support to the upright section and holds the first side support in a retracted position;
wherein the lock member is connected to the first side support.

23. The system of claim 11, further comprising a lock member;
wherein when the first side support is in a retracted position, the lock member connects the first side support to the upright section and holds the first side support in a retracted position;
wherein the lock member is connected to the first side support in a rotatable manner.

24. The system of claim 11, further comprising a lock member;
wherein when the first side support is in a retracted position, the lock member connects the first side support to the upright section and holds the first side support in a retracted position;
wherein the lock member includes a hook that rotates into engagement and rotates out of engagement between the first side support and the upright section.

25. The system of claim 11, further comprising a lock member;
wherein when the first side support is in a retracted position, the lock member connects the first side support to the upright section and holds the first side support in a retracted position;
wherein the lock member includes a hook in one of the upright section and the side support that engages an opening in the other of the upright section and the side support.

26. A docking station system, comprising:
a base section;
an upright section connected to the base section a first side support;
wherein the first side support operatively connects to the base section at a first hinge;
wherein the first side support is configured to move between an extended position and a retracted position upon the first hinge;
wherein the docking station system is configured to receive and connect with a first jig system;
wherein the docking station system is configured to receive and connect with a second jig system that is different from the first jig system.

27. The system of claim 26, further comprising the first jig system and the second jig system.

28. The system of claim 26, wherein the first jig system is a pocket hole jig system operatively connected to the docking station system, the pocket hole jig system having:
a base;
an upright assembly connected to the base;
a drill guide assembly operatively connected to the base;
a clamp assembly operatively connected to the base.

29. The system of claim 26, wherein the pocket hole jig system has:
a base;
an upright assembly connected to the base;
a drill guide assembly operatively connected to the base;
a clamp assembly operatively connected to the base;
wherein when the pocket hole jig system is connected to the docking station system, an upper surface of the base of the pocket hole jig system is in approximate alignment with an upper surface of the first side support.

30. The system of claim 26, wherein the first side support rotates upon the first hinge between an extended position and a retracted position.

31. The system of claim 26, wherein the first hinge facilitates rotation of the first side support between an extended position and a retracted position.

32. The system of claim 26, wherein the first side support has a hollow interior for storage.

33. The system of claim 26, wherein the docking station system further includes the first side support having a base member and a cover member that form a hollow interior for storage.

34. The system of claim 26, wherein the docking station further includes the first side support having a stop member that slides along the first side support thereby forming a positive stop for a workpiece.

35. The system of claim 26, wherein the docking station further includes a second side support;
wherein the second side support operatively connects to the base at a second hinge;
wherein the first side support is configured to move between an extended position and a retracted position upon the second hinge.
